(19) United States
(12) Patent Application Publication
(10) Pub. No.: US 2026/0113436 A1
(43) Pub. Date: Apr. 23, 2026

(54) CODING METHOD, DECODING METHOD, BIT STREAM, CODER, DECODER, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/423,905

(22) Filed: Dec. 17, 2025

Related U.S. Application Data
(63) Continuation of application No. PCT/CN2023/106200, filed on Jul. 6, 2023.

(51) Int. Cl. H04N 19/107; H04N 19/187; H04N 19/196; H04N 19/30; H04N 19/70

(52) U.S. Cl. CPC H04N 19/107; H04N 19/187; H04N 19/196; H04N 19/30; H04N 19/70

(57) ABSTRACT

An encoding method, a decoding method, and a storage medium are provided. The decoding method includes that: when it is determined that a node in the current layer allows attribute prediction, a bitstream is parsed to determine first syntax identification information; when the first syntax identification information indicates that the current layer allows adaptive selection of an inter prediction mode and/or an intra prediction mode, a bitstream is parsed to determine a target decoding mode for the current layer; and according to the target decoding mode, attribute decoding is performed on the node in the current layer to determine an attribute reconstruction value of the node in the current layer.

### CROSS-REFERENCE TO RELATED APPLICATION

This is a continuation application of International Patent Application No. PCT/CN2023/106200, filed on Jul. 6, 2023, the contents of which are hereby incorporated by reference in their entireties.

### BACKGROUND

In a Geometry-based Point Cloud Compression (G-PCC) codec framework or a Video-based Point Cloud Compression (V-PCC) codec framework provided by the Moving Picture Experts Group (MPEG), geometric information and attribute information of a point cloud are separately encoded.

Currently, attribute information encoding primarily focuses on the encoding of colour information. In colour information encoding, there are mainly two transform methods: one is distance-based lifting transform that relies on Level of Detail (LOD) partitioning, and the other is the direct Region-adaptive Hierarchical Transform (RAHT).

However, during performing the RAHT transform, the attribute encoding mode for the entire sequence may be determined through the Attribute Parameters Set (APS), for example, whether the entire sequence employs the RATH transform, the prediction transform or the lifting transform for attribute encoding. However, this attribute encoding scheme does not fully consider the distribution of Alternating Current (AC) components in different RAHT layers, resulting in low encoding efficiency for point cloud attributes.

### SUMMARY

Embodiments of the disclosure relate to the field of point cloud coding technology, and in particular to an encoding method, a decoding method, a bitstream, an encoder, a decoder, and a storage medium.

The technical solutions of the embodiments of the disclosure can be realized as follows:

According to a first aspect, an embodiment of the disclosure provides a decoding method, applied to a decoder, the method includes that: when it is determined that attribute prediction is enabled to be performed on nodes in the current layer, a bitstream is parsed to determine first syntax identifier information; when the first syntax identifier information indicates that adaptive selection of the inter prediction mode and/or the intra prediction mode for the current layer is enabled, the bitstream is parsed to determine the target decoding mode for the current layer; and attribute decoding is performed on the nodes in the current layer based on the target decoding mode to determine attribute reconstruction values of the nodes in the current layer.

In a second aspect, an embodiment of the disclosure provides an encoding method, applied to an encoder, the method includes that: when it is determined that attribute prediction is enabled to be performed on nodes in the current layer and that adaptive selection of an inter prediction mode and/or an intra prediction mode for the current layer is enabled, the target encoding mode for the current layer and first syntax identifier information are determined; and attribute encoding is performed on the nodes in the current layer based on the target encoding mode, and attribute reconstruction values of the nodes in the current layer are determined.

According to a third aspect, an embodiment of the disclosure provides a non-transitory computer-readable storage medium having a computer program and a bitstream stored thereon; the computer program that, when executed by a processor, enables the processor to perform the steps of an encoding method to generate the bitstream, herein the encoding method includes that: when it is determined that attribute prediction is enabled to be performed on nodes in the current layer and that adaptive selection of an inter prediction mode and/or an intra prediction mode for the current layer is enabled, the target encoding mode for the current layer and first syntax identifier information are determined; and attribute encoding is performed on the nodes in the current layer based on the target encoding mode, and attribute reconstruction values of the nodes in the current layer are determined.

### BRIEF DESCRIPTION OF THE DRAWINGS

FIG. 1A is a schematic diagram of a three-dimensional point cloud picture.

FIG. 1B is a partial enlarged view of a three-dimensional point cloud picture.

FIG. 2A is a schematic diagram of six viewing angles of a point cloud picture.

FIG. 2B is a schematic diagram of a data storage format corresponding to a point cloud picture.

FIG. 3 is a schematic diagram of a network architecture of point cloud coding.

FIG. 4A is a schematic diagram of a compositional framework of a G-PCC encoder.

FIG. 4B is a schematic diagram of a compositional framework of a G-PCC decoder.

FIG. 5A is a schematic diagram of a low plane position in the Z-axis direction.

FIG. 5B is a schematic diagram of a high plane position in the Z-axis direction.

FIG. 6 is a schematic diagram of a node encoding sequence.

FIG. 7A is a schematic diagram of a planar mode information.

FIG. 7B is another schematic diagram of planar mode information.

FIG. 8 is a schematic diagram of sibling nodes of a current node.

FIG. 9 is a schematic diagram of the intersection of a lidar and nodes.

FIG. 10 is a schematic diagram of a neighbouring node at the same partitioning depth and the same coordinates.

FIG. 11 is a schematic diagram of a current node located at the low plane position of the parent node.

FIG. 12 is a schematic diagram of a current node located at the high plane position of the parent node.

FIG. 13 is a schematic diagram of predictive encoding of lidar point cloud plane position information.

FIG. 14 is a schematic diagram of an IDCM encoding.

FIG. 15 is a schematic diagram of coordinate conversion of point clouds obtained by a rotating lidar.

FIG. 16 is a schematic diagram of predictive encoding in an X-axis or Y-axis.

FIG. 17A is a schematic diagram of predicting an angle in the Y-plane through horizontal azimuth.

FIG. 17B is a schematic diagram of predicting an angle in the X-plane through horizontal azimuth.

FIG. 18 is another schematic diagram of predictive encoding in the X-axis or Y-axis.

FIG. 19A is a schematic diagram of three vertices included in a sub-block.

FIG. 19B is a schematic diagram of a triangle soup fitted by using three vertices.

FIG. 19C is a diagram of upsampling the triangle soup.

FIG. 20 is a schematic diagram of a distance-based LOD construction process.

FIG. 21 is a schematic diagram of a visualization result of a LOD generation process.

FIG. 22 is a schematic diagram of an encoding process of an attribute prediction.

FIG. 23 is a schematic diagram of the composition of a pyramid structure.

FIG. 24 is a schematic diagram of the composition of another pyramid structure.

FIG. 25 is a schematic diagram of an LOD structure for inter-level nearest-neighbor search.

FIG. 26 is a schematic diagram of a structure of spatial-relationship-based nearest-neighbor search.

FIG. 27A is a schematic diagram of a coplanar spatial relationship.

FIG. 27B is a schematic diagram of a coplanar and collinear spatial relationship.

FIG. 27C is a schematic diagram of a coplanar, collinear and collocated spatial relationship.

FIG. 28 is a schematic diagram of an inter-level prediction based on fast search.

FIG. 29 is a schematic diagram of an LOD structure of an intra-level attribute nearest-neighbor search.

FIG. 30 is a schematic diagram of an intra-level prediction based on fast search.

FIG. 31 is a schematic diagram of a block-based neighborhood search structure.

FIG. 32 is a schematic diagram of an encoding process of a lifting transform.

FIG. 33 is a schematic diagram of a RAHT transform structure.

FIG. 34 is a schematic diagram of a transform process of a RAHT along x, y and z directions.

FIG. 35A is a schematic diagram of a forward RAHT transform process.

FIG. 35B is a schematic diagram of an inverse RAHT transform process.

FIG. 36 is a schematic flowchart of a decoding method according to an embodiment of the disclosure.

FIG. 37 is a schematic structure diagram of an attribute coding block.

FIG. 38 is an overall flow diagram of a RAHT attribute prediction transform coding.

FIG. 39 is a schematic diagram of a neighborhood prediction relationship of current block.

FIG. 40 is a schematic diagram of a calculation process of attribute transform coefficients.

FIG. 41 is a schematic diagram of a structure of a RAHT attribute inter prediction coding.

FIG. 42 is a schematic flowchart of an encoding method according to an embodiment of the disclosure.

FIG. 43 is a schematic diagram of attribute coding layers.

FIG. 44 is a schematic diagram of a compositional structure of a decoder according to an embodiment of the disclosure.

FIG. 45 is a schematic diagram of a specific hardware structure of a decoder according to an embodiment of the disclosure.

FIG. 46 is a schematic diagram of a compositional structure of an encoder according to an embodiment of the disclosure.

FIG. 47 is a schematic diagram of a specific hardware structure of an encoder according to an embodiment of the disclosure.

FIG. 48 is a schematic diagram of a compositional structure of an encoding and decoding system according to an embodiment of the disclosure.

### DETAILED DESCRIPTION

In order to understand characteristics and technical contents of embodiments of the disclosure more thoroughly, implementations of the embodiments of the disclosure will be described in detail below in conjunction with the accompanying drawings. The accompanying drawings are only for the purpose of reference and explanation, and are not intended to limit the embodiments of the disclosure.

Unless otherwise defined, all technical and scientific terms used here have the same meanings as those commonly understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments; however, it may be understood that “some embodiments” may be the same or different subsets of all possible embodiments, and may be combined with each other without conflict.

It should also be pointed out that terms “first\second\third” involved in the embodiments of the disclosure are only intended to distinguish similar objects and do not represent a specific order of the objects. It may be understood that “first\second\third” may be interchanged in a specific order or priority order where permitted, such that the embodiments of the disclosure described here may be implemented in an order other than that illustrated or described herein.

A point cloud is a three-dimensional representation of the surface of an object. The Point cloud (data) on the surface of the object may be collected through acquisition devices such as photoelectric radar, lidar, laser scanner, and multi-view camera.

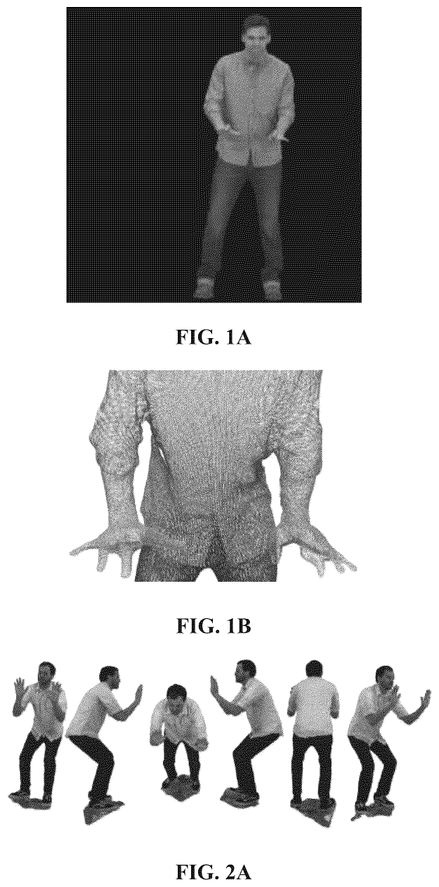

The point cloud is a discrete set of irregularly distributed points in space that represents the spatial structure and surface attributes of a three-dimensional objector scene. As illustrated in FIG. 1A (illustrating the three-dimensional point cloud picture) and FIG. 1B (illustrating a partial enlarged view of the three-dimensional point cloud picture), the surface of the point cloud is composed of densely distributed points.

In the two-dimensional picture, each pixel has information expressed, and the pixels are regularly distributed, so there is no need to additionally record position information of pixels. However, the distribution of points in the point cloud in three-dimensional space is random and irregular, so it is necessary to record the position of each point in space in order to completely express a point cloud. Similar to two-dimensional pictures, each position in the acquisition process has corresponding attribute information, usually RGB colour value, which reflects the colour of the object. For the point cloud, in addition to colour information, the attribute information for each point commonly includes a reflectance value, which reflects the surface material of the object. Therefore, the point cloud data usually includes position information of the points and attribute information of the points. The position information of the points may also be referred to as the geometric information of the points. For example, the geometric information of a point may be three-dimensional coordinate information (x, y, z) of the point. The attribute information of the points may include colour information and/or reflectance, and the like. For example, the reflectance may be one-dimensional reflectance information (r); the colour information may be information in any colour space, or the colour information may be three-dimensional colour information, such as RGB information. Here, R represents Red (R), G represents Green (G), and B represents Blue (B). As another example, the colour information may be luma-chroma (YCbCr, YUV) information. Y represents Luma, Cb (U) represents blue chroma, and Cr (V) represents red chroma.

For a point cloud obtained based on laser measurement principle, the points in the point cloud may include the three-dimensional coordinate information of the points and the reflectance values of the points. For another example, for a point cloud obtained based on the photogrammetry principle, the points in the point cloud may include three-dimensional coordinate information of the points and three-dimensional colour information of the points. For another example, for a point cloud obtained by combining the laser measurement and photogrammetry principles, the points in the point cloud may include three-dimensional coordinate information of the points, reflectance values of the points, and three-dimensional colour information of the points.

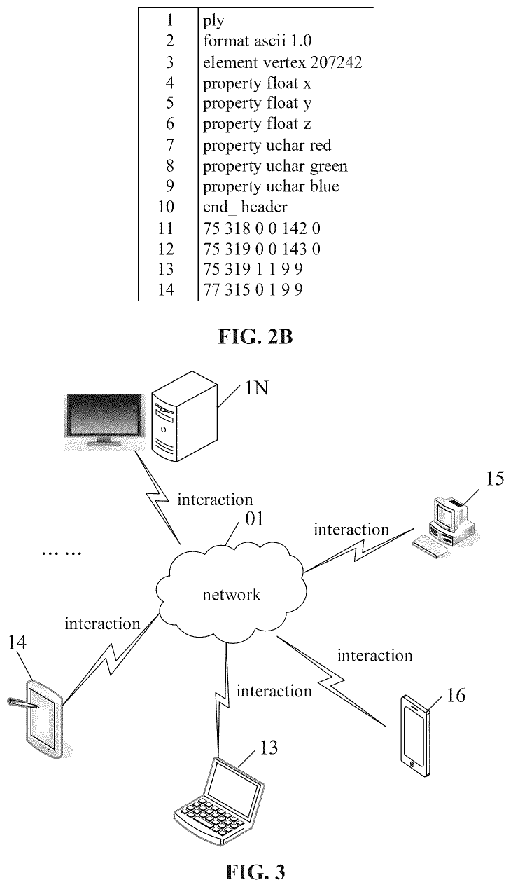

FIG. 2A illustrates a point cloud picture and FIG. 2B illustrates data storage format corresponding to the point cloud picture. FIG. 2A presents six viewing angles of the point cloud picture, and FIG. 2B is composed of a file header information section and a data section. The header information includes a data format, a data representation type, the total number of points in the point cloud, and the content represented by the point cloud. For example, the point cloud is in “.ply” format, represented by ASCII code, with a total of 207242 points, and each point has three-dimensional coordinate information (x, y, z) and three-dimensional colour information (r, g, b).

Point clouds may be classified based on their acquisition manners as follows.

Static point cloud: that is, the object is stationary, and the device acquiring the point cloud is also stationary.

Dynamic point cloud: the object is in motion, but the device acquiring the point cloud is stationary;

Dynamically acquired point cloud: the device acquiring the point cloud is in motion.

For example, point clouds are classified into two major categories based on their applications:
Category 1: machine perception point cloud, which may be applied in scenarios such as autonomous navigation systems, real-time inspection systems, geographic information systems, visual-based sorting robots, and disaster rescue robots; and
Category 2: Human eye perception point cloud, which may be applied in point cloud application scenarios such as digital cultural heritage, free-viewpoint broadcasting, three-dimensional immersive communication, and three-dimensional immersive interaction.

Point clouds may offer a flexible and convenient way to represent the spatial structure and surface attributes of three-dimensional objects or scenes. Since point clouds are obtained by directly sampling real objects, a strong realism can be provided while ensuring precision, having a wide range of applications, such as virtual reality games, computer-aided design, geographic information systems, automatic navigation systems, digital cultural heritage, free-viewpoint broadcasting, three-dimensional immersive telepresence, and three-dimensional reconstruction of biological tissues and organs.

Point cloud acquisition mainly includes the following ways: computer generation, 3D laser scanning, 3D photogrammetry, etc. Computers may generate point clouds of virtual three-dimensional objects and scenes. 3D laser scanning may obtain point clouds of static real-world three-dimensional objects or scenes at a rate of millions of points per second. 3D photogrammetry may obtain point clouds of dynamic real-world three-dimensional objects or scenes at a rate of tens of millions of point per second. These technologies reduce the cost and time required for point cloud data acquisition, and improve the precision of data. The evolution of point cloud data acquisition methods makes it possible to obtain a large amount of point cloud data. However, with the increasing demands of applications, the processing of massive 3D point cloud data faces the bottleneck due to limitations in storage space and transmission bandwidth.

For example, taking a point cloud video with a frame rate of 30 frames per second (fps) as an example, each frame of the point cloud includes 700,000 points, and each point includes coordinate information xyz (stored as float) and colour information RGB (stored as uchar), then the data amount of the 10-second point cloud video is about 0.7 million×(4 Byte×3+1 Byte×3)×30 fps×10 s=3.15 GB, where 1 Byte is 10 bits. In contrast, fora 1280×720 two-dimensional video with a YUV sampling format of 4:2:0 and a frame rate of 24 fps, the data volume of 10 s is about 1280×720×12 bit×24 fps×10 s≈0.33 GB, and the data volume of 10 s two-angle three-dimensional video is about 0.33×2=0.66 GB. It can be seen that the data amount of point cloud video far exceeds the data amount of two-dimensional video and three-dimensional video of the same duration. Therefore, in order to better realize data management, save server storage space, and reduce transmission traffic and transmission time between the server and the client, point cloud compression has become a critical issue to promote the development of point cloud industry.

In other words, since the point cloud is a collection of massive points, storing the point clouds will not only consume a significant amount of memory, but also be not conducive to transmission; moreover, there is insufficient bandwidth to support the direct transmission of the uncompressed point cloud at the network layer. Therefore, it is necessary to compress the point clouds.

Currently, the point cloud coding framework that can compress the point clouds may be a Geometry-based Point Cloud Compression (G-PCC) codec framework or a Video-based Point Cloud Compression (V-PCC) codec framework provided by the Moving Picture Experts Group (MPEG), or an AVS-PCC codec framework provided by AVS. The G-PCC codec framework may be used to compress the first type of static point cloud and the third type of dynamically acquired point cloud, which may be based on the Test Model Compression 13 (TMC13), and the V-PCC codec framework may be used to compress the second type of dynamic point cloud, which may be based on the Test Model Compression 2 (TMC2). Therefore, the G-PCC codec framework is also referred to as the point cloud codec TMC13, and the V-PCC codec framework is also referred to as the point cloud codec TMC2.

Embodiments of the disclosure provide a network architecture of a point cloud coding system including a decoding method and an encoding method, and FIG. 3 is a schematic diagram of a network architecture of a point cloud coding according to the embodiment of the disclosure. As illustrated in FIG. 3, the network architecture includes one or more electronic devices 13 to 1N and a communication network 01, where the electronic devices 13 to 1N may perform video interaction via the communication network 01. During implementation, The electronic device may be various types of devices having point cloud encoding and decoding functions, for example, the electronic device may include a mobile phone, a tablet computer, a personal computer, a personal digital assistant, a navigator, a digital phone, a video phone, a television, a sensing device, a server, and the like, which are not limited in the embodiments of the disclosure. The decoder or encoder in the embodiments of the disclosure may be the electronic device described above.

The electronic device in the embodiments of the disclosure has point cloud encoding and decoding functions, and generally includes a point cloud encoder (i.e., an encoder) and a point cloud decoder (i.e., a decoder).

The following describes the related technologies by taking the point cloud G-PCC codec framework as an example.

It should be understood that in the point cloud G-PCC codec framework, the point cloud data to be encoded is first partitioned into multiple slices through slice partitioning. In each slice, the geometric information of the point cloud and the attribute information for each point are encoded separately.

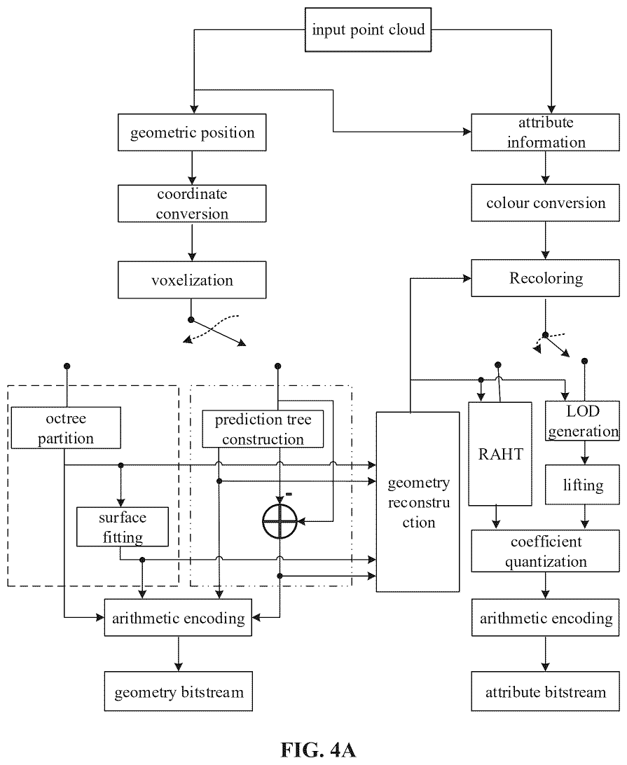

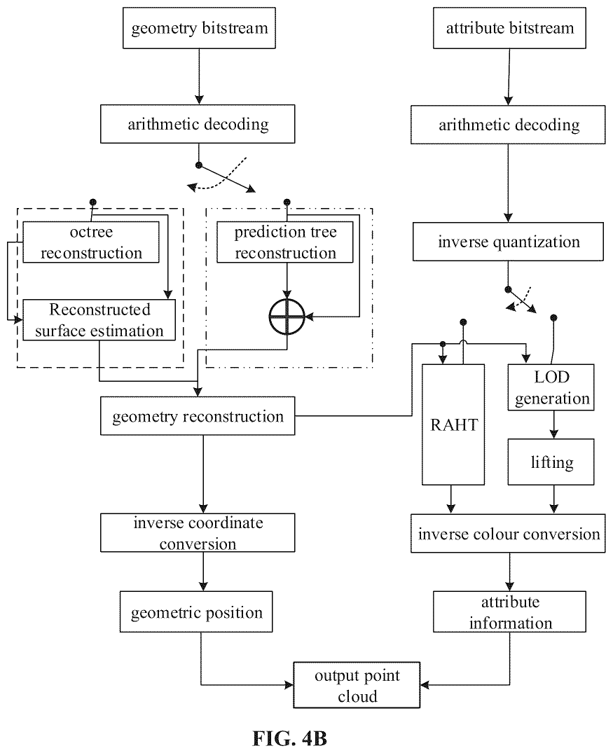

FIG. 4A is a schematic diagram of a compositional framework of a G-PCC encoder. As illustrated in FIG. 4A, in the geometry encoding process, coordinate conversion is performed on the geometric information to ensure that all the point clouds are included in a bounding box, and then quantization is performed. This operation of quantization mainly serves as a scaling function. Due to quantization and rounding, some point clouds have the same geometric information, and thus a decision is made based on parameters to determine whether to remove duplicate points. The process of quantization and removing duplicate points is also referred to as voxelization process. Then, the bounding box is partitioned into an octree or a prediction tree is constructed. During this process, arithmetic encoding is performed on the points in the partitioned leaf nodes to generate a binary geometry bitstream. Alternatively, arithmetic encoding is performed on vertexes generated through the partition (with surface fitting based on the vertexes) to generate a binary geometry bitstream. During attribute encoding process, after geometry encoding is completed and the geometric information is reconstructed, colour conversion is first performed to convert the colour information (i.e. attribute information) from RGB colour space to YUV colour space. Then, the point cloud is recolored by using the reconstructed geometric information, to enable the unencoded attribute information to correspond to the reconstructed geometric information. Attribute encoding mainly focuses on colour information. During colour information encoding process, there are two main transform methods: one is distance-based lifting transform that relies on LOD partitioning, and the other is direct Region-adaptive Hierarchical Transform (RAHT). These two methods convert colour information from spatial domain to frequency domain, obtaining high-frequency coefficients and low-frequency coefficients through transform. Finally, the coefficients are quantized, and then arithmetic encoding is performed on the quantized coefficients to generate a binary attribute bitstream.

FIG. 4B is a schematic diagram of a compositional framework of a G-PCC decoder. As illustrated in FIG. 4B, for the acquired binary bitstream, the geometry bitstream and the attribute bitstream in the binary bitstream are first independently decoded. When decoding the geometry bitstream, the geometric information of the point cloud is obtained through arithmetic decoding, octree reconstruction/prediction tree reconstruction, geometry reconstruction, and inverse coordinate conversion. When decoding the attribute bitstream, the attribute information of the point cloud is obtained through arithmetic decoding, inverse quantization, LOD partitioning/RAHT, and inverse colour conversion. Based on the geometric information and the attribute information, the point cloud data to be encoded is restored (i.e. output point cloud).

It should be noted that, as illustrated in FIG. 4A or FIG. 4B, the current geometry encoding and decoding in G-PCC may be divided into octree-based geometry encoding and decoding (marked with a dashed box) and prediction tree-based geometry encoding and decoding (marked with a dash-dotted box).

For octree geometry encoding (OctGeomEnc), octree geometry encoding includes the following. Coordinate transform is first performed on geometric information to ensure that all point clouds are included in a bounding box. Then quantization is performed. This operation of quantization mainly serves as a scaling function. Due to quantization and rounding, some point clouds have the same geometric information, and thus a decision is made based on parameters to determine whether to remove duplicate points. The process of quantization and removing duplicate points is also referred to as the voxelization process. Next, the bounding box is continuously partitioned into trees (such as octree, quadtree, binary tree) in a breadth-first traversal order, and the occupancy codes of all nodes are encoded. In the related art, a company has proposed an implicit geometric partition method. First, the bounding box of the point cloud (2^{d}^{ₓ}, 2^{d}^{_{y}}, 2^{d}^{_{z}}) is calculated; assuming that dₓ>d_{y}>d_{z}, the bounding box corresponds to a cuboid. During geometric partition, the binary tree partition is continuously performed along the x-axis to obtain two child nodes until the condition dₓ=d_{y}>d_{z} is satisfied; then the quadtree partition is performed along the x-axis and y-axis to obtain four child nodes. When the condition dₓ=d_{y}=d_{z} is finally satisfied, the octree partition is continuously performed until the partitioned leaf nodes are unit cubes of 1×1×1, at which the octree partition stops, and the points in the leaf nodes are encoded to generate a binary bitstream. During the binary tree/quadtree/octree partition process, two parameters (K and M) are introduced. The parameter K indicates the maximum number of binary tree/quadtree partitions before performing octree partition. The parameter M indicates that the minimum corresponding block side length when performing binary tree/quadtree partition is 2^{M}. At the same time, K and M must satisfy the conditions: assuming that dₘₐₓ=max(dₓ, d_{y}, d_{z}), dₘᵢₙ=min(dₓ, d_{y}, d_{z}), the parameter K satisfies: K≥dₘₐₓ−dₘᵢₙ; and the parameter M satisfies: M≥dₘᵢₙ. The reason why parameters K and M satisfy the above conditions is that, currently, in geometric implicit partition process of G-PCC, the priority of partitioning manners is binary tree, quadtree and octree; when the node block size does not satisfy the condition for binary tree/quadtree, octree partition is continuously performed on the node until the partitioned leaf node is the minimum unit cube of 1×1×1. The octree-based geometric information encoding mode can effectively encode the geometric information of point cloud by using the correlation between neighbouring points in space. However, for relatively flat nodes or nodes with planar characteristics, the encoding efficiency for point cloud geometric information can be further improved by using planar encoding.

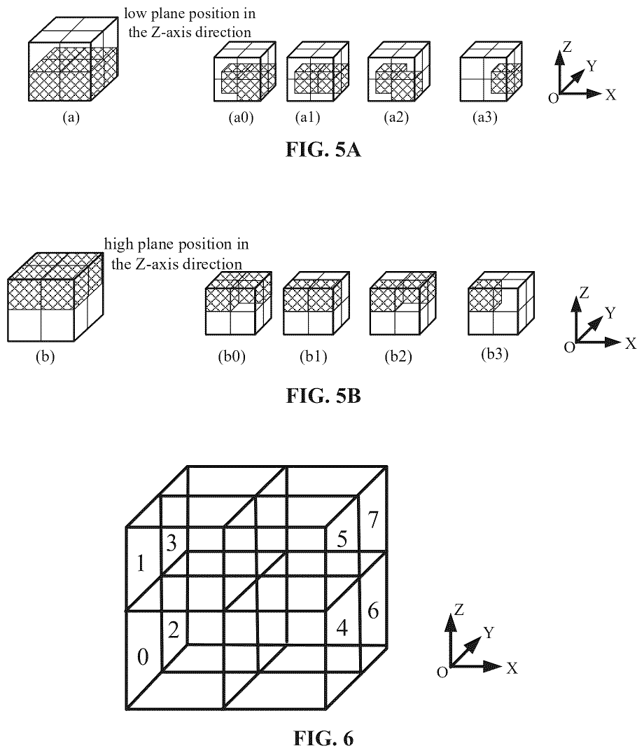

Exemplarily, FIG. 5A and FIG. 5B are schematic diagrams of plane positions. FIG. 5A is a schematic diagram of a low plane position in the Z-axis direction, and FIG. 5B is a schematic diagram of a high plane position in the Z-axis direction. As illustrated in FIG. 5A, (a), (a0), (a1), (a2), and (a3) here all belong to the low plane position in the Z-axis direction. Taking (a) as an example, it can be seen that the occupied four child nodes in the current node are all located at the low plane position of the current node in the Z-axis direction, so it may be considered that the current node belongs to a Z-plane and is a low plane in the Z-axis direction. Similarly, as illustrated in FIG. 5B, (b), (b0), (b1), (b2), and (b3) here all belong to the high plane position in the Z-axis direction. Taking (b) as an example, it can be seen that the occupied four child nodes in the current node are all located at the high plane position of the current node in the Z-axis direction, so it may be considered that the current node belongs to a Z-plane and is a high plane in the Z-axis direction.

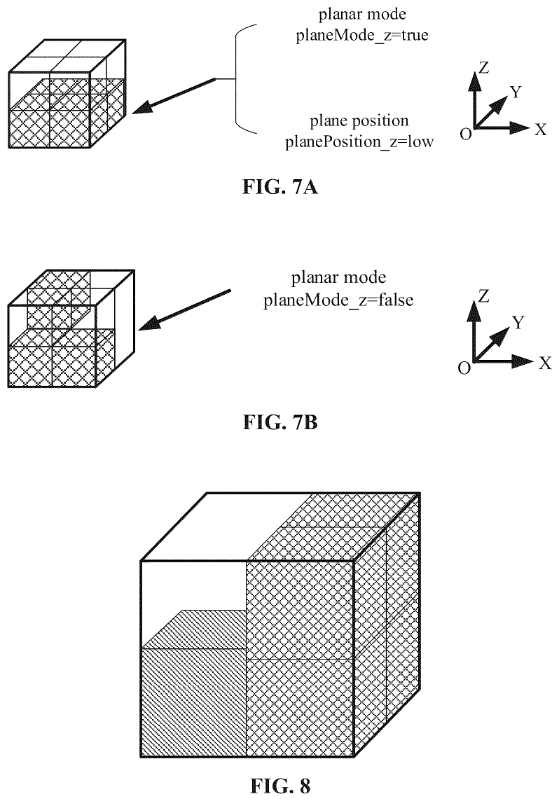

Further, taking (a) in FIG. 5A as an example, a comparison is made between the encoding efficiency of octree encoding and the encoding efficiency of planar encoding. FIG. 6 is a schematic diagram of the node encoding sequence, that is, nodes are encoded in the sequence of 0, 1, 2, 3, 4, 5, 6, and 7 as illustrated in FIG. 6. Here, if the octree encoding manner is adopted for (a) in FIG. 5A, the occupancy information of the current node is represented as: 11001100. However, if the planar encoding manner is adopted: first, an identifier is required to be encoded to indicate that the current node is a plane in the Z-axis direction, and if the current node is the plane in the Z-axis direction, the plane position of the current node is required to be represented; secondly, only the occupancy information of the low plane nodes in the Z-axis direction (that is, the occupancy information of the four child nodes 0, 2, 4, and 6) is required to be encoded, and thus, encoding the current node by using planar encoding manner requires only 6 bits, which can reduce the representation of 2 bits compared to the octree encoding manner in related technologies. Based on this analysis, planar encoding manner has a notably encoding efficiency compared to octree encoding manner. Therefore, for an occupied node, if planar encoding is used for encoding in a certain dimension: first, the planar mode (planarMode) information and plane position (PlanePos) information of the current node in this dimension are required to be represented; and secondly, the occupancy information of the current node is required to be encoded based on the planar information of the current node. Exemplarily, FIG. 7A is a schematic diagram of a planar mode information. As illustrated in FIG. 7A, it illustrates a low plane in the Z-axis direction; accordingly, the value of the planar mode information is true or 1, that is, planarMode_z=true; plane position information is low plane (low), that is, PlanePosition_z=low. FIG. 7B is another schematic diagram of planar mode information. As illustrated in FIG. 7B, it illustrates that no plane is formed in the Z-axis direction; accordingly, the value of the planar mode information is false or 0, that is, planarMode_z=false.

It should be noted that for PlaneMode_{_i}: 0 represents that the current node is not a plane in the i-axis direction; and 1 represents that the current node is a plane in the i-axis direction. If the current node is a plane in the i-axis direction, for PlanePosition_{_i}: 0 represents that the current node is a plane in the i-axis direction and the plane position is a low plane, and 1 represents that the current node is a high plane in the i-axis direction. Here, i represents a coordinate dimension, which may be the X-axis direction, the Y-axis direction, or the Z-axis direction, so i=0, 1, 2.

In the G-PCC standard, when determining whether a node satisfies the planar encoding condition and in case that the node satisfies the planar encoding condition, prediction encoding for the planar mode information and plane position information of the node is required.

In the embodiments of the disclosure, there are three determination conditions in the current G-PCC standard for determining whether a node satisfies planar encoding condition, which will be described in detail one by one below.

### 1. Determination Based on the Planar Probability of the Node in Each Dimension.

(1) Determine the local region density (local_node_density) of the current node;
(2) Determine the probability Prob(i) of the current node in each dimension.

When the local region density of the node is less than the threshold Th (e.g., Th=3), the planar probability Prob(i) of the current node in three coordinate dimensions is compared with the thresholds Th0, Th1, and Th2, where Th0<Th1<Th2 (e.g., Th0=0.6, Th1=0.77, Th2=0.88). Here, Eligibleᵢ (i=0, 1, 2) may be used to indicate whether planar encoding is enabled in each dimension: Eligibleᵢ=Prob(i)>=threshold.

It should be noted that the threshold changes adaptively, for example, when Prob(0)>Prob(1)>Prob(2), Eligibleᵢ is set as follows:

$${Eligible}_{0} = Prob ( 0 ) >= Th 0 ; {Eligible}_{1} = Prob ( 1 ) >= Th 1 ;$$

$${Eligible}_{2} = Prob ( 2 ) >= Th 2 .$$

When Prob(1)>Prob(0)>Prob(2), Eligibleᵢ is set as follows:

$${Eligible}_{0} = Prob ( 0 ) >= Th 1 ; {Eligible}_{1} = Prob ( 1 ) >= Th 0 ;$$

$${Eligible}_{2} = Prob ( 2 ) >= Th 2 .$$

Here, the update of Prob(i) is as follows:

$${Prob ( i )}_{new} = ( L \times Prob ( i ) + δ ( coded node ) ) / L + 1 \qquad ( 1 )$$

Herein, L=255. In addition, if the node (coded node) is a plane, δ(coded node) is 1; otherwise, δ(coded node) is 0.

Here, the update of local_node_density is as follows:

$$local\_node {\_density}_{n e w} = local\_node \_density + 4 * numSiblings \qquad ( 2 )$$

Here, local_node_density is initialized to 4, numSiblings is the number of sibling nodes of the node. Exemplarily, FIG. 8 is a schematic diagram of sibling nodes of a current node. As illustrated in FIG. 8, the current node is a node filled with diagonal lines, and the nodes filled with grid lines is sibling nodes, the number of sibling nodes of the current node is 5 (including the current node itself).

### 2. Determine Whether the Nodes of the Current Layer Satisfy the Planar Encoding Based on the Point Cloud Density of the Current Layer.

The point density of the current layer is used to determine whether to perform planar encoding on the nodes of the current layer. It is assumed that the number of points in the current point cloud to be encoded is pointCount, and the number of points that have been reconstructed through the Infer Direct Coding Model (IDCM) encoding is numPointCountRecon, and given that octree encoding is performed in a breadth-first traversal order, the number of nodes to be encoded in the current layer may be assumed as nodeCount; and then the condition for determining whether planar encoding is enabled in the current layer, may be assumed as planarEligibleKOctreeDepth, specifically: planarEligibleKOctreeDepth=(pointCount-numPointCountRecon)<nodeCount×1.3.

Here, if (pointCount-numPointCountRecon) is less than nodeCount×1.3, planarEligibleKOctreeDepth is true. If (pointCount-numPointCountRecon) is not less than nodeCount×1.3, planarEligibleKOctreeDepth is false. In this way, when planarEligibleKOctreeDepth is true, the planar encoding is performed on all nodes in the current layer; otherwise, no planar encoding is performed on all nodes in the current layer, and only octree encoding is used.

### 3. Determine Whether the Current Node Satisfy the Planar Encoding Based on the Acquisition Parameters of the Lidar Point Cloud.

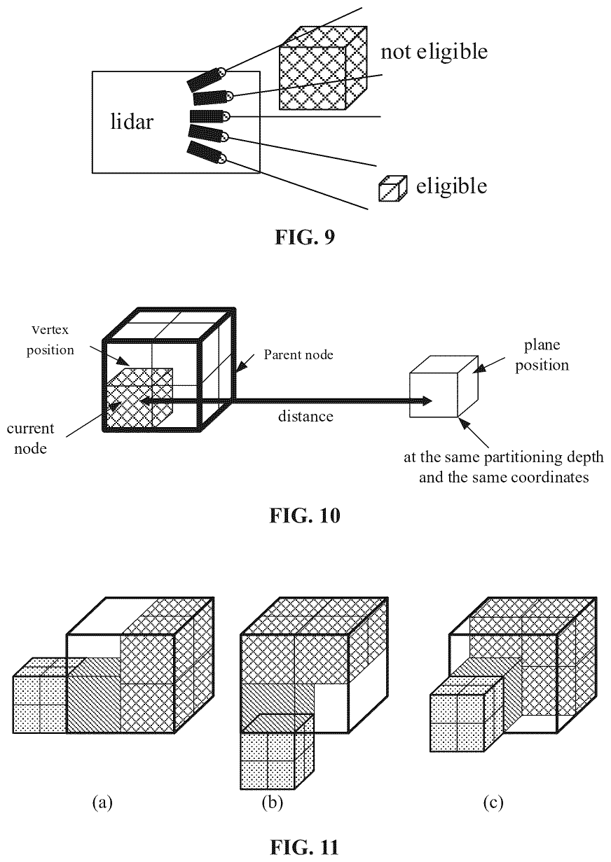

FIG. 9 is a schematic diagram of the intersection of a lidar and nodes. As illustrated in FIG. 9, the node filled with grid lines is passed through by two laser rays (Lasers) simultaneously, which indicates that the current node does not form a plane in the Z-axis vertical direction; a node filled with diagonal lines is small enough that it cannot be passed through by two laser rays (Lasers) simultaneously, which indicates that the node filled with diagonal lines may potentially form a plane in the Z-axis vertical direction.

Further, for a node satisfying the planar encoding condition, predictive encoding may be performed on the planar mode information and the plane position information.

First, for predictive encoding for planar mode information:
here, only three pieces of context information are used for encoding, that is, separate contextual designs for the planar modes in respective coordinate dimension are performed.

Secondly, for predictive encoding for plane position information:
it should be understood that, for encoding of plane position information in a non-lidar point cloud, predictive encoding for plane position information may include the following:
   (a) the plane position information of the current node obtained through performing prediction based on the occupancy information of the neighbouring node is divided into three elements: predicted as low plane, predicted as high plane, and unpredictable;
   (b) the spatial distance between the current node and the node at the same partitioning depth and at the same coordinates as the current node: “near” and “far”;
   (c) if the node at the same partitioning depth and the same coordinates as the current node is a plane, the plane position of the node is determined;
   (d) Coordinate dimensions (i=0, 1, 2).

It should be noted that in the embodiments of the disclosure, after determining the spatial distance between the current node and the node at the same partitioning depth and at the same coordinates as the current node, if the spatial distance is less than a preset distance threshold, it may be determined that the spatial distance is “near”. Or, if the spatial distance is greater than the preset distance threshold, it may be determined that the spatial distance is “far”.

Exemplarily, FIG. 10 is a schematic diagram of a neighbouring node at the same partitioning depth and the same coordinates. As illustrated in FIG. 10, the bold large cube represents the parent node, and the small cube filled with grid lines inside the bold large cube represents the current node, and the vertex position of the current node is illustrated; the small cube filled with white represents the neighbouring node at the same partitioning depth and the same coordinates. The distance between the current node and the neighbouring node is the spatial distance, which can be determined as “near” or “far”. In addition, if the neighbouring node is a plane, the Plane position (Planar position) of the neighbouring node is also required.

In this way, as illustrated in FIG. 10, if the current node is a small cube filled with grid lines, neighbouring node is searched for under the same octree partitioning depth level and the same vertical coordinate, represented by the small cube filled with white, and the distance between the two nodes is determined as “near” or “far”, and the plane position of the node is referred to.

Further, in the embodiments of the disclosure, FIG. 11 is a schematic diagram of a current node located at the low plane position of the parent node. As illustrated in FIG. 11, (a), (b), (c) illustrate three examples of current node located in the low plane position of the parent node. Specific descriptions are as follows.
\textcircled{1} If any of the child nodes 4 to 7 of the dot-filled node is occupied and the grid-filled nodes are unoccupied, it is highly probable that a plane exists in the current node (filled with diagonal lines) and the plane is located low;
\textcircled{2} If the child nodes 4 to 7 of the dot-filled node are unoccupied, and any of grid-filled nodes is occupied, it is highly probable that a plane exists in the current node (filled with diagonal lines), and the plane is located high.
\textcircled{3} If the child nodes 4 to 7 of the dot-filled node are all empty nodes, and the grid-filled nodes are all empty nodes, the plane position cannot be inferred, so it is marked as unknown.
\textcircled{4} If any of the child nodes 4 to 7 of the dot-filled node is occupied, and any of the grid-filled nodes is occupied, the plane position cannot be inferred at this time, so it is marked as unknown.

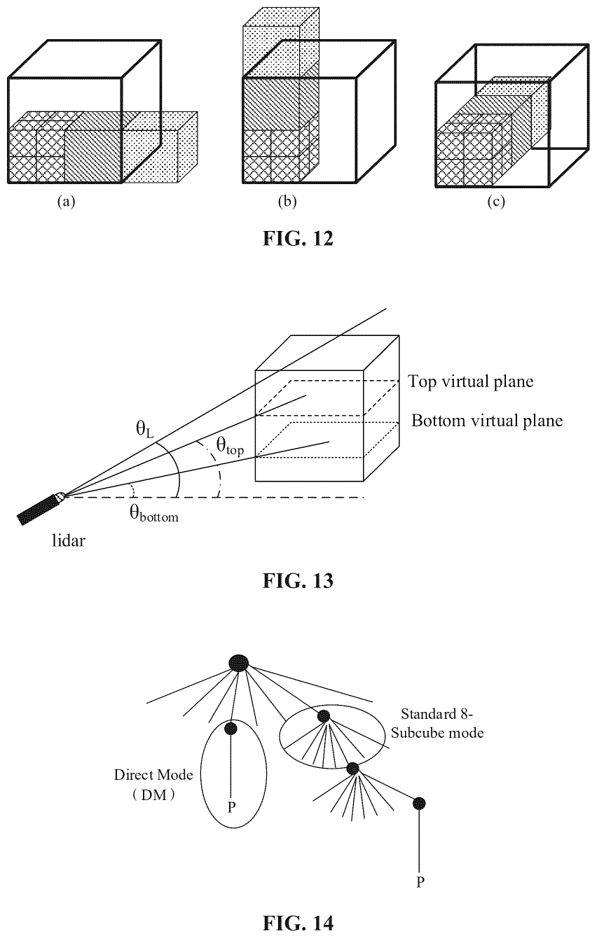

In an embodiments of the disclosure, FIG. 12 is a schematic diagram of a current node located at the high plane position of the parent node. As illustrated in FIG. 12, (a), (b), (c) illustrate three examples of the current node located at the high plane position of the parent node. Specific descriptions are as follows.
\textcircled{1} If any of the child nodes 4 to 7 of grid-filled node is occupied and the dot-filled node is unoccupied, it is highly probable that a plane exists in the current node (filled with diagonal lines) and the plane is located low.
\textcircled{2} If the child nodes 4 to 7 of grid-filled node are unoccupied, and the dot-filled node is occupied, it is highly probable that a plane exists in the current node (filled with diagonal lines) and the plane is located high.
\textcircled{3} If the child nodes 4 to 7 of grid-filled node are all unoccupied, and the dot-filled node is unoccupied, the plane position cannot be inferred at this time, so it is marked as unknown.
\textcircled{4} If one of the child nodes 4 to 7 of grid-filled node is occupied, and the dot-filled node is occupied, the plane position cannot be inferred at this time, so it is marked as unknown.

It should also be understood that, for the encoding of plane position information in lidar point clouds, FIG. 13 is a schematic diagram of predictive encoding of lidar point cloud plane position information. As illustrated in FIG. 13, when the emission angle of the lidar is θ_{bottom}, it may be mapped to a low plane (Bottom virtual plane). When the emission angle of the lidar is θₜₒₚ, it may be mapped to a high plane (Top virtual plane).

That is, the plane position of the current node is predicted by using the lidar acquisition parameters, and the position is quantified into multiple intervals by using the position where the current node intersects with the laser, which finally serves as context information of the plane position of the current node. The specific calculation process is as follows: assuming that the coordinates of the lidar are (x_{Lidar}, y_{Lidar}, z_{Lidar}) and the geometric coordinates of the current node are (x, y, z), the vertical tangent value tan θ of the current node relative to the lidar is first calculated by using the following calculation formula:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Furthermore, since each laser has a certain offset angle relative to the lidar, it is also necessary to calculate the relative tangent value tan θ_{corr,L} of the current node relative to the laser, the specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, the relative tangent value tan θ_{corr,L} of the current node is used to predict the plane position of the current node. Specifically, assuming that the tangent value of the lower boundary of the current node is tan (θ_{bottom}) and the tangent value of the upper boundary is tan(θₜₒₚ), the plane position is quantized into four quantization intervals based on tan θ_{corr,L}, thereby determining the context information of the plane position.

However, octree-based geometric information encoding mode has an efficient compression rate only for points with correlation in space. For points in isolated positions in geometric space, the complexity can be greatly reduced by using the Direct Coding Mode (DCM). For all nodes in the octree, the use of DCM is not represented by flag bit information, but is inferred based on the parent node and neighbouring information of the current node. There are three manners to determine whether the current node is eligible for DCM encoding, as follows:
(1) The current node has no sibling nodes and child nodes, that is, the parent node of the current node has only one child node, and a parent node of the parent node of the current node has only two occupied child nodes, in other words, the current node has at most one neighbouring node.
(2) The parent node of the current node has only the current node as an occupied child node, and the six neighbouring nodes sharing a face with the current node are all empty nodes.
(3) The number of sibling nodes of the current node is greater than 1.

Exemplarily, FIG. 14 is a schematic diagram of an IDCM encoding. If the current node is not eligible for DCM encoding, octree partitioning is performed on the current node. Conversely, if it is eligible, the number of points included within this node is determined. When the number of points is less than a threshold (e.g., 2), DCM encoding is performed on this node; otherwise, octree partitioning will continue. When applying the DCM encoding mode, the first step is to encode whether the current node is a true isolated point, i.e., to encode IDCM_flag. When IDCM_flag is true, DCM encoding is adopted for the current node; otherwise, octree encoding is still adopted. When the current node satisfies the condition for DCM encoding, DCM encoding mode for the current node is required to be encoded. Currently, there are two DCM modes: (a) only one point exists (or multiple points, but they are duplicate points); (b) two points exist. Finally, the geometric information of each point is required to be encoded. Assuming a side length of the node is 2^{d}, encoding each component of the geometric coordinates of the node requires d bits, which are directly signalled into the bitstream. It should be note that when encoding lidar point clouds, coordinate information in three dimensions may be predictively encoded by using lidar acquisition parameters, thereby further improving encoding efficiency of geometric information.

Further, the process of IDCM encoding will be described in detail below.

When the current node satisfies the DCM encoding mode, the number (numPoints) of points of the current node is first encoded; and the number of points of the current node is encoded based on different DirectModes:
(1) If the current node does not satisfy the requirements of the DCM node, the process exits directly (i.e., the number of points is greater than 2 and the points are not duplicate points).
(2) If the number (numPoints) of points included in the current node is less than or equal to 2, the encoding process is as follows:
   i) whether the numPoints of the current node is greater than 1 is first encoded;
   ii) if the current node has only one point and the geometry encoding environment is lossless geometry encoding, it is necessary to encode that the second point of the current node is not a duplicate point.
(3) If the number (numPoints) of points included in the current node is greater than 2, the encoding process is as follows:
   i) numPoints of the current node less than or equal to 1 is first encoded;
   ii) then, the second point of the current node being a duplicate point is encoded, and then, whether the number of duplicate points of the current node is greater than 1 is encoded, and when the number of duplicate points is greater than 1, exponential-Golomb decoding is applied for the number of remaining duplicate points.

After encoding the number of points of the current node, coordinate information of the points included in the current node is encoded. Lidar point clouds and human-eye-oriented point clouds will be introduced in detail below.

### 1. Human-Eye-Oriented Point Cloud.

(1) If the current node includes only one point, the geometric information of the point in the three dimensional directions will be directly encoded (Bypass coding).
(2) If the current node includes two points, the priority encoding axis (dirextAxis) may be obtained first by using the geometric coordinates of the points. It should be noted here that the compared coordinate axes currently only include the x-axis and y-axis, excluding the z-axis. Assuming that the geometric coordinate of the current node is nodePos, the determination manner is as follows:

$$dirextAxis = ! ( nodePos [ 0 ] < nodePos [ 1 ] ) \qquad ( 5 )$$

That is, the axis with the smaller geometric position in terms of node coordinates is set as the priority encoding axis, dirextAxis, and the geometric information of the priority encoding axis (dirextAxis) is first encoded in the following manner. Assume that the geometry bit depth to be encoded corresponding to the priority encoding axis is nodeSizeLog2, and assume that the coordinates of the two points are pointPos[0] and pointPos[1], respectively. The specific encoding process is as follows:

```
  Bool sameBit=true;
  while(nodeSizeLog2&& sameBit){
      int mask=1<< nodeSizeLog2;
      --nodeSizeLog2;
      bool bit0=!!( pointPos[0]& mask)
bool bit1=!!( pointPos[1]& mask)
      sameBits=bit0==bit1;
      entropyCodeSameBit(sameBits); ///<entropy coding
      if(sameBits)
        encodePosBit(bit0);///<Bypass coding
    }
```

After encoding the priority encoding axis dirextAxis, direct encoding of the geometric coordinate of the current node is continued. Assuming that the remaining encoding bit depth of each point is nodeSizeLog2, the specific encoding process is as follows:

$$for ( int axisId x \text{=0;} axisIdx \text{<3;} ++ a xisIdx )$$

$$for ( int mask \text{=(} 1<< nodeSizeLog 2 [ axisIdx ] \text{)>>1;} mask ; m ask \text{>>1} )$$

$$encodePosBit ( \text{!!(} pointPos [ axisIdx \text{]\&} mask ) ) .$$

### 2. Lidar Point Cloud.

If the current node includes two points, the priority encoding axis (dirextAxis) is first obtained by using the geometric coordinates of the points. Assuming that the geometric coordinate of the current node is nodePos, the determination manner is as follows:

$$dirextAxis = ! ( nodePos [ 0 ] < nodePos [ 1 ] )$$

That is, the axis with the smaller geometric position in terms of the node coordinates is set as the priority encoding axis, dirextAxis. Here, it should be noted that the compared axes currently include only the x-axis and the y-axis, excluding the z-axis. Subsequently, the geometric information of the priority encoding axis (dirextAxis) is first encoded in the following manner. Assuming that the geometry bit depth to be encoded corresponding to the priority encoding axis is nodeSizeLog2, and assuming that the coordinates of the two points are pointPos[0] and pointPos[1] respectively. The specific encoding process is as follows:

```
  Bool sameBit=true;
  while(nodeSizeLog2&& sameBit){
      int mask=1<< nodeSizeLog2;
      --nodeSizeLog2;
      bool bit0=!!( pointPos[0]& mask)
bool bit1=!!( pointPos[1]& mask)
      sameBits=bit0==bit1;
      entropyCodeSameBit(sameBits);
      if(sameBits)
        encodePosBit(bit0);
    }
```

After encoding priority encoding axis (dirextAxis), the geometric coordinate of the current node is encoded.

Since the acquisition parameters of lidar point cloud can be obtained through lidar point cloud, the geometric coordinate information of the current node can be predicted by using these parameters, thereby further improving the encoding efficiency of the geometric information of the point cloud. Similarly, the geometric information nodePos of the current node is first used to determine a primary axis direction for direct encoding. Then, the geometric information from the already encoded direction is used to predictively encode the geometric information in another dimension. Assuming that the axis direction for direct encoding is directAxis and that the bit depth to be encoded in the direct encoding process is nodeSizeLog2, the encoding manner is as follows:

$$\begin{matrix}for ( int mask = ( 1 ≪ nodeSize Log 2 ) ≫ 1 ; mask ; mask ; ≫ 1 ) ; \\ encodePosBit ( ! ! ( pointPos [ directAxis ] \& mask ) ) .\end{matrix}$$

It should be noted here that all the geometric precision information of the directAxis direction will be encoded here.

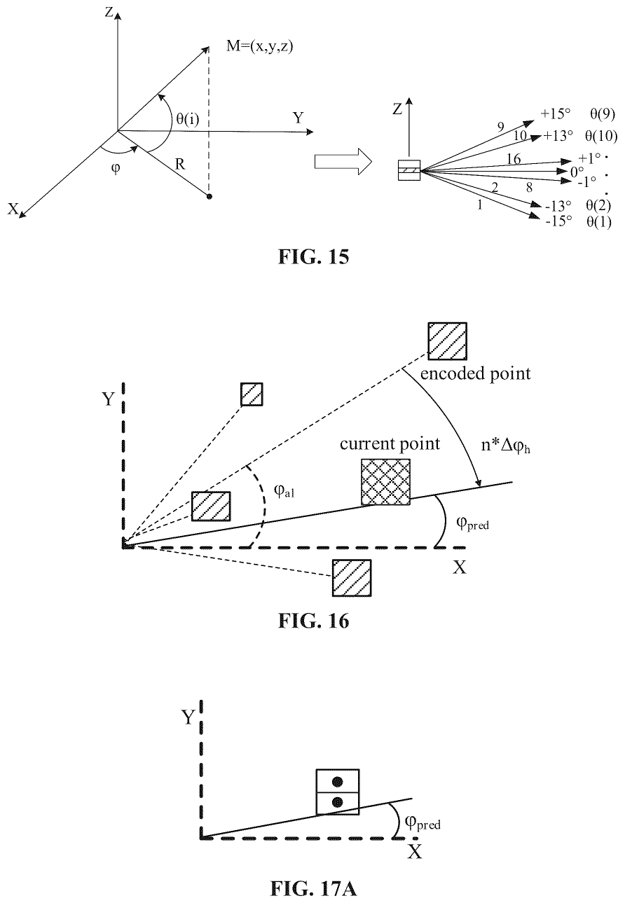

Exemplarily, FIG. 15 is a schematic diagram of coordinate conversion for point clouds acquired by rotating lidar. In the Cartesian coordinate system, the (x, y, z) coordinates of each node may be converted to (R, φ, i) representation. In addition, the laser scanners may perform laser scanning at preset angles, and different θ(i) may be obtained under different values of i. For example, when i is equal to 1, θ(1) may be obtained, and the corresponding scanning angle is −15°; when i is equal to 2, θ(2) may be obtained, and the corresponding scanning angle is −13°; when i is equal to 10, θ(10) may be obtained, and the corresponding scanning angle is +13°; when i is equal to 19, θ(19) may be obtained, and the corresponding scanning angle is +15°.

Thus, after encoding all the precision information in the directAxis coordinate direction, the LaserIdx for the current point, namely the pointLaserIdx number in FIG. 15, is first calculated; and the LaserIdx for the current node, namely nodeLaserIdx, is calculated. Subsequently, the LaserIdx for the node (nodeLaserIdx) is used to predictively encode the LaserIdx for the point (pointLaserIdx). The calculation manners for the LaserIdx of either the node or the point are as follows. Assuming the geometric coordinate of the point is pointPos, the starting coordinate of the laser is LidarOrigin, and assuming that the number of laser is LaserNum, a tangent value of each laser is tan θᵢ, and an offset position of each laser in the vertical direction is Zᵢ, then:

```
      Int bestLaserIdx=0;
      Int Distoration=INT_MAX;
  For(int LaserIdx=0; LaserIdx<numLaser;++ LaserIdx){
int radius = √(pointPos[0] − LidarOrigin[0])2 + (pointPos[1] − LidarOrigin[1])2
      int invRadius=1/ radius
      int Z=pointPos[2]+ Zᵢ
      int tanTheta= Z×invRadius
      if(std::abs(tanTheta-tanθᵢ)< Distoration){
        Distoration= std::abs(tanTheta-tanθᵢ);
        bestLaserIdx= LaserIdx;
        }
    }
```

After the LaserIdx of the current point is calculated, the pointLaserIdx of the point is first predictively encoded by using the LaserIdx of the current node. After the LaserIdx of the current point is encoded, predictive encoding is performed on the geometric information of the current point in the three dimensions by using the acquisition parameters of the lidar.

Exemplarily, FIG. 16 is a schematic diagram of predictive encoding in an X-axis or Y-axis direction. As illustrated in FIG. 16, the box filled with grid lines represents the current point, and boxes filled with diagonal lines represent the already coded point. Here, the prediction value (φ_{pred}) of the horizontal azimuth angle is first obtained by using the LaserIdx corresponding to the current point. Next, the horizontal azimuth angle (φ_{node}) for the node is obtained by using the geometric information of the node corresponding to the current point. Assuming the geometric coordinate of the node is nodePos, the calculation manner for the horizontal azimuth angle φ and the geometric information of the node is as follows:

$$φ = arc tan ( nodePos [ 1 ] / nodePos [ 0 ] ) \qquad ( 6 )$$

By using the acquisition parameters of the lidar, the number(numPoints) of rotation points of each laser may be obtained (representing the number of points obtained per full rotation of each laser), and the rotational angular velocity (deltaPhi) of each laser may be calculated by using the number of rotation points of each laser, and the calculation manner is as follows:

$$deltaPhi = \frac{2 π}{numPoints} \qquad ( 7 )$$

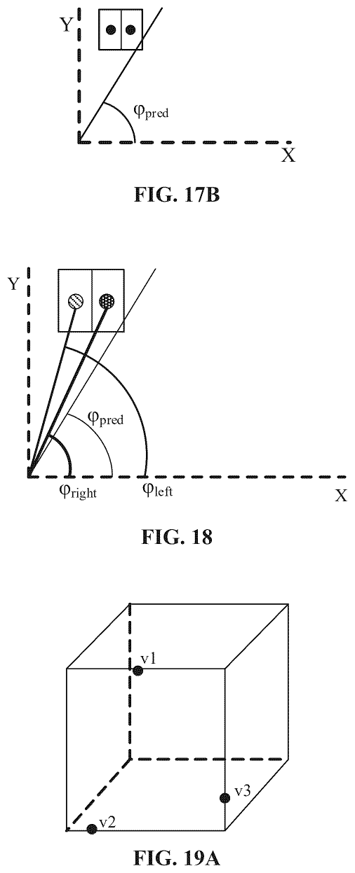

Further, a prediction value φ_{predPoint} of the horizontal azimuth angle for the current point (that is, the prediction value of the horizontal azimuth angle illustrated in FIG. 17A and FIG. 17B) is calculated by using the horizontal azimuth angle φ_{node} of the node and the horizontal azimuth angle φ_{pred} of the previously encoded point of the laser corresponding to the current point. Here, FIG. 17A is a schematic diagram of predicting an angle in the Y-plane through horizontal azimuth angle, and FIG. 17B is a schematic diagram of predicting an angle in the X-plane through horizontal azimuth angle. Here, for the prediction value φ_{predPoint} of the horizontal azimuth angle for the current point, the calculation manner is as follows:

$${φ}_{predPoint} = \frac{φ pred - φ node}{deltaPhi} \times deltaPhi + φ pred \qquad ( 8 )$$

Exemplarily, FIG. 18 is a schematic diagram of another X-axis or Y-axis predictive encoding. As illustrated in FIG. 18, the portion filled with grid lines (left side) represents the low plane, the portion filled with dots (right side) represents the high plane, φ_{left} represents the low-plane horizontal azimuth angle of the current node, φ_{right} represents the high-plane horizontal azimuth angle of the current node, and φ_{pred} represents a prediction value of the horizontal azimuth angle for the current node.

In this way, the geometric information of the current node is predictively encoded by using the prediction value φ_{predPoint} of the horizontal azimuth angle and the low-plane horizontal azimuth angle φ_{left} and high-plane horizontal azimuth angle φ_{right} of the current node, as detailed below:

$$\begin{matrix}int angLel = {φ}_{left} - {φ}_{pred} ; \\ int angLeR = {φ}_{right} - {φ}_{pred} ; \\ int context = ( angLel \geq 0 \&\& angLeR \geq 0 ) ‖ ( angLel < 0 \&\& angLeR < 0 ) ? 0 : 2 ; \\ int min Angle = std ∷ min ( abs ( angLel ) , abs ( angLeR ) ) ; \\ int max Angle = std ∷ max ( abs ( angLel ) , abs ( angLeR ) ) ; \\ context += max Angle > min Angle ? 0 : 1 ; \\ context += max Angle > min Angle ? 0 : 4.\end{matrix}$$

After the LaserIdx of the point is encoded, predictive encoding is performed on the Z-axis direction of the current point by using the LaserIdx for the current point, that is, the depth information (radius) of the radar coordinate system is first calculated by using the x and y information of the current point, and then the tangent value of the current point and the offset in the vertical direction are obtained by using the laser LaserIdx of the current point, so that the prediction value (Z_pred) of the Z-axis direction of the current point may be obtained, as detailed below:

$$\begin{matrix}int radius = \sqrt{{( pointPos [ 0 ] - LidarOrigin [ 0 ] )}^{2} + {( pointsPos [ 1 ] - LidarOrigin [ 1 ] )}^{2}} ; \\ int tan Theta = tan {θ}_{laserIdx} ; \\ int zOffset = {Z}_{laserIdx} ; \\ Z\_pred = radius \times tan Theta - zOffset .\end{matrix}$$

Further, predictive encoding is performed on the geometric information in the Z-axis direction of the current point by using Z_pred to obtain the prediction residual Z_res, and finally Z_res is encoded.

It should be noted that when a node is partitioned into leaf nodes, under the condition of geometry-lossless encoding, the number of duplicate points within the leaf nodes needs to be encoded. Finally, the occupancy information of all nodes is encoded to generate a binary bitstream. Additionally, G-PCC currently introduces a planar encoding mode. During the process of partitioning the geometry, it is determined whether the child nodes of the current node are in the same plane. If the child nodes of the current node satisfy the condition for being on the same plane, this plane is used to represent the child nodes of the current node.

For octree-based geometry decoding, the decoder follows a breadth-first traversal order. Before decoding the occupancy information of each node, the decoder first uses the already reconstructed geometric information to determine whether the planar decoding or IDCM decoding is performed for the current node. If the current node satisfies the condition for planar decoding, the decoder first decodes the planar mode information and plane position information of the current node, and then decodes the occupancy information of the current node based on the planar information. If the current node satisfies the condition for IDCM decoding, the decoder first determines whether the current node is a true IDCM node. If the current node is a true IDCM node, the decoder proceeds to parse the DCM decoding mode of the current node, followed by obtaining the number of points within the current DCM node, and finally decoding the geometric information of each point. For nodes that do not satisfy the condition for either planar decoding or DCM decoding, the occupancy information of the current node is decoded. By continuously parsing the occupancy codes of each node in this manner and continuously partitioning the nodes until unit cubes of 1×1×1 are obtained, the number of points included in each leaf node is parsed, ultimately restoring the geometrically reconstructed point cloud information.

The process of IDCM decoding is described in detail below.

Similar to the processing at the encoding end, the prior information is first used to determine whether the IDCM is enabled for the node Specifically, the enabling conditions for IDCM are as follows:
(1) The current node has no sibling nodes and child nodes, that is, the parent node of the current node has only one child node, and a parent node of the parent node of the current node has only two occupied child nodes, in other words, the current node has at most one neighbouring node.
(2) The parent node of the current node has only the current node as an occupied child node, and the six neighbouring nodes sharing a face with the current node are all empty nodes.
(3) The number of sibling nodes of the current node is greater than 1.

Further, when the node satisfies the condition for DCM encoding, whether the current node is a true DCM node is first decoded, i.e., IDCM_flag is first decoded; When IDCM_flag is true, DCM encoding is used for the current node, otherwise, octree encoding is still used.

Subsequently, the number (numPoints) of points of the current node is decoded. The specific decoding process is as follows.
i) It first decodes whether the numPoints of the current node is greater than 1.
ii) If it is decoded that numPoints of the current node is greater than 1, it continues to decode whether the second point is a duplicate point. If the second point is not a duplicate point, it may be implicitly inferred that the second type of DCM mode is satisfied, including only two points.
iii) If it is decoded that numPoints of the current node is less than or equal to 1, it continues to decode whether the second point is a duplicate point. If the second point is not a duplicate point, it may be implicitly inferred that the second type of DCM mode is satisfied, including only one point. If it is decoded that the second point is a duplicate point, it may be inferred that the third type of DCM mode is satisfied, including multiple points, all of which are duplicate points. Then, it continues to decode whether the number of duplicate points is greater than 1 (using entropy decoding). If the number of duplicate points is greater than 1, it decodes the number of remaining duplicate points (using Exponential-Golomb decoding).

If the current node does not satisfy the requirements of the DCM node, the process exits directly (i.e. the number of points is greater than 2, and the points are not duplicate points).

After decoding the number of points in the current node, coordinate information of the points included in the current node is decoded. Lidar point cloud and human-eye-oriented point cloud will be introduced in detail below.

### 1. Human-Eye-Oriented Point Cloud.

(1) If the current node includes only one point, the geometric information of the point in the three dimensional directions will be directly decoded (Bypass coding).
(2) If the current node includes two points, the priority decoding axis (dirextAxis) may be obtained first by using the geometric coordinates of the points. It should be noted here that the compared coordinate axes currently only include the x-axis and y-axis, excluding the z-axis. Assuming that the geometric coordinate of the current node is nodePos, the determination manner is as follows:

$$dirextAxis = ! ( nodePos [ 0 ] < nodePos [ 1 ] ) \qquad ( 9 )$$

That is, the axis with the smaller geometric position in terms of node coordinates is set as the priority decoding axis, dirextAxis, and the geometric information of the priority decoding axis (dirextAxis) is first decoded in the following manner. Assume that the geometry bit depth to be decoded corresponding to the priority decoding axis is nodeSizeLog2, and assume that the coordinates of the two points are pointPos[0] and pointPos[1], respectively. The specific decoding process is as follows:

```
Bool sameBit=true;
while(nodeSizeLog2&& sameBit){
  pointPos[0][ dirextAxis]<<1;
  pointPos[1][ dirextAxis]<<1;
  --nodeSizeLog2;
        int bit=0;
      deEntropyCodeSameBit(sameBits); ///<entropy coding
        if(sameBits){
            bit =decodePosBit( );///<Bypass coding
            pointPos[0][ dirextAxis]|= bit
          pointPos[1][ dirextAxis]|= bit
        }else
            pointPos [1] [dirextAxis] | = 1///< The reason is that during encoding, two
        points are sorted in the direction of the priority encoding axis. This ensures
        pointPos[0][dirextAxis]<pointPos[1][dirextAxis]. Thus, during decoding, if
        the bit information of the two points is different, it can be inferred that the bit
        of the first point is 0 and the bit of the second point is 1.
    }
```

After decoding the priority decoding axis dirextAxis, the direct decoding of the geometric coordinate of the current point is continued. Assuming that the remaining coding bit depth of each point is nodeSizeLog2, and the coordinate information of the point is pointPos, the specific decoding process is as follows:

```
for(int axisIdx=0;axisIdx<3;++axisIdx)
for(int idx= nodeSizeLog2[axisIdx]; idx; idx--){
    pointPos[axisIdx]<<1;
    pointPos[axisIdx]|=decodePosBit( );
  }
```

### 2. Lidar Point Cloud.

If the current node includes two points, the priority decoding axis (dirextAxis) is first obtained by using the geometric coordinates of the points. Assuming that the geometric coordinate of the current node is nodePos, the determination manner is as follows:

$$dirextAxis = ! ( nodePos [ 0 ] < nodePos [ 1 ] ) \qquad ( 10 )$$

That is, the axis with the smaller geometric position in terms of the node coordinates is set as the priority decoding axis, dirextAxis. Here, it should be noted that the compared axes currently include only the x-axis and the y-axis, excluding the z-axis. Subsequently, the geometric information of the priority encoding axis (dirextAxis) is first decoded in the following manner. Assuming that the geometry bit depth to be encoded corresponding to the priority decoding axis is nodeSizeLog2, and assuming that the coordinates of the two points are pointPos[0] and pointPos[1] respectively. The specific coding process is as follows:

```
Bool sameBit=true;
while(nodeSizeLog2&& sameBit){
  pointPos[0][ dirextAxis]<<1;
  pointPos[1][ dirextAxis]<<1;
        --nodeSizeLog2;
        int bit=0;
      deEntropyCodeSameBit(sameBits); ///<entropy coding
        if(sameBits){
            bit =decodePosBit( );///<Bypass coding
            pointPos[0][ dirextAxis]|= bit
          pointPos[1][ dirextAxis]|= bit
        }else
            pointPos [1] [dirextAxis] | = 1///< The reason is that during encoding, two
        points are sorted in the direction of the priority encoding axis. This ensures
        pointPos[0][dirextAxis] < pointPos[1][dirextAxis]. Thus, during decoding, if
        the bit information of the two points is different, it can be inferred that the bit
        of the first point is 0 and the bit of the second point is 1.
    }
```

After decoding the priority decoding axis dirextAxis, the geometric coordinate of the current point is decoded.

Similarly, a primary axis direction for direct decoding is first obtained by using the geometric information nodePos of the current node. Then the geometric information of another dimension is decoded by using the geometric information of the already decoded direction. Similarly, assuming that the directly decoded axis direction is directAxis, and the bit depth to be decoded in direct decoding is nodeSizeLog2, the decoding manner is as follows:

```
for(int idx= nodeSizeLog2[directAxis]; idx; idx--){
    pointPos[directAxis]<<1;
    pointPos[directAxis]|=decodePosBit( );
  {
```

It should be noted here that all the geometric precision information of the directAxis direction will be decoded here.

After decoding all the precision information of the directAxis coordinate direction, the LaserIdx of the current node (i.e. nodeLaserIdx) is calculated first. Subsequently, the LaserIdx of the node (i.e. nodeLaserIdx) is used to predictively decode the LaserIdx of the point (i.e. pointLaserIdx), where the calculation manners for the LaserIdx of the node or point is the same as that of the encoding end. Finally, prediction residual information (ResLaserIdx) between the LaserIdx of the current point and the LaserIdx of the node is decoded, and the decoding method is as follows:

$$PointLaserIdx = nodeLaserIdx + ResLaserIdx \qquad ( 11 )$$

After decoding the LaserIdx of the current point, the geometric information of the current point in the three dimensions is predictively decoded by using the acquisition parameters of the lidar. The specific algorithm is as follows:

As illustrated in FIG. 11, the prediction value (φ_{pred}) of the horizontal azimuth angle is first obtained by using the LaserIdx corresponding to the current point. Next, the horizontal azimuth angle (φ_{node}) for the node is obtained by using the geometric information of the node corresponding to the current point. Assuming the geometric coordinate of the node is nodePos, the calculation manner for the horizontal azimuth angle φ and the geometric information of the node is as follows:

$$φ = arc tan ( nodePos [ 1 ] / nodePos [ 0 ] ) \qquad ( 12 )$$

By using the acquisition parameters of the lidar, the number (numPoints) of rotation points of each laser may be obtained (representing the number of points obtained per full rotation of each laser), and the rotational angular velocity (deltaPhi) of each laser may be calculated by using the number of rotation points of each laser, and the calculation manner is as follows:

$$deltaPhi = \frac{2 π}{numPoints} \qquad ( 13 )$$

Further, a prediction value φ_{predPoint} of the horizontal azimuth angle for the current point (that is, the prediction value of the horizontal azimuth angle illustrated in FIG. 17A and FIG. 17B) is calculated by using the horizontal azimuth angle φ_{node} of the node and the horizontal azimuth angle φ_{pred} of the previously encoded point of the laser corresponding to the current point. The calculation manner is as follows:

$${φ}_{predPoint} = \frac{φ pred - φ node}{deltaPhi} \times deltaPhi + φ pred \qquad ( 14 )$$

In this way, the geometric information of the current node is predictively decoded by using the prediction value φ_{predPoint} of the horizontal azimuth angle and the low-plane horizontal azimuth angle φ_{left} and high-plane horizontal azimuth angle φ_{right} of the current node, as detailed below:

$$\begin{matrix}int angLel = {φ}_{left} - {φ}_{pred} ; \\ int angLeR = {φ}_{right} - {φ}_{pred} ; \\ int context = ( angLel \geq 0 \&\& angLeR \geq 0 ) ‖ ( angLel < 0 \&\& angLeR < 0 ) ? 0 : 2 ; \\ int abs Angle L = abs ( angLel ) ; \\ int abs Angle R = abs ( angLeR ) ) ; \\ context += abs Angle L > abs Angle R ? 0 : 1 ; \\ context += max Angle > min Angle ≪ 1 ? 4 : 0.\end{matrix}$$

After the LaserIdx of the point is decoded, predictive decoding is performed on the Z-axis direction of the current point by using the LaserIdx for the current point, that is, the depth information (radius) of the radar coordinate system is first calculated by using the x and y information of the current point, and then the tangent value of the current point and the offset in the vertical direction are obtained by using the laser LaserIdx of the current point, so that the prediction value (Z_pred) of the Z-axis direction of the current point may be obtained, as detailed below:

$$\begin{matrix}int radius = \sqrt{( pointPos [ 0 ] - LidarOrigin [ 0 ] ) 2 + ( pointPos [ 1 ] - LidarOrigin [ 1 ] ) 2} ; \\ int tan Theta = tan {θ}_{laserIdx} ; \\ int zOffset = {Z}_{laserIdx} ; \\ Z\_pred = radius \times tan Theta - zOffset .\end{matrix}$$

Further, the geometric information in the Z-axis direction of the current point is reconstructed by using the decoded Z_res and Z_pred.

For triangle-soup (trisoup)-based geometry information encoding, in the trisoup-based geometry information encoding framework, geometric partitioning is also performed first. However, unlike the binary/quad/octree-based geometry information encoding, this method does not require progressive partition of the point cloud into unit cubes with side lengths of 1×1×1. Instead, this method stops partitioning when the side length of the sub-blocks (blocks) reaches W. Based on the surface formed by the distribution of point clouds within each block, up to twelve intersection points (vertices) are obtained where the surface intersects with the twelve edges of the block. The vertex coordinates of each block are then encoded sequentially to generate a binary bitstream.

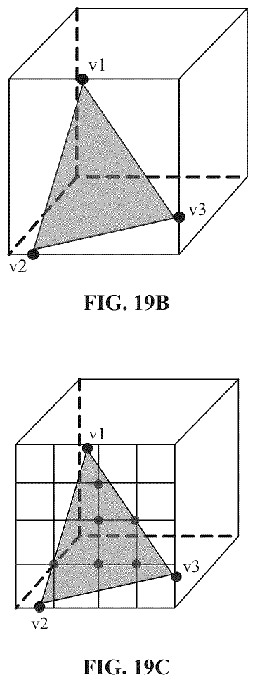

For trisoup-based point cloud geometry information reconstruction, during the reconstruction process of point cloud geometry information at the decoding end, the vertex coordinates are first decoded to complete triangle soup reconstruction, as illustrated in FIG. 19A, FIG. 19B, and FIG. 19C. Specifically, in the block illustrated in FIG. 19A, there are three vertices (v1, v2, v3). The triangle-soup formed by these three vertices in a specific order is referred to as triangle soup, or trisoup, as illustrated in FIG. 19B. Subsequently, sampling is performed on this triangle soup, and the sampled points are used as the reconstructed point cloud within the block, as illustrated in FIG. 19C.

For Predictive geometry coding (PredGeomTree), the predictive geometry coding includes that: the input point cloud is first sorted, and currently adopted sorting manners include unordered, Morton ordered, azimuth ordered and radial distance ordered. At the encoding end, the prediction tree structure is constructed via two different manners, including: KD-Tree (high-latency slow mode) and low-latency fast mode (using lidar calibration information). When using lidar calibration information, each point is assigned into different lasers, and the prediction tree structure is established based on different lasers. Next, based on the prediction tree structure, each node in the prediction tree is traversed, and the geometric position information of the node is predicted by selecting different prediction modes to obtain the prediction residual, and the geometric prediction residual is quantized by using quantization parameters. Finally, through continuous iteration, the prediction residuals of node position information of prediction tree, prediction tree structure and quantization parameters are encoded to generate a binary bitstream.

For prediction tree-based geometry decoding, the decoding end reconstructs the prediction tree structure by continuously parsing the bitstream; then obtains quantization parameters and prediction residual information of the geometric position of each prediction node by parsing; and performs inverse quantization on the prediction residual to recover the reconstructed geometric position information for each node, and finally completes the geometric reconstruction at the decoding end.

After the geometry encoding is completed, the geometric information needs to be reconstructed. At present, attribute encoding is mainly performed for colour information. First, the colour information is converted from RGB colour space to YUV colour space. Then, the point cloud is recolored by using the reconstructed geometric information, to enable the unencoded attribute information to correspond to the reconstructed geometric information. In colour information encoding, there are mainly two transform methods: one is distance-based lifting transform that relies on LOD partitioning, and the other is direct RAHT transform. Both methods convert colour information from spatial domain to frequency domain, obtaining high-frequency coefficients and low-frequency coefficients through transform. Finally, these coefficients are quantized and encode to generate a binary bitstream, as detailed in FIG. 4A and FIG. 4B.

Further, when predicting attribute information by using geometric information, a nearest-neighbor search may be performed by using a Morton code. The Morton code corresponding to each point in the point cloud may be obtained from the geometric coordinates of the point. The specific method of calculating the Morton code is described as follows. For a three-dimensional coordinate where each component is represented by a d-bit binary number, its three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 15 )$$

Where [symbol] , [symbol] , [symbol] ∈{0,1}represent binary values corresponding to the most significant bit ( [symbol] =1) to the least significant bit ( [symbol] =d) of x, y and z, respectively. Morton code M is computed by interleaving the bits of x, y, z from the most significant bit to the least significant bit, where [symbol] , [symbol] and [symbol] are alternately arranged. The formula for calculating M is as follows:

$$M = {Σ}_{ℓ = 1}^{d} {2}^{3 ( d - ℓ )} ( 4 {x}_{ℓ} + 2 {y}_{ℓ} + {z}_{ℓ} ) = {Σ}_{{ℓ}^{′} = 1}^{3 d} {2}^{3 d - {ℓ}^{′}} {m}_{{ℓ}^{′}} \qquad ( 16 )$$

Where [symbol] ′∈{0,1}represent the values of the most significant bit ( [symbol] ′=1) to the least significant bit ( [symbol] ′=3d) of M, respectively. After the Morton code M for each point in the point cloud is obtained, the points in the point cloud are sorted in ascending order of the Morton code, and the weight w for each point is set to 1.

It should also be understood that for the G-PCC coding framework, the general test conditions are as follows:

(1) There are 4 test conditions:
Condition 1: geometric position with bounded loss, the attribute with lossy;
Condition 2: lossless geometric position, the attributes with lossy;
Condition 3: lossless geometric position, the attributes with bounded lossy;
Condition 4: lossless geometric position, lossless attributes.

(2) The general test sequence includes four categories: Cat1A, Cat1B, Cat3-fused, and Cat3-frame. The Cat2-frame point cloud only includes reflectance attribute information, the Cat1A and Cat1B point clouds only include colour attribute information, and the Cat3-fused point cloud includes both colour and reflectance attribute information.

(3) Technical routes: there are two approaches, which are distinguished by the algorithm used for geometric compression.

### Technical Route 1: Octree Encoding Branch.

At the encoding end, the bounding box is recursively partitioned into sub-cubes; non-empty sub-cubes (containing points in point cloud) are further partitioned until leaf nodes are unit cubes of size 1×1×1, at which point partitioning stops. In lossless geometry encoding, the number of points included in each leaf node is encoded to complete the geometric octree encoding, generating a binary bitstream.

At the decoding, the decoder performs processes in a breadth-first traversal order; continuously parses to obtain the occupancy codes for each node, recursively partitions nodes until unit cubes of 1×1×1 are obtained, at which the partitioning stops. For lossless geometry decoding, the number of points included in each leaf node is parsed to ultimately reconstruct the geometric point cloud information.

### Technical Route 2: Prediction Tree Coding Branch.

At the encoding side, the prediction tree structure is established by using two different manner, including: (1) KD-Tree (high-latency slow mode) and (2) LiDAR calibration information (low-latency fast mode). When using lidar calibration information, each point may be assigned into different lasers, and the prediction tree structure is established based on different lasers. Next, based on the prediction tree structure, each node in the prediction tree is traversed, and the geometric position information of the node is predicted by selecting different prediction modes to obtain the prediction residual, and the geometric prediction residual is quantized by using quantization parameters. Finally, through continuous iteration, the prediction residuals of node position information of prediction tree, prediction tree structure and quantization parameters are encoded to generate a binary bitstream.

At the decoding end, the decoding end reconstructs the prediction tree structure by continuously parsing the bitstream; then obtains quantization parameters and prediction residual information of the geometric position of each prediction node by parsing; and performs inverse quantization on the prediction residual to recover the reconstructed geometric position information for each node, and finally completes the geometric reconstruction at the decoding end.

It should also be noted that, as illustrated in FIG. 4A or FIG. 4B, the current G-PCC encoding framework includes three attribute encoding methods: a predicting transform (PT), a Lifting Transform (LT), and a Region-adaptive Hierarchical Transform (RAHT). The first two methods perform predictive encoding of point clouds based on the LOD generation order, while RAHT adaptively transforms attribute information from the bottom to top based on the construction hierarchical structure of the octree. Below, each of these three point cloud attribute encoding methods is described in detail.

### (a) Predictive Encoding of Point Cloud Attribute Information.

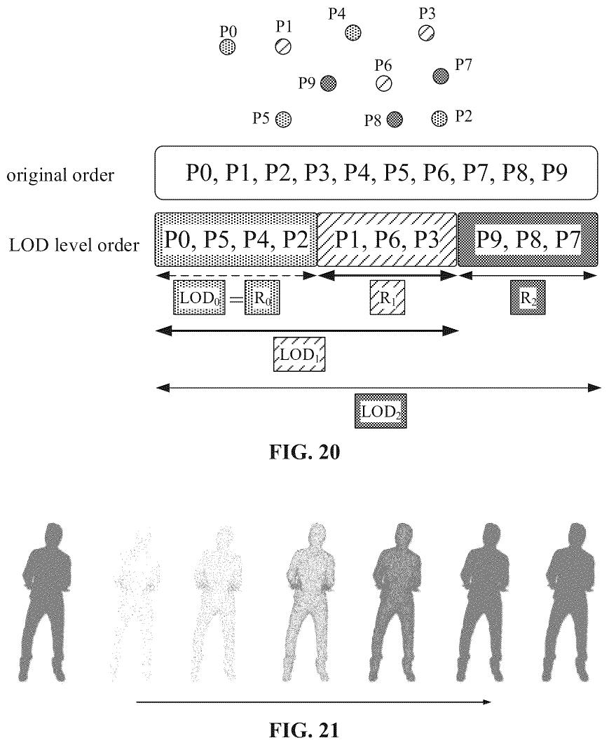

At present, the attribute prediction module of G-PCC adopts a nearest neighbor attribute predictive encoding scheme based on a LoDs structure, and the construction method of LOD includes a distance-based LOD construction, a fixed sampling rate-based LOD construction scheme, and an octree-based LOD construction scheme. In the distance threshold-based LoD construction scheme, Morton sorting is performed on the point cloud before constructing LOD to ensure strong attribute correlation between neighbouring points. FIG. 20 is a schematic diagram of a distance-based LOD construction process. As illustrated in FIG. 20, based on the L Manhattan distances (dl) preset by the user, l=0, 1, . . . L−1; the point cloud is partitioned into L different point cloud detail levels (Rl), l=0, 1, . . . L−1, where (dl) l=0, 1, . . . L−1, satisfying dl<dl−1. The LOD construction process is described below:

(1) First, all points in the point cloud are marked as unvisited, and a set V is established to store the visited points; (2) for each iteration l, by traversing the points in the point cloud, the current point is ignored if this current point has been visited. Otherwise, the minimum distance D from the current point to the point set V is calculated. If D<dl, the point is ignored; otherwise, the current point is marked as visited and added to the refinement level R1 and point set V; (3) the points in detail level LOD1 are composed of points in the refinement levels R0, R1, R2 . . . R1; (4) the above steps are repeated until all points are marked as visited.

Based on the LoD structure, linear weighted prediction is performed on the attribute value of each point by using the reconstructed attribute values of points in the same level or a higher LoD level. The maximum number of reference prediction neighbors is determined by high-level syntax elements in the encoder. For the attribute of each point, the encoder adopts a rate-distortion optimization algorithm to select either weighted prediction by using the attributes of N nearest-neighbouring points or prediction by using the attribute of a single nearest-neighbouring point. Finally, the selected prediction mode and prediction residuals are encoded.

$${{Attr}_{i}}^{′} = Round ( \frac{1}{N} {\sum }_{m ϵ {p}_{i}} \frac{\frac{1}{{D}_{m}^{2}}}{{Σ}_{m ϵ {p}_{i}} \frac{1}{{D}_{m}^{2}}} A t t {r}_{m} ) \qquad ( 17 )$$

Here, N represents the number of prediction points in the nearest-neighbouring point set of point i, Pi represents the set of N nearest-neighbouring points of point i, Dm represents the spatial geometric distance from nearest-neighbouring point m to the current point i, Attrm represents the reconstructed attribute value of nearest-neighbouring point m, and Attrᵢ′ represents the attribute prediction value for the current point i. The number (N) of points is a preset value.

In order to balance attribute encoding efficiency and parallel processing across different LoD levels, a switch is introduced in the high-level syntax elements of the encoder to control whether LoD level intra prediction is enabled. If enabled, LoD level intra prediction allows the use of points within the same LoD level for prediction. Note that when the number of LoD levels is 1, LoD level intra prediction is always used.

FIG. 21 is a schematic diagram of the visualization result of a LOD generation process. As illustrated in FIG. 21, a subjective example of a distance-based LOD generation process is provided here. Specifically (from left to right): the points in the first level represent the outer contour of the point cloud; with the increase of detail levels, the detail description of point cloud becomes progressively clearer.

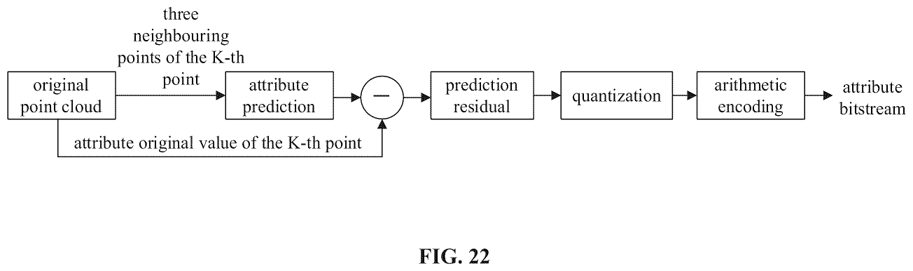

FIG. 22 is a schematic diagram of an encoding process of an attribute prediction. As illustrated in FIG. 22, regarding the specific process of G-PCC attribute prediction, for the original point cloud, three neighbouring points of the K-th point are first searched, and then attribute prediction is performed; the prediction residual of the K-th point may be obtained by calculating the difference between the attribute prediction value of the K-th point and the attribute original value of the K-th point; then quantization and arithmetic encoding are performed, and finally the attribute bitstream is generated.

### (i) Selection of Optimal Prediction Value:

After the LOD construction is completed, based on the LOD generation order, the three nearest-neighbouring points of the current point to be encoded are first searched from the already encoded data points. Taking the reconstructed attribute values of the three nearest-neighbouring points as the candidate prediction values of the current point to be coded; then, the optimal prediction value is selected from the candidate prediction values based on Rate-Distortion Optimal (RDO). For example, when encoding the attribute value of the point P2 in FIG. 20, the prediction variable index of the attribute value of the nearest neighbouring point P4 is set to 1; the attribute prediction variable indexes of the second-nearest neighbouring point P5 and the third-nearest neighbouring point P0 are set to 2 and 3, respectively; a prediction variable index of the weighted average of the points P0, P5, and P4 is set to 0, as illustrated in Table 1; finally, the optimal prediction variable is selected by using RDO. The formula for the weighted average is as follows:

$${\hat{a}}_{i} = Round ( {\sum }_{j = 0}^{2} \frac{{\tilde{w}}_{i j}}{{Σ}_{j = 0}^{2} {\tilde{w}}_{i j}} {ã}_{j} ) \qquad ( 18 )$$

Here, \tilde{w}ᵢⱼ represents the spatial geometric weight from the neighbouring point j to the current point i:

$${\tilde{w}}_{i j} = \frac{1}{{( {x}_{i} - {x}_{i j} )}^{2} + {( {y}_{i} - {y}_{i j} )}^{2} + {( {z}_{i} - {z}_{i j} )}^{2}} \qquad ( 19 )$$

âᵢ represents the attribute prediction value of the current point i; j represents the index of three neighbouring points; ãⱼ represents the reconstructed attribute value of the neighbouring point, xᵢ, yᵢ, zᵢ are the geometric position coordinates of the current point i, and xᵢⱼ, yᵢⱼ, zᵢⱼ; are the geometric coordinates of the neighbouring point j.

Exemplarily, Table 1 provides a sample example of candidate prediction terms for an attribute encoding.

TABLE 1

| Prediction Mode | Prediction value |
|---|---|
| 0 | Attribute weighted average of three neighbouring |
| | points |
| 1 | P4 (Attribute value of a nearest neighbouring point) |
| 2 | P5 (The attribute value of the second-nearest |
| | neighbouring point) |
| 3 | P0 (Attribute value of three-nearest neighbouring |
| | point) |

### (ii) Attribute Prediction Residual and Quantization:

Through the above prediction, the attribute prediction value (âᵢ)_{i∈0 . . . k-1} of the current point i is obtained (k is the total number of points in the point cloud). Let (aᵢ)_{i∈0 . . . k-1} denote the original attribute value of the current point, then the attribute residual (rᵢ)_{i∈0 . . . k-1} is define as:

$${r}_{i} = {a}_{i} - {\hat{a}}_{i} \qquad ( 20 )$$

The prediction residual is further quantized:

$${Q}_{i} = \frac{{r}_{i}}{Q s} \qquad ( 21 )$$

Here, Qᵢ represents the quantized attribute residual of the current point i; and Qs is the quantization step (Qs), which may be calculated through the Quantization Parameter (QP) specified by the CTC.

(iii) Reconstructed Attribute Value at Encoding End:

The purpose of reconstruction at the encoder end is to facilitate prediction for subsequent points. Before reconstructing the attribute values, inverse quantization is performed on the residual, and \hat{r}ᵢ denotes inverse-quantized residual:

$${\hat{r}}_{i} = {Q}_{i} \times Qs \qquad ( 22 )$$

\hat{r}ᵢ is added to the prediction value di to obtain the reconstructed value ãᵢ of point i:

$${\tilde{a}}_{i} = {\hat{r}}_{i} + {\hat{a}}_{i} \qquad ( 23 )$$

When performing attribute nearest-neighbor search based on LOD partitioning, two major categories of algorithms exist: intra nearest-neighbor search and inter nearest-neighbor search. The inter nearest-neighbor search algorithm is detailed as follows. The intra nearest-neighbor search may be divided into two algorithms: inter-level nearest-neighbor search algorithm and intra-level nearest-neighbor search algorithm.

### (i) Intra Nearest-Neighbor Search:

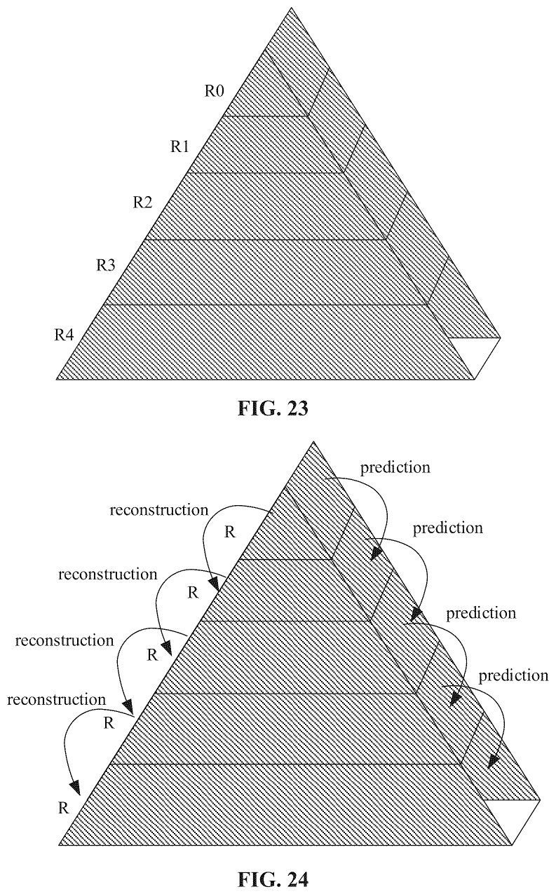

Intra nearest-neighbor search is divided into two algorithms: inter-level nearest-neighbor search algorithm and intra-level nearest-neighbor search algorithm. After partitioning LOD, the structure resembles a pyramid, as illustrated in FIG. 23.

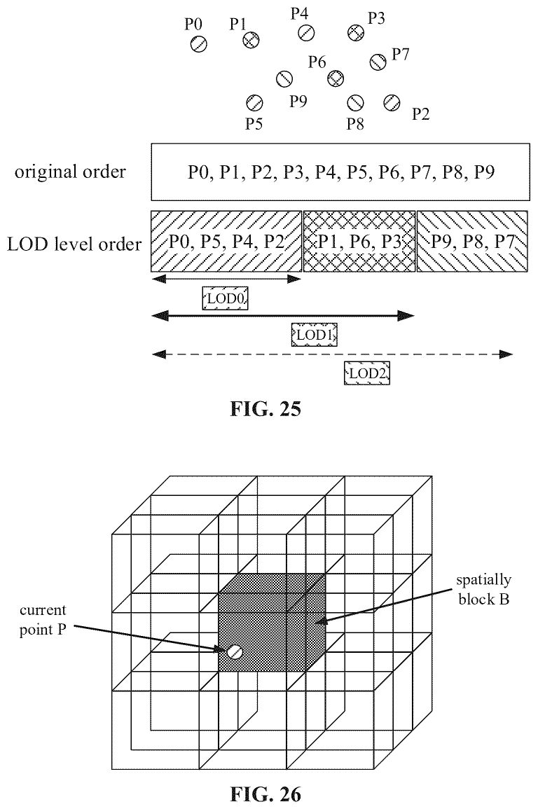

In a specific implementation, for the inter-level nearest-neighbor search, the pyramid structure is illustrated in FIG. 24. FIG. 25 is a schematic diagram of an LOD construction process for inter-level nearest-neighbor search. As illustrated in FIG. 25, different LOD levels (LOD0, LOD1 and LOD2) are obtained based on geometric information partitioning. In the process of the inter-level nearest-neighbor search, the points in LOD0 are used to predict the attributes of the points in the next LOD level.

The entire process of intra nearest-neighbor search will be described in detail below.

During the LOD partitioning process, there are three sets O(k), L(k), and I(k). Here, k represents the index of the LOD level during LOD partitioning, and I(k) represents the input point set for the current LOD level partitioning. After LOD partitioning, an O(k) set and an L(k) set are obtained. The O(k) set stores the sampled point set, and L(k) is the point set in the current LOD level. That is, the entire LOD partitioning process is as follows:
(1) Initialization,
   if k=0, (k)←{ }; otherwise, L(k)←L(k−1);
   O(k)←{ };
(2) Using the LOD partitioning algorithm, the sampled points are stored in O(k), and the remaining points are assigned into L(k);
(3) When performing the next iteration, I←(k).

It should be noted that since the entire LOD partitioning process is partitioned based on the Morton code, O(k), L(k), and I(k) store the Morton code index corresponding to the point.

When performing the inter-level nearest-neighbor search, the nearest-neighbor search for the points in the L(k) set is performed in the O(k) set. The specific search algorithm is as follows.

Taking spatial-relationship-based nearest-neighbor search as an example, when performing prediction for the current point P, the search is performed by using the parent block (Block B) of point P, as illustrated in FIG. 26. Attributes are predicted by searching points within coplanar and collinear neighbouring blocks relative to the current parent block.

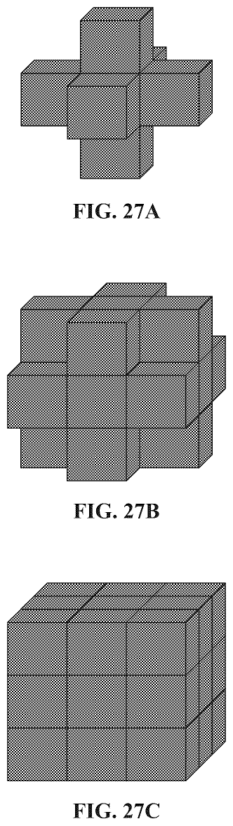

FIG. 27A is a schematic diagram of a coplanar spatial relationship, illustrating a total of 6 spatially blocks related to the current parent block. FIG. 27B is a schematic diagram of a coplanar and collinear spatial relationship, illustrating a total of 18 spatial blocks related to the current parent block. FIG. 27C is a schematic diagram of a coplanar, collinear, and co-point spatial relationship, illustrating a total of 26 spatial blocks related to the current parent block.

Firstly, the corresponding spatial block is obtained by using the coordinates of the current point, and then, the nearest-neighbor search is performed in the previously encoded LOD level, where spatial blocks that are coplanar, collinear, and co-point with the current block are searched to obtain the N nearest neighbors of the current point.

If, after performing the coplanar, collinear and co-point nearest neighbor search, the N nearest neighbors of the current point are still not obtained, the N nearest neighbors of the current point will be obtained based on the fast search algorithm. The specific algorithm is as follows.

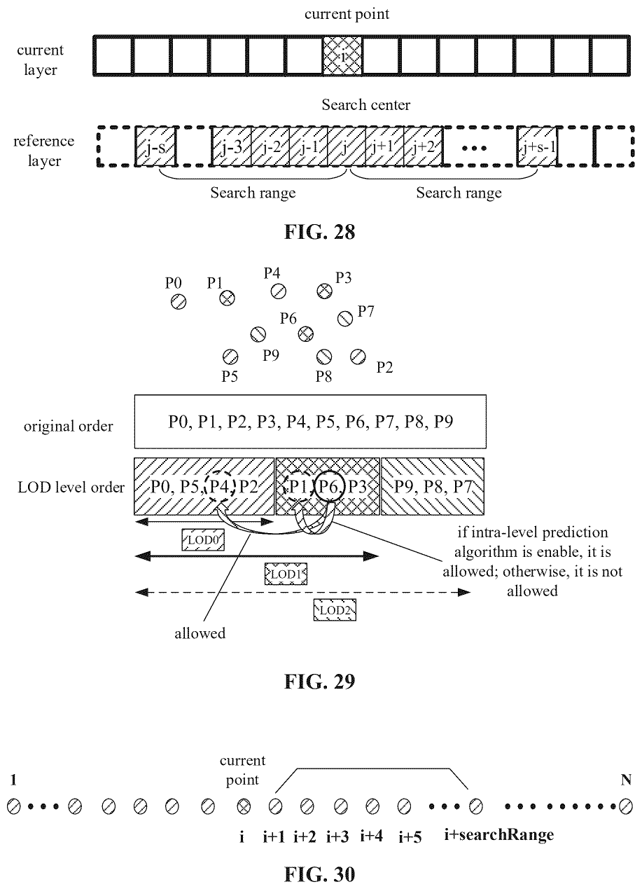

As illustrated in FIG. 28, when performing inter-level attribute prediction, the Morton code for the current point is first obtained by using the geometric coordinates of the current point to be encoded. Subsequently, the first reference point (j) greater than the Morton code of the current point is searched in the reference picture based on the Morton code of the current point; and then, the nearest neighbor search is performed within the range of [j−searchRange, j+searchRange].

Other specific algorithms for updating the nearest-neighbors are consistent with the inter nearest neighbor search algorithm, which is not elaborated here but will be specified in the inter nearest-neighbor search section.

In another specific implementation, for intra-level nearest-neighbor search, FIG. 29 is a schematic diagram of an LOD structure of an intra-level attribute nearest-neighbor search. As illustrated in FIG. 29, if the intra-level prediction algorithm is enabled, that is, the syntax element EnableRefferingSameLoD=1, the intra-level nearest-neighbor search may be allowed. For example, for the LOD1 level, the nearest neighbouring point of the current point P6 may be P1, and other levels are not allowed; If the syntax element EnableRefferingSameLoD=0, inter-level search is allowed in other levels. For example, for the LOD1 level, the nearest neighbouring point of the current point P6 may be P4. That is to say, when the intra-level prediction algorithm is enabled, the nearest-neighbor search will be performed in the encoded point set within the same LOD level to obtain the N nearest neighbors of the current point (the inter-level nearest-neighbor search will also be performed).

When performing intra-level attribute prediction, the nearest-neighbor search is performed based on a fast search algorithm, and the specific algorithm is illustrated in FIG. 30. Here, the current point is represented by a grid. Assuming that the Morton code index of the current point is i, the nearest-neighbor search will be performed in the range [i+1, i+searchRange]. The specific nearest-neighbor search algorithm is consistent with the inter block-based fast search algorithm, and will not be described in detail here.

### (ii) Inter Nearest-Neighbor Search:

FIG. 28 is a schematic diagram of an attribute inter prediction. As illustrated in FIG. 28, when performing attribute inter prediction, the Morton code for the current point is first obtained by using the geometric coordinates of the current point to be encoded. Subsequently, the first reference point (j) greater than the Morton code of the current point is searched in the reference picture based on the Morton code of the current point; and then, the nearest-neighbor search is performed within the range of [j-searchRange, j+searchRange].

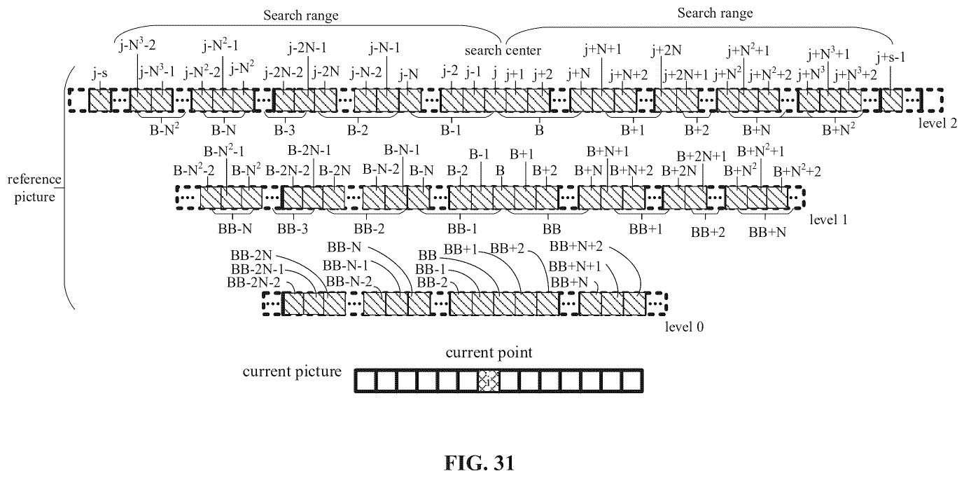

At present, when performing the intra and inter nearest-neighbor search, the neighborhood search is performed based on blocks. Specific details are illustrated in FIG. 31. As illustrated in FIG. 31, when performing neighborhood search for the current point (with Morton code index of i), the points in the reference picture are first partitioned into N (N=3) levels based on the Morton codes. The specific partitioning algorithm is as follows.
First level: assuming that the points of the reference picture are numPoints, the points in the reference picture are first partitioned into blocks, with each block including M (M=2⁵=32) points;
Second level: based on the first level, the blocks of the first level are also partitioned into larger blocks in the order of the Morton codes, with each larger block including M (M=2⁵=32) blocks from the first level;
Third level: based on the second level, the blocks of the second level are also partitioned into even larger blocks in the order of the Morton codes, with each even larger block including M (M=2⁵=32) blocks from the first level;

Finally, a prediction structure as illustrated in FIG. 31 is obtained.

When attribute prediction is performed based on the prediction structure as illustrated in FIG. 31, assuming that the Morton code index of the current point to be encoded is i, the first point equal to or greater than the Morton code of the current point is first obtained in the reference picture, and the index is j. Secondly, the block index of the reference point is calculated based on j, and the specific calculation method is as follows:
First level: BucketSize_0=2⁵=32;
Second level: BucketSize_1=2⁵=32×BucketSize_0=1024;
Third level: BucketSize_2=2⁵=32×BucketSize_1=32768.

Assuming that the reference range in the prediction picture for the current point is [j−searchRange, j+searchRange], the start index of the third level is calculated by using j−searchRange, and the end index of the third level is calculated by using j+searchRange. Next, within the third-level blocks, it is determined whether some second-level blocks require the nearest-neighbor search. Subsequently, moving to the second level, for each block in the first level, it is determined whether a search is required. If some first-level blocks require the nearest-neighbor search, a point-by-point determination is performed on the points within those first-level blocks to update the nearest neighbors.

Hereinafter, based on the algorithm of index calculation block, assuming that the Morton code index corresponding to the current point is index, the index of the corresponding third layer block is:

$$idx \_ 2 = index / {BucketSize}_{-} 2 \qquad ( 24 )$$

After obtaining the block index idx_2 of the third level, the start index and the end index of the block corresponding to the current block in the second level may be obtained by using idx_2:

$$s tartIdx 1 = {idx}_{-} 2 \times B u c k e t S i z {e}_{-} 1 \qquad ( 25 )$$

$$endIdx = {idx}_{-} 2 \times {BucketSize}_{-} 1 + {BucketSize}_{-} 1 - 1 \qquad ( 26 )$$

Similarly, the index of the first-level block is obtained based on the index of the second-level block by using the same algorithm.

When performing the block-based nearestneighbor search, it is first determined whether the current block requires the nearest-neighbor search, i.e., the nearest neighbor-search for selecting block(s). Each spatial block may be obtained by two variables (minPos and maxPos). minPos represents the minimum value of the block, and maxPos represents the maximum value of the block.

Assuming that the distance of the farthest point among the N nearest neighbors searched for the current point is Dist, the coordinates of the point to be encoded are (x, y, z), and the current block is expressed as (minPos, maxPos), where minPos is the minimum value in three dimensions of the bounding box, and maxPos is the maximum value in three dimensions of the bounding box, the distance D between the current point and the bounding box is calculated as follows:

$$int dx = int ( std \text{::} max ( std \text{::} max ( min Pos [ 0 ] - point [ 0 ] , 0 ) , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

When D is less than or equal to Dist, the points in the current block are traversed.

### (b) Lifting Transform Encoding for Point Cloud Attribute Information.

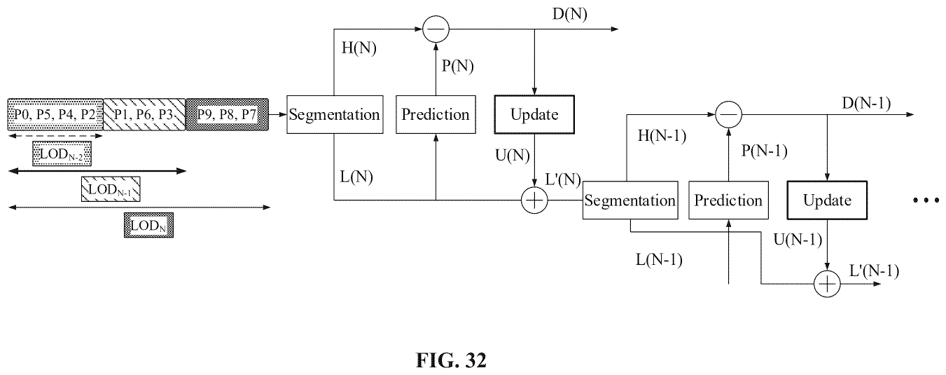

FIG. 32 is a schematic diagram of an encoding process of a lifting transform. Lifting transform is also used to perform predictive encoding for point cloud attributes based on LOD. The difference from the prediction transform is that: the lifting transform will first partition the LOD into high and low levels, perform prediction based on the reverse order of the LOD generation levels, and introduce an update operator in the prediction process to adjust the quantization weights of the low LOD level points for updating, thereby improving the prediction accuracy. This is because the attribute values of the low LOD level points are frequently used to predict the attribute values of the high LOD level points, and the low LOD level points should have greater influence.

### Step 1: Segmentation Process

The segmentation process divides the complete LOD level into a low LOD level L(N) and a high LOD level H(N). If a point cloud has three LOD levels, that is, (LODₗ)_{l=0,1,2}, after segmentation, LOD₂ is the high LOD level, denoted as H(N), and (LODₗ)_{l=0,1} is the low LOD level, denoted as L(N).

### Step 2: Prediction Process

For the points in the high LOD level, the attribute information of the nearest-neighbouring points from the low level is selected as the attribute prediction value P (N) for the current point to be coded, and the prediction residual D(N) is defined as:

$$D ( N ) = H ( N ) - P ( N ) \qquad ( 27 )$$

### Step 3: Update Process

The attribute prediction residual D(N) in the high LOD level is updated to obtain U(N), and the attribute values of the points in the low LOD level is enhanced by using U(N), as shown in the following formula:

$${L}^{′} ( N ) = L ( N ) + U ( N ) \qquad ( 28 )$$

The above process will be iterated sequentially from the highest to the lowest LOD level until the lowest LOD level is reached.

Since the LOD-based prediction scheme makes the points in the lower LOD levels have greater influence, the lifting wavelet transform-based transform scheme introduces quantization weights, and updates the prediction residual based on the prediction residual D(N) and the distance between the prediction point and the neighbouring point. Finally, it uses the quantization weights during the transform process to perform adaptive quantization of the prediction residual. It should be noted that at the decoding end, the quantization weight values for each point may be determined through geometric reconstruction, so there is no need to encode the quantization weights.

### (c) Regional Adaptive Hierarchical Transform.

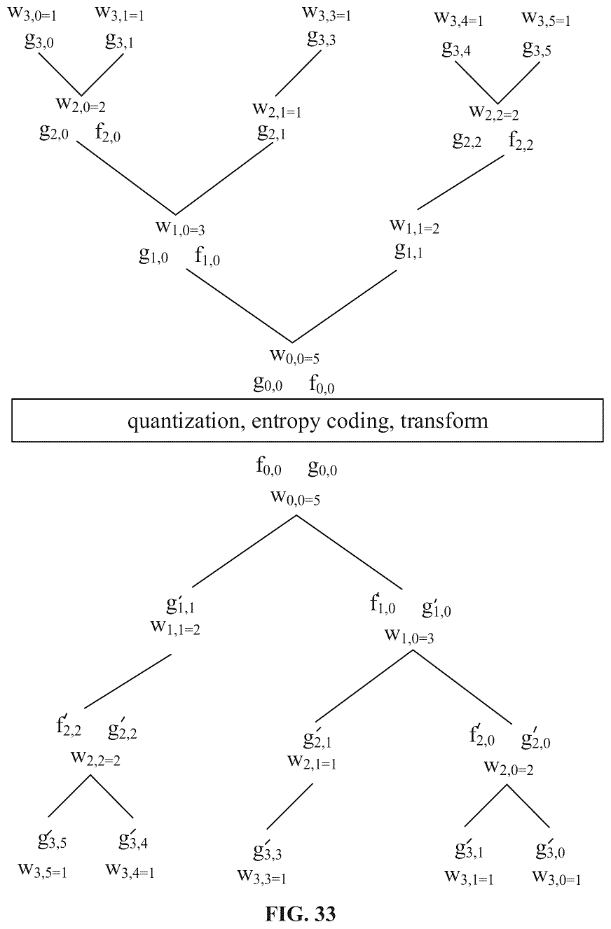

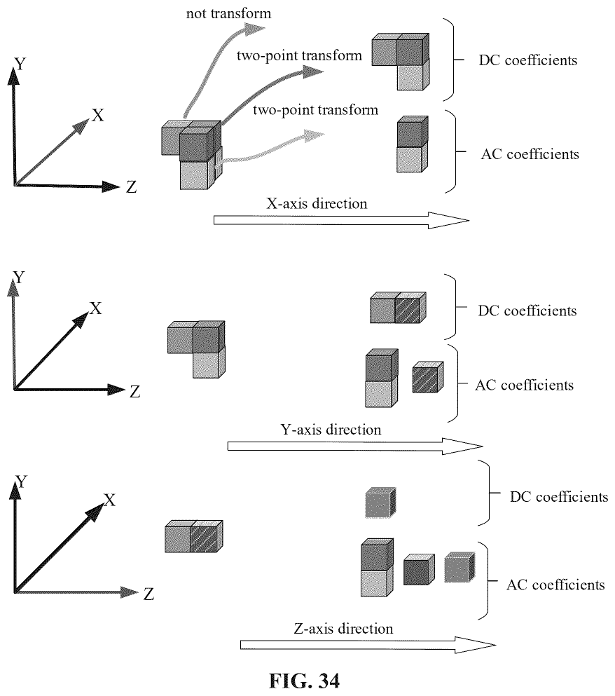

Region-adaptive hierarchical transform (RAHT) is a type of Haar wavelet transform that may transform point cloud attribute information from the spatial domain to the frequency domain, further reducing the correlation between point cloud attributes. Its main idea is to adopt transforms to nodes in each layer along the X, Y, and Z dimensions in a bottom-up manner based on the octree structure (as illustrated in FIG. 34), and iterate until reaching the root node of the octree. As illustrated in FIG. 33, its basic idea is to perform wavelet transforms based on the hierarchical structure of the octree, associating attribute information with octree nodes; recursive transforming the attributes of occupied nodes in the same parent node in a bottom-up manner; and performing transform on nodes in each layer along the X, Y, and Z dimensions until reaching the root node of the octree. During the hierarchical transform process, the low-pass/low-frequency (DC) coefficients obtained after transforming nodes in the same layer are transferred to nodes at the next layer for further transform, while all high-pass/high-frequency (AC) coefficients may be encoded by an arithmetic encoder.

In the transform process, the DC coefficients (direct current components) obtained after transforming nodes at the same layer are transferred to the upper layer for further transform, while the AC coefficients (alternating current components) obtained after transforming each layer are quantized and encoded. The main transform process is described below.

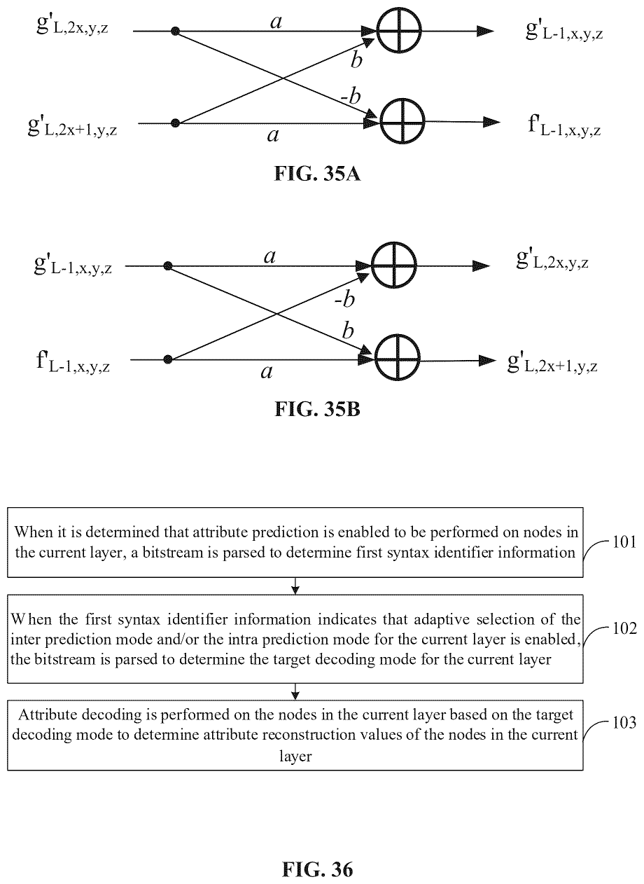

FIG. 35A is a schematic diagram of a forward RAHT transform process, and FIG. 35B is a schematic diagram of an inverse RAHT transform process. For the transform and inverse transform processes corresponding to RAHT, it is assumed that

$${g}_{L , 2 x , y , z}^{′} and {g}_{L , 2 x + 1 , y , z}^{′}$$

are two attribute DC coefficients of neighbouring points at layer L. After the linear transform, the information of the layer L−1 includes AC coefficient

$${f}_{L - 1 , x , y , z}^{′}$$

and DC coefficient

$$\begin{matrix}{g}_{L - 1 , x , y , z}^{′} . Then , \\ {f}_{L - 1 , x , y , z}^{′}\end{matrix}$$

will no longer be transformed and directly quantized and encoded;

$${g}_{L - 1 , x , y , z}^{′}$$

will continue to find the neighbouring points for further transform, and if no neighbouring points are found, it will be directly transferred to the layer L−2. In other words, the RAHT transform is only valid for the node with neighbouring points, and the node without neighbouring points will be directly transferred to the upper layer. In the above transform process, the weights (the number of non-empty child nodes in the node) corresponding to

$$\begin{matrix}{g}_{L , 2 , x , y , z}^{′} and {g}_{L - 2 x + 2 , y , z}^{′} are {w}_{L , 2 x , y , z}^{′} and \\ {w}_{L , 2 x + 1 , y , z}^{′} ( abbreviated as {w}_{0}^{′} and {w}_{1}^{′} )\end{matrix}$$

respectively, and the weight of

$${g}_{L - 1 , x , y , z}^{′} is {w}_{L - 1 , x y z}^{′} .$$

The general transform formula is as follows:

$$[ \begin{matrix}{g}_{L - 1 , x , y , z}^{′} \\ {f}_{L - 1 , x , y , z}^{′}\end{matrix} ] = {T}_{w0 , w 1} [ \begin{matrix}{g}_{L , 2 , x , y , z}^{′} \\ {g}_{L , 2 x + 1 , y , z}^{′}\end{matrix} ] \qquad ( 29 )$$

Here, T_{w0,w1} is the transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 30 )$$

The transform matrix is adaptively updated as the corresponding weights of each points change. The above process will be iteratively updated based on the partitioning structure of the octree until reaching the root node of the octree.

Briefly, in the existing G-PCC attribute RAHT (region-adaptive hierarchical transform) inter prediction encoding, the decision on whether to adopt a specific inter prediction encoding scheme to perform inter prediction on attribute is determined via syntax elements in the Attribute Parameter Set (APS). Additionally, the starting layer for inter prediction encoding is determined by a syntax element treeDepth. For the RAHT encoding layer(s) below this depth, only RAHT intra prediction encoding is adopted. In other words, in related technologies, a specific RAHT inter prediction encoding method is defined for encoding layers above treeDepth, and RAHT intra prediction encoding is used for layers below treeDepth. However, this attribute encoding scheme has two major issues as follows:

1. It does not analyze the distribution of AC coefficients across different RAHT encoding layers within different slice layers (attribute decoding layers). Instead, it directly determines the attribute inter encoding scheme for the current sequence in the sequence set.

2. By determining the number of inter prediction layers in the APS, inter encoding is often only initiated at the upper layers of the RAHT encoding hierarchy, as the intra correlation of AC coefficients in the lower RAHT encoding layers is stronger than the inter correlation of AC coefficients. However, this encoding scheme does not fully and effectively utilize the distribution of AC coefficients across different RAHT layers, resulting in lower encoding efficiency for attribute information.

Based on this, an embodiment of the disclosure provides a decoding method, which includes that: when it is determined that attribute prediction is enabled to be performed on nodes in the current layer, a bitstream is parsed to determine the first syntax identifier information; when the first syntax identifier information indicates that adaptive selection of an inter prediction mode and/or an intra prediction mode is enabled for the current layer, the bitstream is parsed to determine the target decoding mode for the current layer; and attribute decoding is performed on the nodes in the current layer based on the target decoding mode to determine the attribute reconstruction values of the nodes in the current layer.

An embodiment of the disclosure also provides an encoding method, which includes that: when it is determined that attribute prediction is enabled to be performed on nodes in the current layer and that adaptive selection of an inter prediction mode and/or an intra prediction mode for the current layer is enabled, the target encoding mode for the current layer is determined, and the first syntax identifier information is determined, the first syntax identifier information is used to indicate whether adaptive selection of an inter prediction mode and/or an intra prediction mode for the current layer is enabled; attribute encoding is performed on the nodes in the current layer based on the target encoding mode to determine the attribute reconstruction values of the nodes in the current layer.

In this way, by introducing a corresponding attribute encoding mode for each layer, when performing attribute encoding on each layer, the encoding end can adaptively select the target encoding mode for each slice and transmit the target encoding mode to the decoder, so that the decoding end uses the parsed target decoding mode to perform attribute reconstruction on the point cloud attributes, thereby improving the encoding and decoding efficiency of point cloud attributes and further enhancing the encoding and decoding performance of point clouds.

Hereinafter, embodiments of the disclosure will be described in detail with reference to the accompanying drawings.

In an embodiment of the disclosure, FIG. 36 is a schematic flowchart of a decoding method according to the embodiment of the disclosure. As illustrated in FIG. 36, the method may include operations S101 to S103.

In operation S101, when it is determined that attribute prediction is enabled to be performed on nodes in the current layer, a bitstream is parsed to determine first syntax identifier information.

It should be noted that, in the embodiment of the disclosure, the decoding method is applied to a point cloud decoder (which may be abbreviated as “decoder”). Specifically, the decoding method may be a point cloud attribute decoding method, and more specifically, a method for point cloud attributes decoding that adaptively selects inter prediction or intra prediction for decoding through RAHT prediction.

It should also be noted that, in the embodiment of the disclosure, this primarily involves introducing a corresponding attribute decoding mode for each layer in the current sequence within the Attribute Brick Header (ABH) information parameter set, and the corresponding target decoding mode can be adaptively selected for each layer, thereby improving the decoding efficiency of point cloud attributes.

In an embodiment of the disclosure, the current layer may be one of the layers in the current video picture.

In an embodiment of the disclosure, a video frame may be understood as a picture, for example, a current frame may be understood as a current picture, and a reference frame may be understood as a reference picture.

In an embodiment of the disclosure, the current layer includes at least one node.

In the embodiment of the disclosure, when on the decoder side, the current layer may be referred to as a current attribute decoding layer, a current decoding layer, a current slice, or the like. The embodiments of the disclosure do not make any limitation thereto.

In an embodiment of the disclosure, the current layer is a decoding layer obtained by performing one upsampling along the first direction, the second direction, and the third direction. Here, the first direction is the z-axis direction, the second direction is the y-axis direction, and the third direction is the x-axis direction.

It should be noted that the embodiment of the disclosure does not limit the order of the first direction, the second direction, and the third direction. For example, the order may be: the second direction, the first direction, and the third direction; or the third direction, the second direction, and the first direction.

In the embodiment of the disclosure, the current layer is not limited to one decoding layer obtained by performing one upsampling along the first direction, the second direction, and the third direction. The current layer may also be multiple decoding layers obtained by performing one upsampling along the first direction, the second direction, and the third direction. The current layer may also be a layer composed of at least one node in one decoding layer. The embodiments of the disclosure do not make any limitation thereto.

In the embodiment of the disclosure, the first syntax identifier information is used to indicate that adaptive selection of the inter prediction mode and/or the intra prediction mode for the current layer is enabled.

In some embodiments of the disclosure, the implementation of parsing the bitstream to determine the value of the first syntax identifier information may include the following.

If the value of the first syntax identifier information is the first value, it is determined that adaptive selection of the inter prediction mode and/or the intra prediction mode for the current coefficient group is enabled. The current coefficient group includes at least one layer, and the current layer is one of the at least one layer;

If the value of the first syntax identifier information is the second value, it is determined that adaptive selection of the inter prediction mode and/or the intra prediction mode for the current coefficient group is disabled.

The current coefficient group includes at least one layer, and the current layer is one of the at least one layer.

In some embodiments of the disclosure, the implementation of parsing the bitstream to determine the value of the first syntax identifier information may include the following.

If the value of the first syntax identifier information is the first value, it is determined that adaptive selection of the inter prediction mode and/or the intra prediction mode for the current layer is enabled.

If the value of the first syntax identifier information is a second value, it is determined that adaptive selection of the inter prediction mode and/or the intra prediction mode for the current layer is disabled.

It should be noted that, in the embodiment of the disclosure, the first value is different from the second value, and the first value and the second value may be in parameter form or numerical form. Specifically, the first syntax identifier information may be a parameter signalled in a profile, or may be a value of a flag, which is not specifically limited here.

Exemplarily, for the first value and the second value, the first value may be set to 1, and the second value may be set to 0. Alternatively, the first value may be set to 0, and the second value may be set to 1. Alternatively, the first value may be set to true, and the second value may be set to false. Alternatively, the first value may be set to false, and the second value may be set to true. It is not specifically limited here.

In the embodiment of the disclosure, taking the flag signalled in the bitstream as an example, assuming that the first value is set to 1 (true) and the second value is set to 0 (false), and if the value of the first syntax identifier information is 0 (false), it may be determined that adaptive selection of the inter prediction mode and/or the intra prediction mode for the current layer is disabled, that is, the decoding method described in the embodiment of the disclosure does not need to be performed. If the value of the first syntax identifier information is 1 (true), it may be determined that adaptive selection of the inter prediction mode and/or the intra prediction mode for the current layer is enabled, that is, the decoding method described in the embodiment of the disclosure needs to be performed.

In the embodiment of the disclosure, the first syntax identifier information acts as a switch. When the first syntax identifier information is a first value (such as 1 or true), it indicates that the decoding algorithm described in the embodiment of the disclosure is enabled, that is, the decoding algorithm described in the embodiment of the disclosure is performed. When the first syntax identifier information is a second value (such as 0 or false), it indicates that the decoding algorithm described in the embodiment of the disclosure is disabled, that is, the decoding algorithm described in the embodiment of the disclosure is not performed.

It should be understood that, compared with the solution in the related art where the attribute decoding mode for the current sequence is directly determined in the sequence set, in the embodiment of the disclosure, by setting the first syntax identifier information, intra prediction and/or inter prediction can be adaptively selected for different layers to perform attribute decoding on the nodes, the distribution of AC coefficients of different layers can be sufficiently considered, thereby improving the decoding efficiency through the RAHT.

In the embodiment of the disclosure, the implementation of determining that attribute prediction is enabled to be performed on the nodes in the current layer may include the following two manners.

Manner 1: based on the sixth syntax identifier information, it is determined that attribute prediction is enabled to be performed on the nodes in the current layer.

In an embodiment of the disclosure, the implementation of Manner 1 may include the following.

The bitstream is parsed to determine sixth syntax identifier information. The sixth syntax identifier information is used to indicate whether attribute prediction is enabled to be performed on the nodes in the current layer.

If the value of the sixth syntax identifier information is the first value, it is determined that attribute prediction is enabled to be performed on the nodes in the current layer.

If the value of the sixth syntax identifier information is a second value, it is determined that attribute prediction is disabled to be performed on the nodes in the current layer.

It should be understood that when the decoding end adopts the Manner 1 to determine whether attribute prediction is disabled to be performed on the nodes in the current layer, it only requires parsing the bitstream and then making a determination based on the value of the sixth syntax identifier information. In this way, repetitive determination processes at the decoding end can be avoided, which simplifies the decoding process, thereby improving the decoding efficiency.

Manner 2: based on the number of adjacent nodes of the current layer, it is determined that attribute prediction is disabled to be performed on the nodes in the current layer.

In an embodiment of the disclosure, the implementation of Manner 2 may include the following.

The number of adjacent nodes of the current layer is determined. Herein, the adjacent nodes include the number of neighbouring nodes and the number of neighbouring nodes of the parent nodes.

When the number of adjacent nodes is greater than or equal to a preset threshold, it is determined that attribute prediction is enabled to be performed on the nodes in the current layer.

When the number of adjacent nodes is less than a preset threshold, it is determined that attribute prediction is disabled to be performed on the nodes in the current layer.

It should be understood that, in the embodiment of the disclosure, when the decoding end adopts Manner 2, the decoding end and the encoding end adopt the same procedure to determine whether attribute prediction is disabled to be performed on the nodes in the current layer, so that the encoding end does not need to transmit to the decoding end a codeword indicating whether attribute prediction is disabled to be performed on the nodes in the current layer, and the decoding end does not need to parse the corresponding codeword, which improves the decoding efficiency to a certain extent.

The selection for Manner 1 and Manner 2 is not limited in the embodiments of the disclosure, and the specific selection can be made according to the actual application scenario.

In operation S102, when the first syntax identifier information indicates that adaptive selection of the inter prediction mode and/or the intra prediction mode for the current layer is enabled, the bitstream is parsed to determine the target decoding mode for the current layer.

In an embodiment of the disclosure, when the first syntax identifier information indicates that adaptive selection of the inter prediction mode and/or the intra prediction mode for the current layer is enabled, the decoder determines the target decoding mode for the current layer by parsing the bitstream.

In an embodiment of the disclosure, the target decoding mode may be represented as attr_code_mode[i]; where i is the index value of the current layer.

It should be noted that the index value i is assigned only when the three conditions of enabling attribute prediction, enabling inter prediction, and enabling intra prediction are satisfied for the current layer.

For example, assuming that the index (i) of the current layer is 2, if the three conditions of enabling attribute prediction, enabling inter prediction, and enabling intra prediction are not satisfied for the current layer, the decoder directly skips the current layer, directly performs attribute decoding of the next layer, and assigns the index 2 to the next layer. If the three conditions of enabling attribute prediction, enabling inter prediction, and enabling intra prediction are satisfied for the current layer, the decoder performs attribute decoding on the current layer, then increments the index value by 1 (i++) to obtain the updated index value (3), and transmits the index value 3 to the next layer.

In some embodiments of the disclosure, the operation S102 of parsing the bitstream to determine the target decoding mode for the current layer may include operations S1021 to S1023.

In operation S1021, the bitstream is decoded to determine the attribute brick header information parameter set is determined.

In an embodiment of the disclosure, an Attribute Brick Header (ABH) information parameter set may include target decoding modes each corresponding to a respective one of at least one layer.

In operation S1022, the second syntax identifier information is determined from the attribute brick header information parameter set.

In the embodiment of the disclosure, after determining the attribute brick header information parameter set, the decoder determines the second syntax identifier information for the current layer from the attribute brick header information parameter set. Herein, the second syntax identifier information is used to indicate a target decoding mode for the current layer.

In operation S1023: the target decoding mode for the current layer is determined based on the second syntax identifier information.

In an embodiment of the disclosure, the decoder determines the target decoding mode for the current layer based on the value of the second syntax identifier information for the current layer.

It should be noted that, in the embodiment of the disclosure, the value of the second syntax identifier information may be in a parameter form or a numerical form. The embodiments of the disclosure do not make any limitation thereto.

In some embodiments of the disclosure, the target decoding mode includes a region-adaptive hierarchical intra transform mode, a region-adaptive hierarchical inter transform mode, and a region-adaptive hierarchical combined transform mode.

The region-adaptive hierarchical intra transform mode characterizes using the intra prediction mode to perform attribute prediction transform decoding on the nodes in the current layer. The region-adaptive hierarchical inter transform mode characterizes using the inter prediction mode to perform attribute prediction transform decoding on the nodes in the current layer. The region-adaptive hierarchical combined transform mode characterizes using intra prediction mode combined with inter prediction mode to perform attribute prediction transform decoding on the nodes in the current layer.

In some embodiments of the disclosure, the region-adaptive hierarchical inter transform mode includes a first region-adaptive hierarchical inter transform mode and a second region-adaptive hierarchical inter transform mode. The region-adaptive hierarchical combined transform mode includes a first region-adaptive hierarchical combined transform mode, a second region-adaptive hierarchical combined transform mode, and a third region-adaptive hierarchical combined transform mode.

The first region-adaptive hierarchical inter transform mode characterizes performing attribute prediction transform decoding on nodes in the current layer in a manner of using geometric information of the nodes to determine collocated prediction nodes.

The second region-adaptive hierarchical inter transform mode characterizes performing attribute prediction transform decoding on the nodes in the current layer in a manner of using the cache of the reference pictures to determine collocated prediction nodes.

The first region-adaptive hierarchical combined transform mode characterizes using a combination of the region-adaptive hierarchical intra transform mode and the first region-adaptive hierarchical inter transform mode to perform attribute prediction transform decoding on the nodes in the current layer.

The second region-adaptive hierarchical combined transform mode characterizes using a combination of region-adaptive hierarchical intra transform mode and the second region-adaptive hierarchical inter transform mode to perform attribute prediction transform decoding on the nodes in the current layer.

The third region-adaptive hierarchical combined transform mode characterizes using a combination of the region-adaptive hierarchical intra transform mode, the first region-adaptive hierarchical inter transform mode and the second region-adaptive hierarchical inter transform mode to perform attribute prediction transform decoding on the nodes in the current layer.

The region-adaptive hierarchical intra transform mode, the first region-adaptive hierarchical inter transform mode, and the second region-adaptive hierarchical inter transform mode are described below.

### 1. Region-Adaptive Hierarchical Intra Transform Mode:

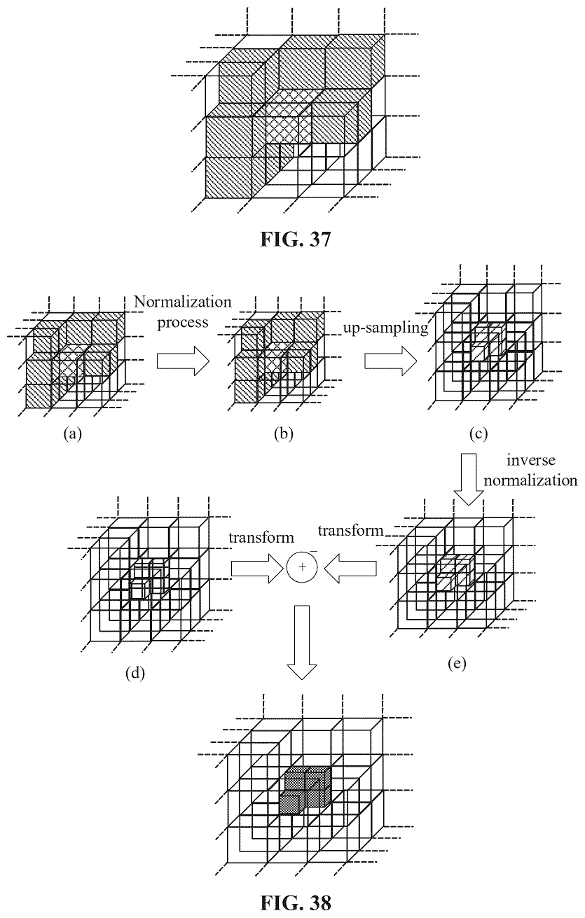

In a specific implementation, for region-adaptive hierarchical intra prediction transform coding, prediction may be performed based on RAHT transform coding. As illustrated in FIG. 33, the RAHT attribute transform is based on the octree level order, progressively transforming from the voxel level to the root node, thereby completing the hierarchical transform coding of the entire attribute. In prediction transform coding, the attribute prediction transform coding is also performed based on the octree level order, but the transform is progressively performed from the root node to the voxel level. During each RAHT attribute transform process, attribute prediction transform coding is performed on 2×2×2 blocks. Specifically, as illustrated in FIG. 37, the block filled with grid lines represents the current block to be coded, and the blocks filled with diagonal lines represent neighbouring blocks that are coplanar and collinear with the current block to be coded. Herein, the attributes of the current block are normalized in the following manner:

$$\begin{matrix}{A}_{node} = {\sum }_{p ∈ node} attribute ( p ) ; \\ {w}_{node} = {\sum }_{p ϵ node} 1 = \{ p ∈ node \} ; \\ {a}_{node} = {A}_{node} / {w}_{mode} .\end{matrix}$$

First, the attribute (denoted as A_{node}) of the current block may be obtained by the attributes of the points included in the current block. By simply summation of the attributes of points included in the current block, and then normalizing the attribute of the current block with the number of points in the current block, the mean value (a_{node}) of the attribute of the current block is obtained. The mean value of the attribute of the current block is used to perform attribute transform coding. The specific encoding and decoding processes are illustrated in FIG. 38.

As illustrated in FIG. 38, the overall flow of RAHT attribute prediction transform coding is illustrated. Herein, (a) illustrates the current block and coplanar and collinear neighbouring blocks; (b) illustrates the normalized block, (c) illustrates the upsampled block, (d) represents the attribute of the current block, (e) represents the attribute of the prediction block obtained through linear weighted fitting by using the attributes of neighbouring blocks of the current block, and finally the attribute transform is performed on the attributes to obtain DC and AC coefficients, and prediction coding are performed on the AC coefficients.

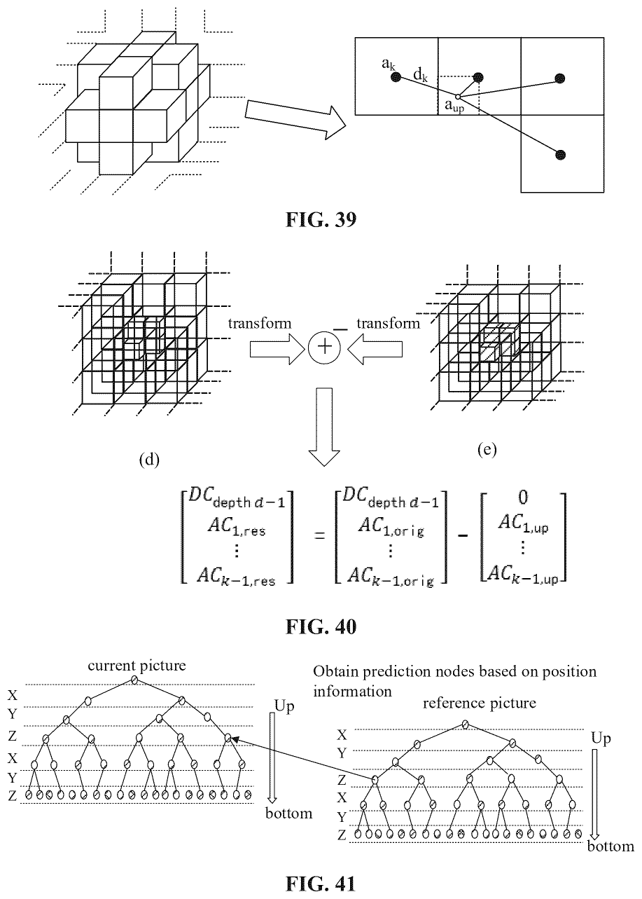

Herein, the prediction attribute of the current block may be obtained by performing linear fitting as illustrated in FIG. 39. As illustrated in FIG. 39, 19 neighbouring blocks of the current block are first obtained; then, linear weighted prediction is performed on the attribute of each sub-block of the current block by using the spatial geometric distances between the neighbouring blocks and the sub-block; finally, the prediction block attribute obtained through linear weighting is used for transform. The specific attribute transform is illustrated in FIG. 40.

In FIG. 40, (d) represents the original value of the attribute, and the corresponding attribute transform coefficients are as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1 , orig} / \sqrt{{w}_{1}} \\ ⋮ \\ {A}_{k , orig} / \sqrt{{w}_{k}}\end{matrix} ] \qquad ( 31 )$$

(e) represents the attribute prediction value, and the corresponding attribute transform coefficients are as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 32 )$$

By performing subtraction between the original value of the attribute and the prediction value of the attribute, the prediction residual may be obtained as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {A}_{k - 1 , orig}\end{matrix} ] - [ \begin{matrix}0 \\ {AC}_{1 , up} \\ ⋮ \\ {AC}_{k - 1 , up}\end{matrix} ] \qquad ( 33 )$$

### 2. a First Region-Adaptive Hierarchical Inter Transform Mode.

In another specific implementation, for the first region-adaptive hierarchical inter transform mode, the first region-adaptive hierarchical inter transform mode is also referred to as region-adaptive hierarchical inter prediction transform coding scheme 1, which is similar to the intra prediction coding process in G-PCC attribute inter prediction. Firstly, the RAHT attribute transform coding structure is constructed based on geometric information, specifically: transforms progress from the voxel level to the root node, thereby completing the hierarchical transform coding of the entire attribute. In this manner, an intra coding structure and an inter attribute coding structure are constructed, with details illustrated in FIG. 41.

As illustrated in FIG. 41, firstly, the collocated prediction node of the node to be coded in the reference picture is obtained by using the geometric information of the current node to be coded; and then, the prediction attribute of the current node to be coded is obtained by using the geometric information and attribute information of the reference node.

Herein, the attribute prediction value of the current node to be coded is obtained in the following two different ways:
\textcircled{1} The inter prediction node of the current node is valid: that is, the collocated node exists, the attribute of the prediction node is directly used as the attribute prediction value of the current node to be coded.
\textcircled{2} The inter prediction node of the current node is invalid: that is, the collocated node does not exist, the intra attribute prediction value of the adjacent node is used as the attribute prediction value of the node to be coded.

Finally, the obtained attribute prediction value is used to predict the attribute of the current node to be coded, thereby completing the prediction coding of the entire attribute.

### 3. a Second Region-Adaptive Hierarchical Inter Transform Mode:

In another specific implementation mode, for the second region-adaptive hierarchical inter transform mode, the second region-adaptive hierarchical inter transform mode is also referred to as the region-adaptive hierarchical inter prediction transform coding scheme 2, unlike the first region-adaptive hierarchical inter transform mode, if the second region-adaptive hierarchical inter transform mode is enabled, the RAHT attribute transform coding structure is first constructed based on the geometric information of the current node to be coded. That is, nodes are continuously merged from the voxel level until the root node of the entire RAHT transform tree is obtained, thereby completing the hierarchical transform coding structure of the entire attribute. Subsequently, based on the RAHT transform structure, the root node is divided to obtain N sub-nodes of each node (N is less than or equal to 8). In the inter prediction coding scheme 2, the attributes of the N sub-nodes are first independently orthogonally transformed by using the RAHT transform to obtain DC coefficients (direct current components) and AC coefficients (alternating current components), and then, the attribute inter prediction is performed on the AC coefficients of the N sub-nodes in the following manner:
\textcircled{1} The inter prediction node of the current node is valid: that is, the collocated node exists, the attribute of the prediction node is directly used as the attribute prediction value of the current node to be coded.
\textcircled{2} For the current node, a node at the exact same position as the current node can be found in the cache of the reference picture: that is, the collocated node exists, the AC coefficients of M sub-nodes included in the collocated node will be directly used as the AC coefficient attribute prediction values of N sub-nodes of the current node.
   a) If the AC coefficient of the prediction node is not zero, the AC coefficient of the prediction node is directly used as the prediction value.
   b) if the AC coefficient of the prediction node is zero, the AC coefficient of the sub-node corresponding to the intra prediction is used as the prediction value.
\textcircled{3} The inter prediction node of the current node is invalid: that is, the collocated node does not exist, the intra attribute prediction value of the adjacent node is used as the attribute prediction value of the node to be coded.

In some embodiments of the disclosure, the operation S1023 of determining the target decoding mode for the current layer based on the second syntax identifier information may include that: the target decoding mode that uses the inter prediction mode and/or the intra prediction mode for the current layer is determined based on the value of the second syntax identifier information.

In some embodiments of the disclosure, the operation of determining the target decoding mode that uses the inter prediction mode and/or the intra prediction mode for the current layer based on the value of the second syntax identifier information may include the following.

If the value of the second syntax identifier information is a third value, it is determined that the target decoding mode for the current layer is a region-adaptive hierarchical intra transform mode.

If the value of the second syntax identifier information is a fourth value, it is determined that the target decoding mode for the current layer is the first region-adaptive hierarchical inter transform mode.

If the value of the second syntax identifier information is a fifth value, it is determined that the target decoding mode for the current layer is a second region-adaptive hierarchical inter transform mode.

If the value of the second syntax identifier information is a sixth value, it is determined that the target decoding mode for the current layer is the first region-adaptive hierarchical combined transform mode.

If the value of the second syntax identifier information is a seventh value, it is determined that the target decoding mode for the current layer is a second region-adaptive hierarchical combined transform mode.

If the value of the second syntax identifier information is the eighth value, it is determined that the target decoding mode for the current layer is the third region-adaptive hierarchical combined transform mode.

In the embodiment of the disclosure, the third value, the fourth value, the fifth value, the sixth value, the seventh value, and the eighth value are different. It should be noted that the third value, the fourth value, the fifth value, the sixth value, the seventh value, and the eighth value may be in a parameter form or a numerical form. Exemplarily, the third value is 0, the fourth value is 1, the fifth value is 2, the sixth value is 3, the seventh value is 4, and the eighth value is 5. The embodiments of the disclosure do not limit the setting of the third value, the fourth value, the fifth value, the sixth value, the seventh value, and the eighth value.

In operation S103, attribute decoding is performed on the nodes in the current layer based on the target decoding mode to determine attribute reconstruction values of the nodes in the current layer.

It should be noted that, in the embodiment of the disclosure, after determining the target decoding mode for the current layer, the decoder may perform attribute decoding on the nodes in the current layer based on the target decoding mode, and then determine the attribute reconstruction values of the nodes in the current layer.

In the embodiment of the disclosure, if the target decoding mode is the region-adaptive hierarchical intra transform mode, the decoder performs attribute decoding on the nodes in the current layer based on the region-adaptive hierarchical intra transform mode to determine the attribute reconstruction values of the nodes in the current layer. If the target decoding mode is the first region-adaptive hierarchical inter transform mode, the decoder performs attribute decoding on the nodes in the current layer based on the first region-adaptive hierarchical inter transform mode to determine attribute reconstruction values of the nodes in the current layer. If the target decoding mode is the second region-adaptive hierarchical inter transform mode, the decoder performs attribute decoding on the nodes in the current layer based on the second region-adaptive hierarchical inter transform mode to determine attribute reconstruction values of the nodes in the current layer. If the target decoding mode is the first region-adaptive hierarchical combined transform mode, the decoder performs attribute decoding on the nodes in the current layer based on the first region-adaptive hierarchical combined transform mode to determine the attribute reconstruction values of the nodes in the current layer. If the target decoding mode is the second region-adaptive hierarchical combined transform mode, the decoder performs attribute decoding on the nodes in the current layer based on the second region-adaptive hierarchical combined transform mode to determine the attribute reconstruction values of the nodes in the current layer. If the target decoding mode is the third region-adaptive hierarchical combined transform mode, the decoder performs attribute decoding on the nodes in the current layer based on the third region-adaptive hierarchical combined transform mode to determine the attribute reconstruction values of the nodes in the current layer.

It should be understood that, in the embodiment of the disclosure, first, when it is determined that attribute prediction is enabled to be performed on nodes in the current layer, the bitstream is parsed to determine the first syntax identifier information; then, when the first syntax identifier information indicates that adaptive selection of an inter prediction mode and/or an intra prediction mode for the current layer is enabled, the bitstream is parsed to determine the target decoding mode for the current layer; finally, the decoding end uses the parsed target decoding mode to perform attribute reconstruction on attributes of the point cloud, thereby improving the decoding efficiency of the point cloud attributes, and further improving the decoding performance of the point cloud.

In some embodiments of the disclosure, the decoding method further includes the following operations.

The bitstream is parsed to determine the value of the third syntax identifier information. The third syntax identifier information is used to indicate the number of layers included in the current sequence where the current layer is located.

An index value of the current layer is obtained, and if the index value of the current layer is greater than or equal to a ninth value and less than the number of layers, the operation of parsing a bitstream to determine a target decoding mode for the current layer is performed.

If the index value of the current layer is greater than the number of layers, the operation of parsing the bitstream to determine the target decoding mode for the current layer is not performed.

In the embodiment of the disclosure, the determination of the index value of the current layer includes the following two manner.

Manner 1: an index value of the current layer is determined based on the seventh syntax identifier information.

In an embodiment of the disclosure, the implementation of Manner 1 may include that:
the bitstream is parsed to determine a value of the seventh syntax identifier information; the seventh syntax identifier information is used to indicate an index value of the current layer.

For example, if the value of the seventh syntax identifier information is 1, the index value of the current layer is 1.

Manner 2: The decoding end and the encoding end adopt the same process to determine the index value of the current layer, so that the encoding end does not need to transmit to the decoding end a codeword indicating the index value of the current layer, and the decoding end does not need to parse the corresponding codeword, which can improve the decoding efficiency to a certain extent.

In an embodiment of the disclosure, the number of layers included in the current sequence may be represented as attr_code_mode_cnt. It should be noted that the number of layers refers to the number of decoding layers in the current sequence that an inter prediction mode and/or an intra prediction mode can be adaptively selected.

For example, assuming that there are a total of 20 decoding layers included in the current sequence, if there are 10 layers in the current sequence that satisfy the three conditions of enabling attribute prediction, enabling inter prediction, and enabling intra prediction, the value of attr_code_mode_cnt is 10.

In an embodiment of the disclosure, the index value of the current layer may be represented as i, where i is an integer greater than or equal to 0.

In an embodiment of the disclosure, the ninth value is 0.

In the embodiment of the disclosure, if the index value of the current layer is greater than or equal to the ninth value and less than the number of layers, the operation of parsing the bitstream to determine the target decoding mode for the current layer is performed, which may be represented as follows:

$$\begin{matrix}for ( i = 0 ; i < attr\_code \_mode \_cnt ) \\ attr\_code \_mode [ i ]\end{matrix}$$

It should be understood that by using the third syntax identifier information to indicate the number of layers included in the current sequence where the current layer is located, it can achieves adaptively selecting the inter prediction and/or intra prediction mode for layers whose index values of decoding layers in the current sequence satisfy preset conditions (enabling attribute prediction, enabling inter prediction, and enabling intra prediction), so that the distribution of AC coefficients among different layers can be fully considered, thereby improving the decoding efficiency of attribute information.

In some embodiments of the disclosure, the implementation of performing attribute decoding on the nodes in the current layer based on the target decoding mode to determine the attribute reconstruction values of the nodes in the current layer in operation S103 may include operations S1031 to S1034.

In operation S1031, the attribute prediction values of the nodes in the current layer are determined.

In an embodiment of the disclosure, the decoder determines the attribute prediction value for each node in the current layer based on the number of adjacent nodes of the node in the current layer.

It should be noted that, in the embodiment of the disclosure, if the attribute of the node in the current layer can be predicted, the attribute prediction value of the node in the current layer can be obtained through linear fitting by using the reconstructed attributes of the neighbouring nodes of the node in the current layer and the geometric distances between each of the neighbouring nodes and the current node.

It should also be noted that, in the embodiment of the disclosure, the attribute prediction of the node in the current layer may be based on intra attribute prediction transform or inter attribute prediction transform, which is not specifically limited here.

In some embodiments of the disclosure, the implementation of determining the attribute prediction values of the nodes in the current layer in operation S1031 may include that:
adjacent nodes of each of the nodes in the current layer are determined; herein, the adjacent nodes include neighbouring nodes and neighbouring nodes of a parent node; and
the attribute prediction value of the node in the current layer is determined by performing linear fitting based on the attribute reconstruction values for the adjacent nodes and the geometric distances between the node in the current layer and each of the adjacent nodes.

In a specific implementation, taking FIG. 38 as an example, 19 neighbouring nodes of a node in the current layer are first determined, and then linear weighted prediction is performed on the attribute of each node by using the spatial geometric distances between the neighbouring nodes and the current node, and finally the attribute prediction value for each node is determined based on the prediction value obtained through linear weighting.

It should be noted that, in the embodiment of the disclosure, the region-adaptive hierarchical transform mode is a Haar wavelet transform, which may transform point cloud attribute information from the spatial domain to the frequency domain, and further reduce the correlation between point cloud attributes. The main idea is to adopt transforms to nodes in each layer along the X, Y, and Z dimensions in a bottom-up manner based on the octree structure, and iterate until reaching the root node of the octree. Here, the basic idea is to perform wavelet transforms based on the hierarchical structure of the octree, associating attribute information with octree nodes; recursive transforming the attributes of occupied nodes in the same parent node in a bottom-up manner; and performing transform on nodes in each layer along the X, Y, and Z dimensions until reaching the root node of the octree. During the hierarchical transform process, the first coefficients obtained after transforming nodes in the same layer are transferred to nodes at the next layer for further transform, while all second coefficients may be decoded and determined through an arithmetic decoder.

In operation S1032, forward transform is performed on the attribute prediction values of the nodes in the current layer based on the target decoding mode to determine the first coefficient value and the second coefficient prediction value for each of nodes in the current layer.

In an embodiment of the disclosure, the forward transform is a RAHT forward transform, the first coefficient value is a DC coefficient, and the second coefficient prediction value is an AC coefficient prediction value.

In some embodiments of the disclosure, when the target decoding mode for the current layer is a region-adaptive hierarchical combined transform mode, the operation of determining a second coefficient prediction value of each of the nodes in the current layer includes that:
forward transform is performed on the node in the current layer based on the region-adaptive hierarchical combined transform mode to determine a first intermediate prediction value and a second intermediate prediction value of the node in the current layer; and
the first intermediate prediction value and the second intermediate prediction value of the node in the current layer are added to obtain the second coefficient prediction value of the node in the current layer.

In an embodiment of the disclosure, the first intermediate prediction value may be represented as w*predIntraVal, and the second intermediate prediction value may be represented as w2*predIntraVal.

In some embodiments of the disclosure, the operation of performing the forward transform on the node in the current layer based on the region-adaptive hierarchical combined transform mode to determine the first intermediate prediction value and the second intermediate prediction value of the node in the current layer, may include that:
a first target weight and a second target weight for the current layer are determined;
forward transform is performed on the node in the current layer by using the region-adaptive hierarchical intra transform mode to determine the first attribute prediction value of the node in the current layer;
forward transform is performed on the node in the current layer by using the region-adaptive hierarchical inter transform mode to determine the second attribute prediction value of the node in the current layer;
the first attribute prediction value of the node in the current layer is multiplied by the first target weight to obtain the first intermediate prediction value of the node in the current layer; and
the second attribute prediction value of the node in the current layer is multiplied by the second target weight to obtain the second intermediate prediction value of the node in the current layer.

In the embodiment of the disclosure, assuming that the RAHT intra prediction value of the current node is predIntraVal (first attribute prediction value), and the inter prediction value of the current node is predInterVal (second attribute prediction value), the final prediction value is predVal (second coefficient prediction value), which may be represented as:

$$predVal = w 1 * predIntraVal + w 2 * predIntrVal \qquad ( 34 )$$

In an embodiment of the disclosure, the first target weight may be represented as w1, and the second target weight may be represented as w2.

In some embodiments of the disclosure, the operation of determining the first target weight and the second target weight of the current layer may include that:
the bitstream is parsed to determine the weight index value; and
a target weight combination corresponding to the weight index is determined from the preset weight table; herein, the target weight combination includes a first target weight and a second target weight.

In the embodiment of the disclosure, the weight index value may be in a parameter form or a numerical form, which is not limited in the embodiment of the disclosure.

Exemplarily, the weight index value may be in numerical form, such as a weight index value of 2.

In an embodiment of the disclosure, the target weight combination includes a first target weight and a second target weight. In another embodiment, the target weight combination includes a first target weight, a second target weight, and a third target weight.

The number of target weights included in the target weight combination is related to the target decoding mode.

For example, if the target decoding mode is the region-adaptive hierarchical intra transform mode, the target weight combination includes a first target weight w1. If the target decoding mode is the first region-adaptive hierarchical inter transform mode, the target weight combination includes a second target weight w2. If the target decoding mode is the second region-adaptive hierarchical inter transform mode, the target weight combination includes a third target weight w3. If the target decoding mode is the first region-adaptive hierarchical combined transform mode, the target weight combination includes a first target weight w1 and a second target weight w2. If the target decoding mode is the second region-adaptive hierarchical combined transform mode, the target weight combination includes a first target weight w1 and a third target weight w3. If the target decoding mode is the third region-adaptive hierarchical combined transform mode, the target weight combination includes a first target weight w1, a second target weight w2, and a third target weight w3.

It should be understood that when the target decoding mode for the current layer is the region-adaptive hierarchical combined transform mode, the inter prediction values and the intra prediction values from different RAHT transform layers are merged to finally obtain the optimal prediction values based on different weights, thereby further improving the efficiency of RAHT decoding for point cloud attributes.

In some embodiments of the disclosure, when the target decoding mode for the current layer is a region-adaptive hierarchical inter transform mode or a region-adaptive hierarchical combined transform mode, after determining a second coefficient prediction value of the node in the current layer, the method further includes that:
when the second coefficient prediction value of the node in the current layer is a tenth value, the region-adaptive hierarchical intra transform mode is used to perform forward transform on the node in the current layer to obtain an intermediate second coefficient prediction value of the node in the current layer; and
the intermediate second coefficient prediction value is used as the second coefficient prediction value of the node in the current layer.

In an embodiment of the disclosure, the tenth value is 0.

In a specific embodiment, for any prediction decoding mode, it is first determined whether the attribute prediction value through inter prediction is equal to zero; if it is not equal to zero, the current prediction value is directly used as the prediction value of the AC coefficient of the current node; otherwise, the AC coefficient obtained through intra prediction is used as the AC coefficient prediction value of the current node.

In operation S1033, a second coefficient value for the node of the current layer based on the second coefficient prediction value;

In an embodiment of the disclosure, the second coefficient value is also referred to as an AC coefficient reconstruction value.

In some embodiments of the disclosure, the operation of determining the second coefficient value for the node of the current layer based on the second coefficient prediction value includes that:
a bitstream is decoded to determine a second coefficient decoded residual value for the node in the current layer;
inverse quantization is performed on the second coefficient decoded residual value to obtain the second coefficient inverse-quantized residual value of the node in the current layer; and
the second coefficient value of the node in the current layer is determined based on the second coefficient prediction value and the second coefficient inverse-quantized residual value ofthe node in the current layer.

It should also be noted that in the embodiment of the disclosure, the first coefficient may refer to a low-frequency coefficient, and may also be referred to as a Direct Current (DC) coefficient; the second coefficient may refer to a high-frequency coefficient, or may be referred to as an Alternating Current (AC) coefficient. In the process of hierarchical transform, the DC coefficients obtained after transforming the nodes in the same layer are transferred to the nodes in the next layer for further transform, and the AC coefficients obtained after the transform of each layer will be quantized and decoded, thus, at the decoding end, the second coefficient value for the node in the current layer can only be further determined by combining the second coefficient decoded residual values obtained through parsing.

In operation S1034, inverse transform is performed on the first coefficient value and the second coefficient value of the node in the current layer based on the target decoding mode, to determine the attribute reconstruction value of the node in the current layer.

In the embodiment of the disclosure, it is assumed that

$${g}_{L , 2 x , y , z}^{′} and {g}_{L , 2 x + 1 , y , z}^{′}$$

are attribute DC coefficients of two neighbouring points at layer L. After the linear transform, the information of the layer L−1 includes AC coefficient

$${f}_{L - 1 , x , y , z}^{′}$$

and DC coefficient

$$\begin{matrix}{g}_{L - 1 , x , y , x}^{′} . Then , \\ {f}_{L - 1 , xy , z}^{′}\end{matrix}$$

will no longer be transformed and directly quantized and decoded;

$${g}_{L - 1 , x , y , z}^{′}$$

will continue to find the neighbouring points for further transform, and if no neighbouring points are found, it will be directly transferred to the layer L−2. In other words, the RAHT transform is only valid for the node with neighbouring points, and the node without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′} are {w}_{L , 2 x , y , z} and$$

$${w}_{L , 2 x + 1 , y , z}^{′} ( abbreviated as {w}_{0}^{′} and {w}_{1}^{′} )$$

respectively, and the weight of

$${g}_{L - 1 , x , y , z}^{′} is {w}_{L - 1 , x , y , z}^{′} .$$

The general transform formula is as follows:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 35 )$$

Herein, T_{w0,w1} is the transform matrix, and the transform matrix is adaptively updated as the corresponding weights of each points change. The forward transform of the RAHT (which may also be referred to as the “RAHT forward transform”) is illustrated in FIG. 35A described above.

Further, the reverse RAHT transform is performed based on the obtained DC coefficients and AC coefficients of the points in the current slice, and the attribute reconstruction values of the points in the current slice can be recovered. The inverse transform of the RAHT (which may also be referred to as “inverse RAHT transform” or “RAHT inverse transform”) is as illustrated in FIG. 35B described above.

In a specific embodiment, taking the current node in the current layer as an example, the implementation operations at the decoding end are as follows.

Firstly, when it is determined to perform attribute prediction on the current node, the reconstructed attributes of neighbouring nodes of the current node and the spatial geometric distances between each of neighbouring nodes and the current node are used to perform linear fitting to obtain the attribute prediction value for each of child nodes of the current node;

Secondly, using the attribute prediction value of each child node, RAHT transform is performed to obtain the corresponding DC and AC coefficients, and finally the AC coefficients of the prediction node and the AC coefficients obtained by parsing the bitstream are used to recover the AC coefficients of the current node.

Thirdly, the AC and DC coefficients of the current node are used to perform inverse RAHT transform, so as to recover the attribute reconstruction value for each child node of the current node.

Finally, the foregoing operations are continuously repeated from the root node of the RAHT transform to the last node of the leaf node layer of the RAHT, thereby completing the attribute decoding for the RAHT transform of the current layer.

It should be understood that by performing attribute decoding on nodes in the current layer by using the target decoding mode, the distribution of AC coefficients in the current layer can be taken into account, and thus the decoding efficiency of the current layer can be improved.

In some embodiments of the disclosure, the decoding method further includes that:
the number of adjacent nodes of the current layer is determined; herein, the adjacent nodes includes the number of neighbouring nodes and the number of neighbouring nodes of the parent nodes;
when the number of adjacent nodes is greater than or equal to a preset threshold, it is determined that attribute prediction is enabled to be performed on the nodes in the current layer.

In an embodiment of the disclosure, the preset threshold is used to determine whether attribute prediction is enabled to be performed on the nodes in the current layer.

In an embodiment of the disclosure, the preset threshold is a preset value. The preset threshold may be a value agreed by both the decoder and the encoder. The preset threshold may also be determined by the decoder through parsing the bitstream. The embodiment of the disclosure does not impose any restriction on the obtaining manner of the preset threshold.

It should also be noted that, in the embodiment of the disclosure, if the number of adjacent nodes of a node of the current layer is greater than or equal to a preset threshold, it may be determined that attribute prediction is enabled to be performed for the current layer, and at this time, the operation of determining the attribute prediction values of the nodes of the current layer based on the attribute information of the neighbouring nodes of the current layer is continued. Otherwise, if the number of adjacent nodes of the current layer is less than a preset threshold, it may be determined that attribute prediction is disabled to be performed for the current layer, and at this time, the attribute prediction for the nodes of the current layer is directly stopped, and the attribute prediction for the next layer may proceed.

In some embodiments of the disclosure, the decoding method further includes that:
neighbouring nodes of each node in the current layer are determined based on the spatial position of each node;
herein, the neighbouring nodes of the node at least includes neighbouring nodes coplanar with the node and neighbouring nodes collinear with the node.

It should be noted that, in the embodiment of the disclosure, the spatial position information of each node in the current layer may be position information of the node, specifically, three-dimensional coordinate information (x, y, z).

In a specific implementation, neighbouring nodes of a node may include neighbouring nodes coplanar with the node and neighbouring nodes collinear with the node. Exemplarily, as illustrated in FIG. 37, a block filled with grid lines may represent the current node, and then blocks filled with diagonal lines may represent neighbouring nodes that are coplanar and collinear with the current node.

In some embodiments of the disclosure, the decoding method further includes that:
a parent node of each node in the current layer is determined; and
neighbouring nodes of the parent node of each node are determined based on the spatial position of the parent node of each node; herein, neighbouring nodes of the parent node of the node at least includes neighbouring nodes coplanar with the parent node of the node and neighbouring nodes collinear with the parent node of the node.

In some embodiments of the disclosure, the operation of determining the number of adjacent nodes of the current layer includes that:
the number of neighbouring nodes of all nodes in the current layer is counted to determine the number of the neighbouring nodes in the current layer;
the number of neighbouring nodes of parent nodes of nodes in the current layer is counted to determine the number of neighbouring nodes of the parent nodes in the current layer; and
the number of the neighbouring nodes and the number of the neighbouring nodes of the parent nodes are added to obtain the number of the adjacent nodes of the current layer.

It should be understood that, in the G-PCC coding framework, RAHT can be used as both transform and prediction, resulting in high complexity. Considering the problem of high complexity, the related art sets an enabling condition for whether attribute prediction is enabled to be performed on the current node. Specifically: whether the number of adjacent nodes in the current layer is greater than a preset threshold is determined. In this way, by setting the determining condition of whether attribute prediction is enabled for the current layer, the memory usage for point cloud attribute decoding can be reduced while maintaining complexity, and the decoding efficiency of point cloud can be improved.

In some embodiments of the disclosure, when both the fourth syntax identifier information and the fifth syntax identifier information are the first value, the first syntax identifier information is the first value, the fourth syntax identifier information is used to indicate whether inter prediction is enabled to be performed on the nodes in current layer, and the fifth syntax identifier information is used to indicate whether intra prediction is enabled to be performed on the nodes in current layer;

When either the fourth syntax identifier information or the fifth syntax identifier information is a second value, the first syntax identifier information is a second value.

In the embodiment of the disclosure, only when both the fourth syntax identifier information and the fifth syntax identifier information are the first value, the first syntax identifier information is the first value, that is, when it is determined that inter prediction and intra prediction are enabled to be performed on the current attribute-decoded node, the first syntax identifier information is the first value.

In some embodiments of the disclosure, the decoding method further includes that:
when the first syntax identifier information indicates that adaptive selection of inter prediction mode and/or intra prediction mode are disabled to be performed on the current layer, the bitstream is parsed to determine the fourth syntax identifier information;
when the fourth syntax identifier information indicates that inter prediction is disabled to be performed on the nodes in the current layer, the bitstream is parsed to determine the fifth syntax identifier information;
when the fifth syntax identifier information indicates that intra prediction is enabled to be performed on the nodes of the current layer, attribute decoding is performed on the nodes of the current layer based on the region-adaptive hierarchical intra transform mode to determine attribute reconstruction values of the nodes of the current layer.

In the embodiment of the disclosure, the fourth syntax identifier information may be represented as: !disableAttrInterPred, the fifth syntax identifier information may be represented as: raht_prediction_enabled.

Exemplary, when !disableAttrInterPred is true, it is determined that inter prediction is enabled to be performed on the nodes of the current layer. When !disableAttrInterPred is false, it is determined that inter prediction is disabled to be performed on the nodes of the current layer.

Exemplarily, when raht_prediction_enabled is true (1), it is determined that intra prediction is enabled to be performed on the nodes of the current layer. When raht_prediction_enabled is false (0), it is determined that intra prediction is disabled to be performed on the nodes of the current layer.

In an embodiment of the disclosure, the fourth syntax identifier information and the fifth syntax identifier information may be high-level syntax elements, and the fourth syntax identifier information and the fifth syntax identifier information may be set in an attribute parameter set (aps).

In the embodiment of the disclosure, the decoder determines the attribute parameter set by parsing the bitstream; and determines the fourth syntax identifier information and the fifth syntax identifier information for the current layer from the attribute parameter set.

In the embodiment of the disclosure, only when it is determined that attribute prediction is enabled to be performed on the nodes of the current layer, and when it is determined that inter prediction and intra prediction are enabled to be performed on the nodes of the current layer, the decoder determines the target decoding mode for the current layer by parsing the bitstream. That is, when the decoder determines that the first syntax identifier information for the current layer is true (1 or true), the decoder continues to parse the bitstream to determine the target attribute of the current layer.

In some embodiments of the disclosure, the decoding method further includes that: when the fourth syntax identifier information indicates that inter prediction is enabled to be performed on the nodes of the current layer, attribute decoding is performed on the nodes in the current layer based on the region-adaptive hierarchical inter transform mode, to determine attribute reconstruction values for the nodes in the current layer.

In some embodiments of the disclosure, the decoding method further includes that:
when the value of the fourth syntax identifier information is the first value, it is determined that inter prediction is enabled to be performed on the nodes of the current layer;
when the value of the fourth syntax identifier information is the second value, it is determined that inter prediction is disabled to be performed on the nodes of the current layer.

In some embodiments of the disclosure, the decoding method further includes that:
when the value of the fifth syntax identifier information is the first value, it is determined that inter prediction is enabled to be performed on the nodes of the current layer;
when the value of the fifth syntax identifier information is a second value (false), it is determined that inter prediction is disabled to be performed on the nodes of the current layer.

In some embodiments of the disclosure, the decoding method further includes that:

the bitstream is parsed to determine the value of the sixth syntax identifier information (attr_coding_type); the sixth syntax identifier information is used to indicate that the region-adaptive hierarchical inter transform mode is used for the nodes in the current layer.

In the embodiment of the disclosure, the sixth syntax identifier information may be represented as attr_coding_type.

In an embodiment of the disclosure, a decoding method is provided, which is applied to a decoder. First, when it is determined that attribute prediction is enabled to be performed on the nodes of the current layer, the decoder parses a bitstream to determine first syntax identifier information. Then, when the first syntax identifier information indicates that adaptive selection of the inter prediction mode and/or the intra prediction mode for the current layer is enabled, the decoder parses the bitstream to determine a target decoding mode for the current layer. Finally, the decoder uses the parsed target decoding mode to perform attribute reconstruction on the attributes of the point cloud, thereby improving the decoding efficiency of the point cloud attributes, and further improving the decoding performance of point cloud.

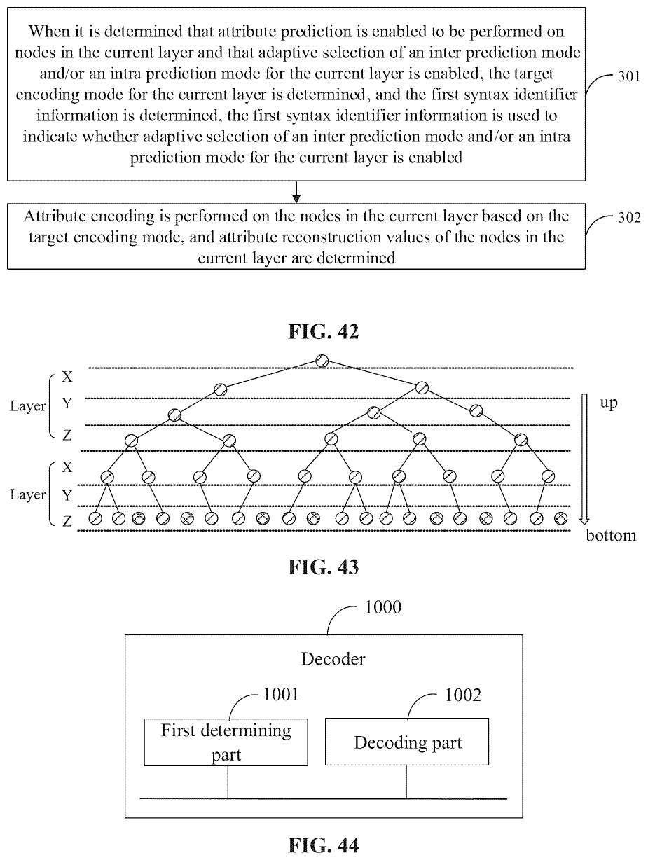

In another embodiment of the disclosure, referring to FIG. 42, which is a schematic flowchart of an encoding method according to the embodiment of the disclosure. As illustrated in FIG. 42, the method may include operations S301 to S302:

In operation S301, when it is determined that attribute prediction is enabled to be performed on nodes in the current layer and that adaptive selection of an inter prediction mode and/or an intra prediction mode for the current layer is enabled, the target encoding mode for the current layer is determined, and the first syntax identifier information is determined, the first syntax identifier information is used to indicate whether adaptive selection of an inter prediction mode and/or an intra prediction mode for the current layer is enabled.

It should be noted that, in the embodiment of the disclosure, the encoding method is applied to a point cloud encoder (which may be abbreviated as an “encoder”). The encoding method may be a point cloud attribute encoding method, and more specifically, a method for point cloud attributes encoding that adaptively selects inter prediction or intra prediction for encoding through RAHT prediction.

It should also be noted that, in the embodiment of the disclosure, this primarily involves introducing a corresponding target encoding mode for each layer in the current sequence within the Attribute Brick Header (ABH) information parameter set, and the corresponding target encoding mode can be adaptively selected for each layer, thereby improving the encoding efficiency of point cloud attributes.

In an embodiment of the disclosure, the current layer may be one of the layers in the current video picture.

In an embodiment of the disclosure, the current layer includes at least one node.

In the embodiment of the disclosure, when on the encoder side, the current layer may be referred to as a current attribute encoding layer, a current encoding layer, a current slice, or the like. The embodiments of the disclosure do not make any limitation thereto.

In an embodiment of the disclosure, the current layer is a encoding layer obtained by performing one downsampling along the first direction, the second direction, and the third direction. Here, the first direction is the z-axis direction, the second direction is the y-axis direction, and the third direction is the x-axis direction.

It should be noted that the embodiment of the disclosure does not limit the order of the first direction, the second direction, and the third direction. For example, the order may be: the second direction, the first direction, and the third direction; or the third direction, the second direction, and the first direction.

In an embodiment of the disclosure, the current layer is not limited to one encoding layer obtained by performing one downsampling along the first direction, the second direction, and the third direction, and the current layer may also be multiple encoding layers obtained by performing one downsampling along the first direction, the second direction, and the third direction. The current layer may be a layer composed of at least one node in one encoding layer. The embodiments of the disclosure do not make any limitation thereto.

In an embodiment of the disclosure, the first syntax identifier information is used to indicate that adaptive selection of the inter prediction mode and/or the intra prediction mode for the current layer is enabled.

In some embodiments of the disclosure, the encoding method further includes that: the first syntax identifier information is determined.

In some embodiments of the disclosure, the implementation of determining the first syntax identifier information may include that:
if it is determined that adaptive selection of the inter prediction mode and/or the intra prediction mode for the current coefficient group is enabled, it is determined that the value of the first syntax identifier information is a first value; and the current coefficient group includes at least one layer, the current layer is one of the at least one layer;
if it is determined that adaptive selection of the inter prediction mode and/or the intra prediction mode for the current coefficient group is disabled, it is determined that the value of the first syntax identifier information is a second value.

In some embodiments of the disclosure, the implementation of determining the first syntax identifier information may further include that:
if it is determined that adaptive selection of the inter prediction mode and/or the intra prediction mode for the current layer is enabled, it is determined that the value of the first syntax identifier information is a first value;
if it is determined that adaptive selection of the inter prediction mode and/or the intra prediction mode for the current layer is disabled, it is determined that the value of the first syntax identifier information is a second value.

It should be noted that, in the embodiment of the disclosure, the first value is different from the second value, and the first value and the second value may be in a parameter form or a numerical form. Specifically, the first syntax identifier information may be a parameter signalled in a profile, or may be a value of a flag, which is not specifically limited here.

Exemplarily, for the first value and the second value, the first value may be set to 1, and the second value may be set to 0. Alternatively, the first value may be set to 0, and the second value may be set to 1. Alternatively, the first value may be set to true, and the second value may be set to false. Alternatively, the first value may be set to false, and the second value may be set to true. It is not specifically limited here.

In the embodiment of the disclosure, taking the flag signalled in the bitstream as an example, assuming that the first value is set to 1 (true) and the second value is set to 0 (false), and if the value of the first syntax identifier information is 0 (false), it may be determined that adaptive selection of the inter prediction mode and/or the intra prediction mode for the current layer is disabled, that is, the encoding method described in the embodiment of the disclosure does not need to be performed. If the value of the first syntax identifier information is 1 (true), it may be determined that adaptive selection of the inter prediction mode and/or the intra prediction mode for the current layer is enabled, that is, the encoding method described in the embodiment of the disclosure needs to be performed.

In the embodiment of the disclosure, the first syntax identifier information acts as a switch. When the first syntax identifier information is a first value (such as 1 or true), it indicates that the encoding algorithm described in the embodiment of the disclosure is enabled, that is, the encoding algorithm described in the embodiment of the disclosure is performed. When the first syntax identifier information is a second value (such as 0 or false), it indicates that the encoding algorithm described in the embodiment of the disclosure is disabled, that is, the encoding algorithm described in the embodiment of the disclosure is not performed.

It should be understood that, compared with the solution in the related art where the attribute encoding mode for the current sequence is directly determined in the sequence set, in the embodiment of the disclosure, by setting the first syntax identifier information, intra prediction and/or inter prediction can be adaptively selected for different layers to perform attribute encoding on the nodes, the distribution of AC coefficients of different layers can be sufficiently considered, thereby improving the encoding efficiency through the RAHT.

In the embodiment of the disclosure, after determining whether attribute prediction is enabled to be performed on the nodes in the current layer, the value of the sixth syntax identifier information is determined. The sixth syntax identifier information is used to indicate whether attribute prediction is enabled to be performed on the nodes in the current layer; the sixth syntax identifier information is encoded, and the obtained encoded bits are signalled into the bitstream.

In an embodiment of the disclosure, the operation of determining the value of the sixth syntax identifier information may include that: if it is determined that attribute prediction is enabled to be performed on the nodes in the current layer, the value of the sixth syntax identifier information is set to a first value; if it is determined that attribute prediction is disabled to be performed on the nodes in the current layer, the value of the sixth syntax identifier information is set to the second value.

It can be understood that after the encoder performs encoding processing on the sixth syntax identifier information and signals the obtained encoded bits into the bitstream, subsequently, the decoding end may make a determination based on the value of the sixth syntax identifier information by parsing the bitstream.

In an embodiment of the disclosure, the encoder and the decoder may determine whether attribute prediction is enabled to be performed on the nodes in the current layer through a mutually agreed-upon determination method. In an embodiment, the implementation for determining that attribute prediction is enabled to be performed on the nodes in the current layer may include that:
the number of adjacent nodes of the current layer is determined; herein, the adjacent nodes include the number of neighbouring nodes and the number of neighbouring nodes of the parent nodes;
when the number of adjacent nodes is greater than or equal to a preset threshold, it is determined that attribute prediction is enabled to be performed on the nodes in the current layer;
when the number of adjacent nodes is less than a preset threshold, it is determined that attribute prediction is disabled to be performed on the nodes in the current layer.

It should be understood that the encoder and the decoder may determine whether attribute prediction is enabled to be performed on the nodes in the current layer through a mutually agreed-upon determination method, so that the encoding end does not need to signal the encoded codewords of the sixth syntax identifier information into the bitstream, thereby saving codewords and improving encoding efficiency.

In an embodiment of the disclosure, the target encoding mode may be represented as attr_code_mode[i]; where i is the index value of the current layer.

It should be noted that the index value i is assigned only when the three conditions of enabling attribute prediction, enabling inter prediction, and enabling intra prediction are satisfied for the current layer.

For example, assuming that the index (i) of the current layer is 2, if the three conditions of enabling attribute prediction, enabling inter prediction, and enabling intra prediction are not satisfied for the current layer, the encoder directly skips the current layer, directly performs attribute encoding of the next layer, and assigns the index 2 to the next layer. If the three conditions of enabling attribute prediction, enabling inter prediction, and enabling intra prediction are satisfied for the current layer, the encoder performs attribute encoding on the current layer, then increments the index value by 1 (i++) to obtain the updated index value (3), and transmits the index value 3 to the next layer.

In some embodiments of the disclosure, the target encoding mode includes a region-adaptive hierarchical intra transform mode, a region-adaptive hierarchical inter transform mode, and a region-adaptive hierarchical combined transform mode.

The region-adaptive hierarchical intra transform mode characterizes using the intra prediction mode to perform attribute prediction transform encoding on the nodes in the current layer. The region-adaptive hierarchical inter transform mode characterizes using the inter prediction mode to perform attribute prediction transform encoding on the nodes in the current layer. The region-adaptive hierarchical combined transform mode characterizes using intra prediction mode combined with inter prediction mode to perform attribute prediction transform encoding on the nodes in the current layer.

In some embodiments of the disclosure, the region-adaptive hierarchical inter transform mode includes a first region-adaptive hierarchical inter transform mode and a second region-adaptive hierarchical inter transform mode. The region-adaptive hierarchical combined transform mode includes a first region-adaptive hierarchical combined transform mode, a second region-adaptive hierarchical combined transform mode, and a third region-adaptive hierarchical combined transform mode.

The first region-adaptive hierarchical inter transform mode characterizes performing attribute prediction transform encoding on nodes in the current layer in a manner of using geometric information of the nodes to determine collocated prediction nodes.

The second region-adaptive hierarchical inter transform mode characterizes performing attribute prediction transform encoding on the nodes in the current layer in a manner of using the cache of the reference pictures to determine collocated prediction nodes.

The first region-adaptive hierarchical combined transform mode characterizes using a combination of the region-adaptive hierarchical intra transform mode and the first region-adaptive hierarchical inter transform mode to perform attribute prediction transform encoding on the nodes in the current layer.

The second region-adaptive hierarchical combined transform mode characterizes using a combination of region-adaptive hierarchical intra transform mode and the second region-adaptive hierarchical inter transform mode to perform attribute prediction transform encoding on the nodes in the current layer.

The third region-adaptive hierarchical combined transform mode characterizes using a combination of the region-adaptive hierarchical intra transform mode, the first region-adaptive hierarchical inter transform mode and the second region-adaptive hierarchical inter transform mode to perform attribute prediction transform encoding on the nodes in the current layer.

It should be noted that for the relevant descriptions of the region-adaptive hierarchical intra transform mode, the first region-adaptive hierarchical inter transform mode, the second region-adaptive hierarchical inter transform mode, the first region-adaptive hierarchical combined transform mode, the second region-adaptive hierarchical combined transform mode, and the third region-adaptive hierarchical combined transform mode, reference can be made to the related descriptions provided earlier for the decoding end. No further elaboration will be given here.

In some embodiments of the disclosure, the encoding method further includes that:
second syntax identifier information is determined based on the target encoding mode;
the second syntax identifier information is added to the attribute brick header information parameter set, encoding processing is performed on the attribute brick header information parameter set, and the obtained encoded bits are signalled into the bitstream.

In the embodiment of the disclosure, the encoder determines the second syntax identifier information based on the value of the target encoding mode. Herein, the second syntax identifier information is used to indicate a target encoding mode for the current layer.

It should be noted that, in the embodiment of the disclosure, the value of the second syntax identifier information may be in a parameter form or a numerical form. The embodiments of the disclosure do not limit this in any way.

In some embodiments of the disclosure, the encoding method further includes that:
the target coding mode for the nodes in the current layer is encoded, and the obtained encoded bits are signalled into the bitstream.

In the embodiment of the disclosure, the encoding end employs a rate-distortion algorithm to obtain cost values corresponding to at least one candidate encoding mode, then determines the target encoding mode based on the cost values corresponding to at least one candidate encoding mode, and determines the first syntax identifier information. The first syntax identifier information is used to indicate whether adaptive selection of inter prediction mode and/or intra prediction mode for the current layer is enabled. Subsequently, the first syntax identifier information and the second syntax identifier information are signalled into the bitstream. Alternatively, the encoding end can directly signal the second syntax identifier information into the bitstream. In this case, at the subsequent decoding end, the decoding end can directly decode the second syntax identifier information to obtain the target decoding mode. The disclosure does not limit this in any way.

It should be noted that, in the embodiment of the disclosure, for encoding the target encoding mode for the current layer, the method may further include that: the target encoding mode for the current layer is added to the attribute brick header information parameter set. The attribute brick header information parameter set is encoded, and the obtained encoded bits are signalled into the bitstream.

It should also be noted that, in the embodiment of the disclosure, since the current sequence includes at least one layer, the target encoding mode for each layer is added to the attribute brick header information parameter set here. Accordingly, in some embodiments, the method may further include that: encoding layer partitioning is performed on the current sequence, at least one encoding layer is determined; the target encoding modes for each of at least one encoding layer are added to the attribute brick header information parameter set.

In this way, in the embodiment of the disclosure, subsequently at the decoding end, the decoding end can directly decode the target decoding mode for the current slice from the attribute brick header information parameter set.

In some embodiments of the disclosure, the implementation of determining the second syntax identifier information based on the target encoding mode may include that:
the value of the second syntax identifier information is determined based on the target decoding mode in which the inter prediction mode and/or the intra prediction mode are used for the current layer.

In some embodiments of the disclosure, the implementation of determining the value of the second syntax identifier information based on the target decoding mode in which the inter prediction mode and/or the intra prediction mode are used for the current layer may include that:
if the target encoding mode for the current layer is the region-adaptive hierarchical intra transform mode, the value of the second syntax identifier information is determined to be a third value;
If the target encoding mode for the current layer is the first region-adaptive hierarchical inter transform mode, the value of the second syntax identifier information is determined to be a fourth value;
If the target encoding mode for the current layer is the second region-adaptive hierarchical inter transform mode, the value of the second syntax identifier information is determined to be a fifth value;
If the target encoding mode for the current layer is the first region-adaptive hierarchical combined transform mode, the value of the second syntax identifier information is determined to be a sixth value;
If the target encoding mode for the current layer is the second region-adaptive hierarchical combined transform mode, the value of the second syntax identifier information is determined to be a seventh value;
If the target encoding mode for the current layer is the third region-adaptive hierarchical combined transform mode, the value of the second syntax identifier information is determined to be the eighth value.

In the embodiment of the disclosure, the third value, the fourth value, the fifth value, the sixth value, the seventh value, and the eighth value are different. It should be noted that the third value, the fourth value, the fifth value, the sixth value, the seventh value, and the eighth value may be in a parameter form or a numerical form. Exemplarily, the third value is 0, the fourth value is 1, the fifth value is 2, the sixth value is 3, the seventh value is 4, and the eighth value is 5. The embodiments of the disclosure do not limit the setting of the third value, the fourth value, the fifth value, the sixth value, the seventh value, and the eighth value.

In operation S302: attribute encoding is performed on the nodes in the current layer based on the target encoding mode, and attribute reconstruction values of the nodes in the current layer are determined.

It should be noted that, in the embodiment of the disclosure, after determining the target encoding mode for the current layer, the encoder may perform attribute encoding on the nodes in the current layer based on the target encoding mode, and then determine the attribute reconstruction values of the nodes in the current layer.

In the embodiment of the disclosure, if the target encoding mode is the region-adaptive hierarchical intra transform mode, the encoder performs attribute encoding on the nodes in the current layer based on the region-adaptive hierarchical intra transform mode to determine the attribute reconstruction values of the nodes in the current layer. If the target encoding mode is the first region-adaptive hierarchical inter transform mode, the encoder performs attribute encoding on the nodes in the current layer based on the first region-adaptive hierarchical inter transform mode to determine attribute reconstruction values of the nodes in the current layer. If the target encoding mode is the second region-adaptive hierarchical inter transform mode, the encoder performs attribute encoding on the nodes in the current layer based on the second region-adaptive hierarchical inter transform mode to determine attribute reconstruction values of the nodes in the current layer. If the target encoding mode is the first region-adaptive hierarchical combined transform mode, the encoder performs attribute encoding on the nodes in the current layer based on the first region-adaptive hierarchical combined transform mode to determine the attribute reconstruction values of the nodes in the current layer. If the target encoding mode is the second region-adaptive hierarchical combined transform mode, the encoder performs attribute encoding on the nodes in the current layer based on the second region-adaptive hierarchical combined transform mode to determine the attribute reconstruction values of the nodes in the current layer. If the target encoding mode is the third region-adaptive hierarchical combined transform mode, the encoder performs attribute encoding on the nodes in the current layer based on the third region-adaptive hierarchical combined transform mode to determine the attribute reconstruction values of the nodes in the current layer.

It should be understood that, in the embodiment of the disclosure, when it is determined that attribute prediction is enabled to be performed on nodes in the current layer, the encoder first determines the first syntax identifier information; when the first syntax identifier information indicates that adaptive selection of the inter prediction mode and/or the intra prediction mode for the current layer is enabled, the encoder determines a target encoding mode for the current layer; the encoder performs the attribute encoding on the nodes in the current layer based on the target encoding mode, and determines the attribute reconstruction values of the nodes in the current layer, thereby improving the encoding efficiency of the point cloud attributes, and further improving the encoding performance of the point cloud.

In some embodiments of the disclosure, the encoding method further includes that:
a value of the third syntax identifier information is determined; the third syntax identifier information is used to indicate the number of layers included in the current sequence where the current layer is located;
an index value of the current layer is obtained, and if the index value of the current layer is greater than or equal to a ninth value and less than the number of layers, the operation of determining a target encoding mode for the current layer is performed;
if the index value of the current layer is greater than the number of layers, the operation of determining the target encoding mode for the current layer is not performed;
the third syntax identifier information is encoded, and the obtained encoded bits are signalled into the bitstream.

In an embodiment of the disclosure, the number of layers included in the current sequence may be represented as attr_code_mode_cnt. It should be noted that the number of layers refers to the number of encoding layers in the current sequence that an inter prediction mode and/or an intra prediction mode can be adaptively selected.

For example, there are a total of 20 encoding layers included in the current sequence, if there are 10 layers in the current sequence that satisfy the three conditions of enabling attribute prediction, enabling inter prediction, and enabling intra prediction, the value of attr_code_mode_cnt is 10.

In an embodiment of the disclosure, the index value of the current layer may be represented as i, where i is an integer greater than or equal to 0.

In an embodiment of the disclosure, the ninth value is 0.

In the embodiment of the disclosure, if the index value of the current layer is greater than or equal to the ninth value and less than the number of layers, the operation of parsing the bitstream and determining the target encoding mode for the current layer is performed, which may be represented as follows:

$$for ( i = 0 ; i < am\_code \_mode \_cnt , i ++ )$$

$$attr\_code \_mode [ i ]$$

It should be understood that by using the third syntax identifier information to indicate the number of layers included in the current sequence where the current layer is located, it can achieves adaptively selecting the inter prediction and/or intra prediction mode for layers whose index values of encoding layers in the current sequence satisfy preset conditions (enabling attribute prediction, enabling inter prediction, and enabling intra prediction), so that the distribution of AC coefficients among different layers can be fully considered, thereby improving the encoding efficiency of attribute information.

In some embodiments of the disclosure, the implementation of determining the target encoding mode for the current layer in operation S301 may include operations S3011 to S3013.

In operation S3011, attribute encoding is performed on the current layer based on at least one candidate encoding mode, and a pre-encoding result for each ofthe at least one candidate encoding mode is determined.

In some embodiments of the disclosure, the at least one candidate encoding mode includes at least one of: a region-adaptive hierarchical intra transform mode, a first region-adaptive hierarchical inter transform mode, a second region-adaptive hierarchical inter transform mode, a first region-adaptive hierarchical combined transform mode, a second region-adaptive hierarchical combined transform mode, and a third region-adaptive hierarchical combined transform mode.

In operation S3012: cost calculation is performed based on the pre-encoding result for each of the at least one candidate encoding mode, to determine a cost value for each of the at least one candidate encoding mode.

It should be noted that, in the embodiment of the disclosure, the cost calculations are performed respectively for each of at least one candidate encoding mode, and the cost may refer to a distortion value, a rate distortion value, or another cost value, which is not specifically limited here.

In some embodiments of the disclosure, the implementation of operation S3012 may include that: performing rate-distortion cost calculation is performed based on the pre-encoding result of each of the at least one candidate encoding mode, to determine a cost value for each of the at least one candidate encoding mode.

Exemplarily, taking the rate-distortion cost as an example, in some embodiments, the operation of performing cost calculation based on the pre-encoding result for each of the at least one candidate encoding mode to determine a cost value for each of the at least one candidate encoding mode may include that: rate-distortion cost calculation is performed based on the pre-encoding result for each of the at least one candidate encoding mode to determine a cost value for each of the at least one candidate encoding mode.

In the embodiment of the disclosure, in the rate-distortion optimization algorithm, first, the distortion D between the reconstructed attribute and the original attribute for each candidate encoding mode is calculated; and subsequently, the bitstream R required for encoding each candidate encoding mode is obtained, and then the rate-distortion cost is calculated as follows:

$$J = D + λ \times R \qquad ( 36 )$$

Herein, J represents the rate-distortion cost value, R represents the bitstream required for encoding the candidate encoding mode, and λ may be calculated through attribute quantization parameters. The current manner for calculating λ is as follows:

$$λ = \sqrt{{2}^{\frac{Q P - 4}{6} \times 2} \times N} \qquad ( 37 )$$

Here, QP represents a quantization parameter, and N may be set to different values based on reflectance and colour.

In operation S3013: a target encoding mode for the current layer is determined from the at least one candidate encoding mode based on the respective cost values for the at least one candidate encoding mode.

In some embodiments of the disclosure, the implementation of S3023 may include that:
a minimum cost value is determined from the respective cost values for the at least one candidate encoding mode; and
the candidate encoding mode with the minimum cost value is determined as the target encoding mode for the current layer.

Exemplarily, assuming that at least one candidate encoding mode includes a second region-adaptive hierarchical combined transform mode and a third region-adaptive hierarchical combined transform mode, the cost calculations are performed respectively for the second region-adaptive hierarchical combined transform mode and the third region-adaptive hierarchical combined transform mode, to determine the first cost value for the second region-adaptive hierarchical combined transform mode and the second cost value for the third region-adaptive hierarchical combined transform mode; the target encoding mode for the current layer is determined based on the first cost value and the second cost value.

In the embodiment of the disclosure, the operation of determining the target encoding mode for the current layer based on the first-cost value and the second-cost value, specifically includes that: if the first cost value is less than the second cost value, the second region-adaptive hierarchical combined transform mode is determined as the target encoding mode for the current layer; alternatively, if the first cost value is greater than the second cost value, the third region-adaptive hierarchical combined transform mode is determined as the target encoding mode for the current layer.

Further, in the embodiment of the disclosure, if the first cost value is equal to the second cost value, the second region-adaptive hierarchical combined transform mode may be determined as the target encoding mode for the current layer, or the third region-adaptive hierarchical combined transform mode may be determined as the target encoding mode for the current layer, which is not specifically limited here.

In some embodiments of the disclosure, the implementation for operation S302 of performing attribute encoding on the nodes in the current layer based on the target encoding mode and determining the attribute reconstruction values of the nodes in the current layer may include operations S3021 to S3024.

In operation S3021: the attribute prediction values of the nodes in the current layer are determined.

In an embodiment of the disclosure, the encoder determines the attribute prediction value of each node in the current layer based on the number of adjacent nodes of the node in the current layer.

It should be noted that, in the embodiment of the disclosure, if the attribute of the node in the current layer can be predicted, the attribute prediction value of the node in the current layer can be obtained through linear fitting by using the reconstructed attributes of the neighbouring nodes of the node in the current layer and the geometric distances between each of the neighbouring nodes and the current node.

It should also be noted that, in the embodiment of the disclosure, the attribute prediction of the node in the current layer may be based on intra attribute prediction transform or inter attribute prediction transform, which is not specifically limited here.

In some embodiments of the disclosure, the implementation of determining attribute prediction values of the nodes in the current layer may include that:
adjacent nodes of each of the nodes in the current layer are determined; herein, the adjacent nodes include neighbouring nodes and neighbouring nodes of parent node; and
the attribute prediction value of the node in the current layer is determined by performing linear fitting based on the attribute reconstruction values for the adjacent nodes and the geometric distances between the node in the current layer and each of the adjacent nodes.

In a specific implementation, 19 neighbouring nodes of a node in the current layer are first determined, and then linear weighted prediction is performed on the attribute of each node by using the spatial geometric distances between the neighbouring nodes and the current node, and finally the attribute prediction value for each node is determined based on the prediction value obtained through linear weighting.

It should be noted that, in the embodiment of the disclosure, the region-adaptive hierarchical transform mode is a Haar wavelet transform, which may transform point cloud attribute information from the spatial domain to the frequency domain, and further reduce the correlation between point cloud attributes. The main idea is to adopt transforms to nodes in each layer along the X, Y, and Z dimensions in a bottom-up manner based on the octree structure, and iterate until reaching the root node of the octree. Here, the basic idea is to perform wavelet transforms based on the hierarchical structure of the octree, associating attribute information with octree nodes; recursive transforming the attributes of occupied nodes in the same parent node in a bottom-up manner; and performing transform on nodes in each layer along the X, Y, and Z dimensions until reaching the root node of the octree. During the hierarchical transform process, the first coefficients obtained after transforming nodes in the same layer are transferred to nodes at the next layer for further transform, while all second coefficients may be encoded and determined through an arithmetic encoder.

In operation S3022: forward transform is performed on the attribute prediction values of the nodes in the current layer based on the target encoding mode, and the first coefficient value and the second coefficient prediction value for each of the nodes in the current layer are determined.

In an embodiment of the disclosure, the forward transform is a RAHT forward transform, the first coefficient value is a DC coefficient, and the second coefficient prediction value is an AC coefficient prediction value.

In some embodiments of the disclosure, when the target encoding mode for the current layer is a region-adaptive hierarchical combined transform mode, the operation of determining a second coefficient prediction value for each of the nodes in the current layer includes that:
forward transform is performed on the node in the current layer based on the region-adaptive hierarchical combined transform mode to determine a first intermediate prediction value and a second intermediate prediction value of the node in the current layer;
the first intermediate prediction value and the second intermediate prediction value of the node in the current layer are added to obtain the second coefficient prediction value of the node in the current layer.

In an embodiment of the disclosure, the first intermediate prediction value may be represented as w*predIntraVal, and the second intermediate prediction value may be represented as w2*predIntraVal.

In some embodiments of the disclosure, the implementation for the operation of performing the forward transform on the node in the current layer based on the region-adaptive hierarchical combined transform mode to determine the first intermediate prediction value and the second intermediate prediction value of the node in the current layer, may include that:
a target weight combination corresponding to the current layer is determined from a preset weight table; herein, the target weight combination includes a first target weight and a second target weight;
forward transform is performed on the node in the current layer by using the region-adaptive hierarchical intra transform mode to determine the first attribute prediction value of the node in the current layer;
forward transform is performed on the node in the current layer by using the region-adaptive hierarchical inter transform mode to determine the second attribute prediction value of the node in the current layer;
the first attribute prediction value of the node in the current layer is multiplied by the first target weight to obtain the first intermediate prediction value of the node in the current layer; and
the second attribute prediction value of the node in the current layer is multiplied by the second target weight to obtain the second intermediate prediction value of the node in the current layer.

In the embodiment of the disclosure, the weight index value may be in a parameter form or a numerical form, which is not limited in the embodiment of the disclosure.

Exemplarily, the weight index value may be in numerical form, such as a weight index value of 2.

In an embodiment of the disclosure, the target weight combination includes a first target weight and a second target weight. In another embodiment, the target weight combination includes a first target weight, a second target weight, and a third target weight.

The number of target weights included in the target weight combination is related to the target encoding mode.

For example, if the target encoding mode is the region-adaptive hierarchical intra transform mode, the target weight combination includes a first target weight w1. If the target encoding mode is the first region-adaptive hierarchical inter transform mode, the target weight combination includes a second target weight w2. If the target encoding mode is a second region-adaptive hierarchical inter transform mode, the target weight combination includes a third target weight w3. If the target encoding mode is the first region-adaptive hierarchical combined transform mode, the target weight combination includes a first target weight w1 and a second target weight w2. If the target encoding mode is the second region-adaptive hierarchical combined transform mode, the target weight combination includes a first target weight w1 and a third target weight w3. If the target encoding mode is the third region-adaptive hierarchical combined transform mode, the target weight combination includes a first target weight w1, a second target weight w2, and a third target weight w3.

It can be understood that when the target encoding mode for the current layer is a region-adaptive hierarchical combined transform mode, the inter prediction values and intra prediction values from different RAHT transform layers will be combined to finally obtain the optimal prediction value based on different weights, thereby further improving the efficiency of RAHT encoding for point cloud attributes.

In some embodiments of the disclosure, the weight index value corresponding to the target weight combination in the preset weight table is encoded, and the obtained encoded bits are signalled into the bitstream.

In some embodiments of the disclosure, when the target encoding mode for the current layer is a region-adaptive hierarchical inter transform mode or a region-adaptive hierarchical combined transform mode, after determining the second coefficient prediction value of the node in the current layer, the method further includes that:
when the second coefficient prediction value of the node in the current layer is a tenth value, forward transform is performed on the node in the current layer based on the region-adaptive hierarchical intra transform mode to obtain an intermediate second coefficient prediction value of the node in the current layer; and
the intermediate second coefficient prediction value is used as the second coefficient prediction value of the node in the current layer.

It should also be noted that in the embodiment of the disclosure, the first coefficient may refer to a low-frequency coefficient, and may also be referred to as a Direct Current (DC) coefficient; the second coefficient may refer to a high-frequency coefficient, or may be referred to as an Alternating Current (AC) coefficient. In the process of hierarchical transform, the DC coefficients obtained after transforming the nodes in the same layer are transferred to the nodes in the next layer for further transform, and the AC coefficients obtained after the transform of each layer will be quantized and encoded.

In operation S3023, a second coefficient value for the node of the current layer is determined based on the second coefficient prediction value.

In some embodiments of the disclosure, the implementation of determining the second coefficient value for the node of the current layer based on the second coefficient prediction value may include that:
a second coefficient encoded residual value for the node in the current layer is determined;
inverse quantization is performed on the second coefficient encoded residual value to obtain the second coefficient inverse-quantized residual value of the node in the current layer;
the second coefficient value of the node in the current layer is determined based on the second coefficient prediction value and the second coefficient inverse-quantized residual value of the node in the current layer.

In some embodiments of the disclosure, an implementation of determining a second coefficient encoded residual value of the node in the current layer may include that:
an attribute original value of the node in the current layer is determined;
forward transform is performed on the attribute original value of the node in the current layer based on the target encoding mode to determine the first coefficient value and the second coefficient original value of the node in the current layer;
a second coefficient prediction residual value of the node in the current layer is determined based on the second coefficient original value and the second coefficient prediction value of the node in the current layer;
quantization is performed on second coefficient residual value to obtain the second coefficient quantized residual value of the node in the current layer.

In some embodiments of the application, the encoding method further includes that:

The second coefficient quantized residual value of the node in the current layer is encoded, and the obtained encoded bits are signalled into the bitstream.

In operation S3024, inverse transform is performed on the first coefficient value and the second coefficient value of the node in the current layer based on the target encoding mode, to determine the attribute reconstruction value of the node in the current layer.

It should also be noted that in the embodiment of the disclosure, the first coefficient may refer to a low-frequency coefficient, and may also be referred to as a Direct Current (DC) coefficient; the second coefficient may refer to a high-frequency coefficient, or may be referred to as an Alternating Current (AC) coefficient. In the process of hierarchical transform, the DC coefficients obtained after transforming the nodes in the same layer are transferred to the nodes in the next layer for further transform, and the AC coefficients obtained after the transform of each layer will be quantized and decoded, enabling the subsequent determination of the second coefficient values for the nodes in the current slice at the decoding end.

Further, in the embodiment of the disclosure, it is assumed that

$${g}_{L , 2 x , y , z}^{′} and {g}_{L , 2 x + 1 , y , z}^{′}$$

are attribute DC coefficients of two neighbouring points at layer L. After the linear transform, the information of the layer L−1 includes AC coefficient

$${f}_{L - 1 , x , y , z}^{′}$$

and DC coefficient

$${g}_{L - 1 , x , y , z}^{′} . Then {f}_{L - 1 , x , y , z}^{′}$$

will no longer be transformed and directly quantized and encoded;

$${g}_{L - 1 , x , y , z}^{′}$$

will continue to find the neighbouring points for further transform, and if no neighbouring points are found, it will be directly transferred to the layer L−2. In other words, the RAHT transform is only valid for the node with neighbouring points, and the node without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′} are {w}_{L , 2 x , y , z}^{′} and$$

$${w}_{L , 2 x + 1 , y , z}^{′} ( abbreviated as {w}_{0}^{′} and {w}_{1}^{′} )$$

respectively, and the weight of

$${g}_{L - 1 , x , y , z}^{′} is {w}_{L - 1 , x , y , z}^{′} .$$

The general transform formula is as follows:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 38 )$$

Herein, T_{w0,w1} is the transform matrix, and the transform matrix is adaptively updated as the corresponding weights of each points change. The forward transform of the RAHT (which may also be referred to as the “RAHT forward transform”) is illustrated in FIG. 35A described above.

It should also be noted that, in the embodiment of the disclosure, the reverse RAHT transform is performed based on the obtained DC coefficients and AC coefficients of the points in the current slice, and the attribute reconstruction values of the points in the current slice can be recovered. The inverse transform of the RAHT (which may also be referred to as “inverse RAHT transform” or “RAHT inverse transform”) is as illustrated in FIG. 35B described above.

In a specific embodiment, taking the current node in the current layer as an example, the implementation steps of the encoding end are as follows.

Firstly, when it is determined to perform attribute prediction on the current node, the reconstructed attributes of neighbouring nodes of the current node and the spatial geometric distances between each of neighbouring nodes and the current node are used to perform linear fitting to obtain the attribute prediction value for each of child nodes of the current node.

Secondly, using the attribute prediction value of each child node, RAHT transform is performed to obtain the corresponding DC and AC coefficients. Similarly, RAHT transform is performed on the attributes of each child node of the current node to obtain DC and AC coefficients.

Thirdly, prediction is performed on the AC coefficients of the current node by using the prediction value of the AC coefficients obtained through the prediction node, and finally the AC prediction residual coefficient of each child node is quantized and encoded.

Fourthly, the AC reconstruction coefficient of the current node is recovered by using the inverse-quantized value of the AC prediction residual coefficients and the prediction value of the AC coefficients; and finally, RAHT inverse transform is performed by using the AC and DC coefficients of the current node, so as to recover the attribute reconstruction value of each child node of the current node.

Finally, the foregoing operations are continuously repeated from the root node of the RAHT transform to the last node of the leaf node layer of the RAHT, thereby completing the attribute encoding for the RAHT transform of the current layer.

That is, in the embodiment of the disclosure, first, when it is determined that attribute prediction is enabled to be performed on nodes in the current layer, the encoder determines the first syntax identifier information; when the first syntax identifier information indicates that adaptive selection of an inter prediction mode and/or an intra prediction mode for the current layer is enabled, the encoder determines a target encoding mode for the current layer; the encoder performs the attribute encoding on the nodes in the current layer based on the target encoding mode, determines the attribute reconstruction values of the nodes in the current layer, thereby improving the encoding efficiency of the point cloud attributes, and further improving the encoding performance of the point cloud.

In some embodiments of the disclosure, the encoding method further includes that:
a value of the fourth syntax identifier information and a value of the fifth syntax identifier information are determined; the fifth syntax identifier information is used to indicate whether intra prediction is enabled to be performed on the nodes of the current layer;
when the fourth syntax identifier information and the fifth syntax identifier information are both the first value, it is determined that the value of the first syntax identifier information is the first value;
when either the fourth syntax identifier information or the fifth syntax identifier information is a second value, it is determined that the value of the first syntax identifier information is a second value; and
the first syntax identifier information is encoded, and the obtained encoded bits are signalled into the bitstream.

In the embodiment of the disclosure, only when the fourth syntax identifier information and the fifth syntax identifier information are both the first value, the first syntax identifier information is the first value, that is, when it is determined that inter prediction and intra prediction are enabled to be performed on the current attribute-encoded node, the first syntax identifier information is the first value.

In the embodiment of the disclosure, the fourth syntax identifier information may be represented as: !disableAttrInterPred, the fifth syntax identifier information may be represented as: raht_prediction_enabled.

Exemplary, when !disableAttrInterPred is true, it is determined that inter prediction is enabled to be performed on the nodes of the current layer. When !disableAttrInterPred is false, it is determined that inter prediction is disabled to be performed on the nodes of current layer.

Exemplarily, when raht_prediction_enabled is true (1), it is determined that intra prediction is enabled to be performed on the nodes of the current layer. When raht_prediction_enabled is false (0), it is determined that intra prediction is disabled to be performed on the nodes of the current layer.

In some embodiments of the disclosure, the encoding method further includes that:
when it is determined that inter prediction is enabled to be performed on the nodes of the current layer, the value of the fourth syntax identifier information is set to a first value;
when it is determined that inter prediction is disabled to be performed on the nodes of the current layer, a value of the fourth syntax identifier information is set to a second value; and
the fourth syntax identifier information is encoded, and the obtained encoded bits are signalled into the bitstream.

In some embodiments of the disclosure, the encoding method further includes that:
when it is determined that intra prediction is enabled to be performed on the nodes of the current layer, the value of the fifth syntax identifier information is set to a first value;
when it is determined that intra prediction is disabled to be performed on the nodes of the current layer, a value of the fifth syntax identifier information to a second value; and
the fifth syntax identifier information is encoded, and the obtained encoded bits are signalled into the bitstream.

In some embodiments of the disclosure, the encoding method further includes that:
a value of the sixth syntax identifier information is determined; the sixth syntax identifier information is used to indicate that the region-adaptive hierarchical inter transform mode is used for the nodes in the current layer; and
the sixth syntax identifier information is encoded, and the obtained encoded bits are signalled into the bitstream.

In some embodiments of the disclosure, the encoding method further includes that:
the number of adjacent nodes of the current layer is determined; herein, the adjacent nodes include the number of neighbouring nodes and the number of neighbouring nodes of the parent nodes; and
when the number of adjacent nodes is greater than or equal to a preset threshold, it is determined that attribute prediction is enabled to be performed on the nodes in the current layer.

In some embodiments of the disclosure, the encoding method further includes that:
neighbouring nodes of each node in the current layer are determined based on the spatial position of each node;
herein, the neighbouring nodes of the node at least includes neighbouring nodes coplanar with the node and neighbouring nodes collinear with the node.

In some embodiments of the disclosure, the encoding method further includes that:
a parent node of each node in the current layer is determined; and
neighbouring nodes of the parent node of each node are determined based on the spatial position of the parent node of each node; herein, neighbouring nodes of the parent node of the node at least includes neighbouring nodes coplanar with the parent node of the node and neighbouring nodes collinear with the parent node of the node.

It should be noted that, in the embodiment of the disclosure, the spatial position information of each node in the current layer may be position information of the node, specifically, three-dimensional coordinate information (x, y, z).

In a specific implementation, neighbouring nodes of a node may include neighbouring nodes coplanar with the node and neighbouring nodes collinear with the node. Exemplarily, as illustrated in FIG. 37, a block filled with grid lines may represent the current node, and then blocks filled with diagonal lines may represent neighbouring nodes that are coplanar and collinear with the current node.

In some embodiments of the disclosure, at the encoding side, the operation of determining the number of adjacent nodes of the current layer, includes that:
the number of neighbouring nodes of all nodes in the current layer is counted to determine the number of the neighbouring nodes in the current layer;
the number of neighbouring nodes of parent nodes of nodes in the current layer is counted to determine the number of neighbouring nodes of the parent nodes in the current layer; and
the number of the neighbouring nodes and the number of the neighbouring nodes of the parent nodes are added to obtain the number of the adjacent nodes of the current layer.

It should be understood that, in the G-PCC coding framework, RAHT can be used as both transform and prediction, resulting in high complexity. Considering the problem of high complexity, the related art sets an enabling condition for whether attribute prediction is enabled to be performed on the current node. Specifically: whether the number of adjacent nodes in the current layer is greater than a preset threshold is determined. In this way, by setting the determining condition of whether attribute prediction is enabled for the current layer, the memory usage for point cloud attribute encoding can be reduced while maintaining complexity, and the decoding efficiency of point cloud can be improved.

In the embodiment of the disclosure, when it is determined that attribute prediction is enabled to be performed on nodes in the current layer, the encoder first determines the first syntax identifier information; when the first syntax identifier information indicates that adaptive selection of the inter prediction mode and/or the intra prediction mode for the current layer is enabled, the encoder determines a target encoding mode for the current layer; the encoder performs the attribute encoding on the nodes in the current layer based on the target encoding mode, and determines the attribute reconstruction values of the nodes in the current layer, thereby improving the encoding efficiency of the point cloud attributes, and further improving the encoding performance of the point cloud.

In another embodiment of the disclosure, based on the encoding and decoding method described in the foregoing embodiment, a point cloud attribute RAHT transform prediction RDO adaptive selection scheme for inter prediction or intra prediction encoding is specifically proposed here. At the encoding end, the optimal encoding mode for each attribute encoding layer is adaptively selected based on the RDO mode, and then the final optimal encoding mode is transmitted to the decoding end. The decoding end uses the obtained optimal encoding mode to perform attribute reconstruction on the point cloud attributes, so as to further improve the encoding efficiency of the point cloud attributes.

In the embodiment of the disclosure, a new encoding scheme is introduced to improve the encoding efficiency of point cloud attributes. First, by combining three attribute prediction encoding schemes (two inter prediction encoding schemes and one intra prediction encoding scheme), and before encoding the AC coefficients of different RAHT encoding layers, the optimal encoding mode of the current RAHT encoding layer is obtained by using the rate-distortion optimization algorithm at the encoding end. Specifically, the inter prediction encoding scheme 2+intra prediction encoding, the inter prediction encoding scheme 1+inter prediction encoding scheme 2+intra prediction encoding scheme. Finally, the optimal encoding mode for the current RAHT encoding layer is transmitted to the decoding end. The decoding end then adaptively recovers the AC coefficients of the current layer by using the encoding mode of the current RAHT layer, thereby completing the entire attribute RAHT encoding process and ultimately enhancing the encoding efficiency of RAHT attributes.

In the embodiment of the disclosure, as illustrated in FIG. 43, first, the RAHT attribute encoding layer (i.e., the current layer) is defined. Currently, the attribute RAHT transform encoding sequence proceeds by dividing from the root node successively down to the voxel level (1×1×1), thereby completing the entire point cloud attribute encoding and attribute reconstruction. Here, a layer obtained by performing downsampling once along the z-direction, y-direction, and x-direction each time is defined as a RAHT transform layer, i.e., a layer. Secondly, based on the RAHT layers, a rate-distortion optimization algorithm is introduced to adaptively select the prediction encoding method for the current layer. Two prediction encoding modes are introduced: 1, a combination of intra prediction and inter prediction encoding mode 2 (i.e., the second region-adaptive hierarchical combined transform mode); 2, a combination of intra prediction encoding mode, inter prediction encoding mode 2 and inter prediction encoding mode 1 (i.e., the third region-adaptive hierarchical combined transform mode).

Further, the encoding end uses the two prediction modes through the rate-distortion optimization algorithm to predict and encode the attribute information of the nodes in the current layer. Finally, the optimal encoding mode for the current layer is obtained through the rate-distortion optimization algorithm, and this optimal encoding mode is transmitted to the decoding end. The decoding end uses the parsed prediction decoding mode to reconstruct and recover the attribute information of the points in the current layer to be decoded. In the rate-distortion optimization algorithm, first, the distortion D between the reconstructed attributes and the original attributes for each prediction mode is calculated; then the bitstream R required for encoding each prediction mode is obtained, and the rate-distortion cost is calculated as shown in the aforementioned equations (36) and (37).

In the embodiment of the disclosure, the target encoding mode for each layer is finally added to the ABH parameter set. In a specific embodiment, the specific algorithm at the encoding end is as follows.

Operation 1: whether attribute prediction may be used for the nodes in the current layer is adaptively determined based on the number of neighbouring nodes of the current layer and the number of neighbouring nodes of the parent nodes.

Operation 2: if attribute prediction may be used for the nodes in the current layer and inter prediction for attributes is enabled, the rate-distortion optimization algorithm is introduced for the current layer, and a cost for each prediction encoding mode is calculated by encoding each node of the current layer to obtain an optimal prediction encoding mode.

Operation 3: Finally, the optimal prediction encoding mode is used to predictively encode the attributes of nodes in the current layer.

In another specific embodiment, the specific algorithm at the decoding side is as follows.

Operation 1: whether attribute prediction may be used for the nodes in the current layer is adaptively determined based on the number of neighbouring nodes of the current layer and the number of neighbouring nodes of the parent nodes.

Operation 2: if attribute prediction may be used for the nodes in the current layer and inter prediction for attributes is enabled, an optimal prediction decoding mode is obtained for the nodes in the current layer.

Operation 3: finally, the optimal prediction decoding mode is used to predictively decode the attribute of nodes in the current layer.

Further, in the embodiment of the disclosure, the description for the Attribute parameter set data unit syntax in APS is shown in Table 2.

TABLE 2

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if(lod_dist_log2_offset_present) | | |
| lod_dist_log2_offset | se(v) | 10.6.2 |
| if(last_comp_pred_enabled && AttrDim == 3) | | |
| for(dpth = 0; dpth ≤ lod_max_levels_minus1; dpth++) | | |
| last_comp_pred_coeff_diff[dpth] | se(v) | 10.6.10.1 |
| if(inter_comp_pred_enabled) | | |
| for(dpth = 0; dpth ≤ lod_max_levels_minus1; dpth++) | | |
| for(c = 1; c < AttrDim; c++) | | |
| inter_comp_pred_coeff_diff[dpth][c] | se(v) | 10.6.10.1 |
| if(attr_qp_offsets_present) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth = 0; dpth ≤ attr_qp_layer_cnt_minus1; dpth++) | | |
| for(qc = 0; qc < Min(2, AttrDim); qc++) | | |
| attr_qp_layer_offset[dpth][qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(i = 0; i < attr_qp_region_cnt; i++) { | | |
| if(¬attr_coord_conv_enabled) { | | |
| for(k = 0; k < 3; k++) | | |
| attr_qp_region_origin_xyz[i][k] | u(v) | 10.7.1 |
| for(k = 0; k < 3; k++) | | |
| attr_qp_region_size_minus1_xyz[i][k] | u(v) | 10.7.1 |
| } else { | | |
| for(k = 0; k < 3; k++) | | |
| attr_qp_region_origin_rpi[i][k] | u(v) | 10.7.1 |
| for(k = 0; k < 3; k++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[i][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for(i = 0; i < attr_code_mode_cnt; i++) | | |
| attr_code_mode[i] | u(1) | |
| } | | |
| byte_alignment( ) | | |
| } | | |

In simple terms, in the embodiment of the disclosure, when performing RAHT prediction encoding on attributes, a prediction encoding mode (attr_code_mode[i]) is introduced for each RAHT encoding layer to adaptively select either a combination of inter prediction encoding mode 2 and intra prediction encoding mode or a combination of intra prediction encoding and two inter prediction encoding modes. This encoding mode is ultimately transmitted to the decoding end. The decoding end uses this encoding mode to reconstruct the point cloud attributes. The key aspect of this solution is the introduction of an encoding mode for each RAHT encoding layer. The optimal encoding mode is determined at the encoding end by using a rate-distortion optimization selection algorithm; and at the decoding end, the decoding mode is used to reconstruct the point cloud attributes. Currently, the encoding mode for each layer is stored in the ABH, and the decoding end obtains the decoding mode for the RAHT encoding layer through the ABH. The form in which this parameter is encoded is not restricted here.

In an embodiment of the disclosure, the attribute inter prediction encoding mode may be further refined. Specifically, in the main solution, three existing prediction encoding modes are combined: a combination of inter prediction encoding mode 2 and intra prediction encoding mode, inter prediction encoding mode 2, inter prediction encoding mode 1, and intra prediction encoding mode. At the encoding end, an encoding mode is introduced for the current RAHT encoding layer to represent which prediction encoding mode is used to restore the AC coefficients of the current RAHT encoding layer. This solution may further modify the prediction encoding modes to: inter prediction encoding mode 1, intra prediction encoding mode, and inter-frame prediction encoding mode 1. In the same manner as the main solution, the optimal encoding mode for the current layer is determined. The decoding end also recovers the AC coefficients of the current layer based on the prediction encoding mode of the current layer, thereby completing the entire RAHT attribute coding process.

In an embodiment of the disclosure, the attribute prediction mode may be further refined. Specifically, in the main solution, for any prediction encoding mode, it is first determined whether the inter attribute prediction value is equal to zero. If it is not equal to zero, the current prediction value is directly used as the predictive value for the AC coefficients of the current node. Otherwise, the AC coefficients obtained through intra prediction are used as the prediction value for the AC coefficients of the current node. In this solution, the inter and intra prediction values for different RAHT transform layers are combined, and the optimal prediction value is ultimately obtained by applying different weights, thereby further improving the RAHT encoding efficiency for point cloud attributes. The specific prediction encoding scheme is shown in Equation (X).

In the embodiment of the disclosure, detailed explanations have been provided on the specific implementation of the aforementioned embodiments. It may be seen that, based on the technical solutions of the preceding embodiments, a layer-based rate-distortion optimization encoding algorithm is proposed here. When performing inter RAHT prediction for attributes, if attribute prediction is enabled to be performed on the current layer to be encoded, two encoding modes are first introduced for the current layer to be encoded. Subsequently, the rate-distortion optimization algorithm is used to select the optimal prediction encoding mode for prediction encoding, thereby improving the encoding efficiency of point cloud attributes. Furthermore, the final optimal encoding mode is transmitted to the decoding end. The decoding end uses the obtained optimal encoding mode to reconstruct the point cloud attributes, thereby further enhancing the coding efficiency of point cloud attributes. Exemplarily, Table 3 shows the test results regarding the coding efficiency of attributes.

TABLE 3

| Frame-Idx | Anchor | Proposal | Bpp |
|---|---|---|---|
| 0 | 21376 | 21128 | 98.8% |
| 1 | 18313 | 17632 | 96.2% |
| 2 | 17933 | 17175 | 95.7% |
| 3 | 17745 | 16698 | 94.1% |
| 4 | 18151 | 17516 | 96.5% |
| 5 | 17902 | 17341 | 96.8% |
| 6 | 17500 | 16519 | 94.3% |
| 7 | 18072 | 17422 | 96.4% |

As may be seen from Table 3, after introducing the rate-distortion optimization algorithm, for sequences that can adopt inter attribute prediction, the attribute coding BPP is reduced by about 3.9%, which significantly improves the coding efficiency of point cloud attributes.

In an embodiment of the disclosure, based on the same inventive concept as the above embodiments, a bitstream is provided, herein, the bitstream is generated by bit encoding information to be encoded. Herein the information to be encoded includes at least one of the following: a value of the first syntax identifier information, a value of the second syntax identifier information, a value of the third syntax identifier information, a value of the fourth syntax identifier information, a value of the fifth syntax identifier information, a weight index value for the nodes in the current layer, and a second coefficient quantized residual value for the node in the current layer;

Herein, the first syntax identifier information is used to indicate whether adaptive selection of the inter prediction mode and/or the intra prediction mode for the current layer is enabled; the second syntax identifier information is used to indicate the target encoding mode for the current layer; the value of the third syntax identifier information is used to indicate the number of layers included in the current sequence where the current layer is located; the value of the fourth syntax identifier information is used to indicate whether inter prediction is enabled to be performed on the nodes in current layer; the fifth syntax identifier information is used to indicate whether intra prediction is enabled to be performed on the nodes in current layer; and the sixth syntax identifier information is used to indicate that the region-adaptive hierarchical inter transform mode is used for the nodes in the current layer; the weight index value is used to indicate the index value in a preset weight table that corresponds to the target weight combination for nodes in the current layer.

In another embodiment of the disclosure, based on the same inventive concept as the above-described embodiments, referring to FIG. 44, which illustrates a schematic diagram of a compositional structure of a decoder according to the embodiment of the disclosure. As illustrated in FIG. 44, the decoder 1000 may include a first determining part 1001 and a decoding part 1002.

The first determining part 1001 is configured to: when it is determined that attribute prediction is enabled to be performed on nodes in the current layer, parse the bitstream to determine first syntax identifier information; when the first syntax identifier information indicates that adaptive selection of the inter prediction mode and/or the intra prediction mode for the current layer is enabled, parse the bitstream to determine a target decoding mode for the current layer.

The decoding part 1002 is configured to: perform attribute decoding on the nodes in the current layer based on the target decoding mode to determine attribute reconstruction values of the nodes in the current layer.

In some embodiments of the disclosure, the first determining part 1001 is further configured to: when the value of the first syntax identifier information is a first value, determine that adaptive selection of the inter prediction mode and/or the intra prediction mode for a current coefficient group is enabled, the current coefficient group including at least one layer, the current layer being one of the at least one layer; when the value of the first syntax identifier information is a second value, determine that adaptive selection of the inter prediction mode and/or the intra prediction mode for the current coefficient group is disabled.

In some embodiments of the disclosure, the first determining part 1001 is further configured to: when the value of the first syntax identifier information is a first value, determine that adaptive selection of the inter prediction mode and/or the intra prediction mode for the current layer is enabled; when the value of the first syntax identifier information is a second value, determine that adaptive selection of the inter prediction mode and/or the intra prediction mode for the current layer is disabled.

In some embodiments of the disclosure, the first determining part 1001 is further configured to: decode a bitstream to determine an attribute brick header information parameter set; determine second syntax identifier information from the attribute brick header information parameter set; and determine the target decoding mode for the current layer based on the second syntax identifier information.

In some embodiments of the disclosure, the target decoding mode includes a region-adaptive hierarchical intra transform mode, a region-adaptive hierarchical inter transform mode, and a region-adaptive hierarchical combined transform mode. Herein, the region-adaptive hierarchical intra transform mode characterizes using the intra prediction mode to perform attribute prediction transform decoding on the nodes in the current layer. The region-adaptive hierarchical inter transform mode characterizes using the inter prediction mode to perform attribute prediction transform decoding on the nodes in the current layer. The region-adaptive hierarchical combined transform mode characterizes using intra prediction mode combined with inter prediction mode to perform attribute prediction transform decoding on the nodes in the current layer.

In some embodiments of the disclosure, the region-adaptive hierarchical inter transform mode includes a first region-adaptive hierarchical inter transform mode and a second region-adaptive hierarchical inter transform mode. The region-adaptive hierarchical combined transform mode includes a first region-adaptive hierarchical combined transform mode, a second region-adaptive hierarchical combined transform mode, and a third region-adaptive hierarchical combined transform mode.

The first region-adaptive hierarchical inter transform mode characterizes performing attribute prediction transform decoding on nodes in the current layer in a manner of using geometric information of the nodes to determine collocated prediction nodes.

The second region-adaptive hierarchical inter transform mode characterizes performing attribute prediction transform decoding on the nodes in the current layer in a manner of using the cache of the reference pictures to determine collocated prediction nodes.

The first region-adaptive hierarchical combined transform mode characterizes using a combination of the region-adaptive hierarchical intra transform mode and the first region-adaptive hierarchical inter transform mode to perform attribute prediction transform decoding on the nodes in the current layer.

The second region-adaptive hierarchical combined transform mode characterizes using a combination of region-adaptive hierarchical intra transform mode and the second region-adaptive hierarchical inter transform mode to perform attribute prediction transform decoding on the nodes in the current layer.

The third region-adaptive hierarchical combined transform mode characterizes using a combination of the region-adaptive hierarchical intra transform mode, the first region-adaptive hierarchical inter transform mode and the second region-adaptive hierarchical inter transform mode to perform attribute prediction transform decoding on the nodes in the current layer.

In some embodiments of the disclosure, the first determining part 1001 is further configured to: determine the target decoding mode that uses the inter prediction mode and/or the intra prediction mode for the current layer based on the value of the second syntax identifier information.

In some embodiments of the disclosure, the first determining part 1001 is further configured to: when the value of the second syntax identifier information is a third value, determine that the target decoding mode for the current layer is a region-adaptive hierarchical intra transform mode;
when the value of the second syntax identifier information is a fourth value, determine that the target decoding mode for the current layer is a first region-adaptive hierarchical inter transform mode;
when the value of the second syntax identifier information is a fifth value, determine that the target decoding mode for the current layer is a second region-adaptive hierarchical inter transform mode;
when the value of the second syntax identifier information is a sixth value, determine that the target decoding mode for the current layer is a first region-adaptive hierarchical combined transform mode;
when the value of the second syntax identifier information is a seventh value, determine that the target decoding mode for the current layer is a second region-adaptive hierarchical combined transform mode; and
when the value of the second syntax identifier information is an eighth value, determine that the target decoding mode for the current layer is a third region-adaptive hierarchical combined transform mode.

In some embodiments of the disclosure, the first determining part 1001 is further configured to: parse the bitstream to determine a value of the third syntax identifier information, and the third syntax identifier information is used to indicate the number of layers included in a current sequence where the current layer is located; obtain an index value of the current layer, and when the index value of the current layer is greater than or equal to a ninth value and less than the number of layers, perform the operation of parsing the bitstream to determine a target decoding mode for the current layer; when the index value of the current layer is greater than the number of layers, not perform the operation of parsing bitstream to determine the target decoding mode for the current layer.

In some embodiments of the disclosure, the first determining part 1001 is further configured to: determine attribute prediction values of nodes in the current layer; perform a forward transform on the attribute prediction values of the nodes in the current layer based on the target decoding mode, to determine a first coefficient value and a second coefficient prediction value for each of the nodes in the current layer; determine a second coefficient value for the node of the current layer based on the second coefficient prediction value; perform inverse transform on the first coefficient value and the second coefficient value of the node in the current layer based on the target decoding mode, to determine an attribute reconstruction value of the node in the current layer.

In some embodiments of the disclosure, the first determining part 1001 is further configured to: determine adjacent nodes of each of the nodes in the current layer, herein, the adjacent nodes includes neighbouring nodes and neighbouring nodes of a parent node; and determine the attribute prediction value of the node in the current layer by performing linear fitting based on the attribute reconstruction values for the adjacent nodes and the geometric distances between the node in the current layer and each of the adjacent nodes.

In some embodiments of the disclosure, the first determining part 1001 is further configured to: decode the bitstream to determine a second coefficient decoded residual value for the node in the current layer; perform inverse quantization on the second coefficient decoded residual value to obtain the second coefficient inverse-quantized residual value of the node in the current layer; determine the second coefficient value of the node in the current layer based on the second coefficient prediction value and the second coefficient inverse-quantized residual value of the node in the current layer.

In some embodiments of the disclosure, when the target decoding mode for the current layer is the region-adaptive hierarchical combined transform mode, the first determining part 1001 is further configured to: perform forward transform on the node in the current layer based on the region-adaptive hierarchical combined transform mode, to determine a first intermediate prediction value and a second intermediate prediction value of the node in the current layer; and add the first intermediate prediction value and the second intermediate prediction value of the node in the current layer to obtain the second coefficient prediction value of the node in the current layer.

In some embodiments of the disclosure, the first determining part 1001 is further configured to: determine a first target weight and a second target weight of the current layer; perform forward transform on the node in the current layer by using the region-adaptive hierarchical intra transform mode to determine a first attribute prediction value of the node in the current layer; perform forward transform on the node in the current layer by using the region-adaptive hierarchical inter transform mode to determine a second attribute prediction value of the node in the current layer; multiply the first attribute prediction value of the node in the current layer with the first target weight to obtain the first intermediate prediction value of the node in the current layer; and multiply the second attribute prediction value of the node in the current layer with the second target weight to obtain the second intermediate prediction value of the node in the current layer.

In some embodiments of the disclosure, the first determining part 1001 is further configured to: parse the bitstream to determine a weight index value; determine a target weight combination corresponding to the weight index in a preset weight table; herein, the target weight combination includes a first target weight and a second target weight.

In some embodiments of the disclosure, when the target decoding mode for the current layer is the region-adaptive hierarchical inter transform mode or the region-adaptive hierarchical combined transform mode, the first determining part 1001 is further configured to: when the second coefficient prediction value of the node in the current layer is the tenth value, perform forward transform on the node in the current layer by using the region-adaptive hierarchical intra transform mode, to obtain the intermediate second coefficient prediction value of the node in the current layer; take the intermediate second coefficient prediction value as the second coefficient prediction value for the node in the current layer.

In some embodiments of the disclosure, when the fourth syntax identifier information and the fifth syntax identifier information are both the first value, the first syntax identifier information is the first value. The fourth syntax identifier information is used to indicate whether inter prediction is enabled to be performed on the nodes in current layer; the fifth syntax identifier information is used to indicate whether intra prediction is enabled to be performed on the nodes in current layer; when any one of the fourth syntax identifier information and the fifth syntax identifier information is a second value, the first syntax identifier information is a second value.

In some embodiments of the disclosure, the first determining part 1001 is further configured to: when the first syntax identifier information indicates that adaptive selection of inter prediction mode and/or intra prediction mode are disabled to be performed on the current layer, parse a bitstream to determine fourth syntax identifier information; when the fourth syntax identifier information indicates that inter prediction is disabled to be performed on the nodes in the current layer, parse the bitstream to determine fifth syntax identifier information; when the fifth syntax identifier information indicates that intra prediction is enabled to be performed on the nodes of the current layer, perform attribute decoding on the nodes of the current layer based on the region-adaptive hierarchical intra transform mode to determine attribute reconstruction values of the nodes of the current layer.

In some embodiments of the disclosure, the first determining part 1001 is further configured to: when the fourth syntax identifier information indicates that inter prediction is enabled to be performed on the nodes of the current layer, perform attribute decoding on the nodes of the current layer based on the region-adaptive hierarchical inter transform mode, to determine attribute reconstruction values of the nodes of the current layer.

In some embodiments of the disclosure, the first determining part 1001 is further configured to: when the value of the fourth syntax identifier information is a first value, determine that inter prediction is enabled to be performed on the nodes of the current layer; when the value of the fourth syntax identifier information is a second value, determine that inter prediction is disabled to be performed on the nodes of the current layer.

In some embodiments of the disclosure, the first determining part 1001 is further configured to: when the value of the fifth syntax identifier information is a first value, determine that inter prediction is enabled to be performed on the nodes of the current layer; when the value of the fifth syntax identifier information is a second value, determine that inter prediction is disabled to be performed on the nodes of the current layer.

In some embodiments of the disclosure, the first determining part 1001 is further configured to: parse the bitstream to determine a value of the sixth syntax identifier information. The sixth syntax identifier information is used to indicate that the region-adaptive hierarchical inter transform mode is used for the nodes in the current layer.

In some embodiments of the disclosure, the first determining part 1001 is further configured to: determine the number of adjacent nodes of the current layer; herein, the adjacent nodes includes the number of neighbouring nodes and the number of neighbouring nodes of the parent nodes; when the number of adjacent nodes is greater than or equal to a preset threshold, determine that attribute prediction is enabled to be performed on the nodes in the current layer.

In some embodiments of the disclosure, the first determining part 1001 is further configured to: determine neighbouring nodes of each node in the current layer based on the spatial position of each node; herein, the neighbouring nodes of the node includes at least neighbouring nodes coplanar with the node and neighbouring nodes collinear with the node.

In some embodiments of the disclosure, the first determining part 1001 is further configured to: determine a parent node of each of the nodes in the current layer; determine neighbouring nodes of the parent node of each node based on the spatial position of the parent node of each node; herein, neighbouring nodes of the parent node of the node at least includes neighbouring nodes coplanar with the parent node of the node and neighbouring nodes collinear with the parent node of the node.

In some embodiments of the disclosure, the first determining part 1001 is further configured to: count the number of neighbouring nodes of all of the nodes in the current layer to determine the number of the neighbouring nodes in the current layer; count the number of neighbouring nodes of parent nodes of nodes in the current layer to determine the number of neighbouring nodes of the parent nodes in the current layer; add the number of the neighbouring nodes and the number of the neighbouring nodes of the parent nodes to obtain the number of the adjacent nodes of the current layer.

It should be understood that in the embodiments of the disclosure, the “part” may be a part of a circuit, a part of a processor, a part of a program or software, etc. Or, the “part” may be a module, or may be non-modular. Furthermore, various components in the embodiment may be integrated into a processing unit, or each unit may physically exist separately, or two or more than two units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solutions in the embodiments, in essence or the part that contributes to the related art or all or part of the technical solutions may be embodied in the form of a software product. The computer software product is stored in a storage medium and includes several instructions to make a computer device (which may be a personal computer, a server, or a network device, etc.) or a processor to execute all or part of the operations of the method described in the embodiments. The foregoing storage medium includes various media capable of storing program codes, such as a U disk, a mobile hard disk, a Read Only Memory (ROM), a Random Access Memory (RAM), a magnetic disk, or an optical disk, etc.

Accordingly, an embodiment of the disclosure provides a computer-readable storage medium, which is applied to the decoder 1000, and the computer-readable storage medium stores a computer program that, when executed by a first processor, implements the method according to any one of the foregoing embodiments.

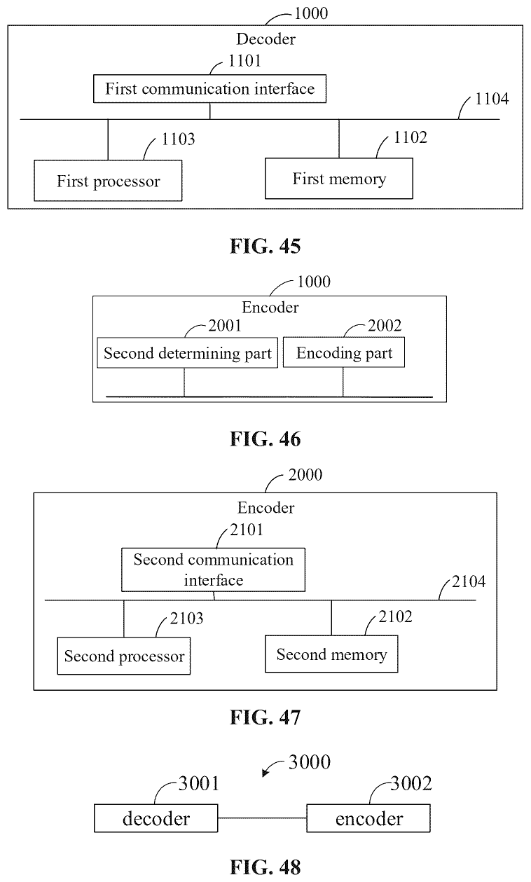

Based on the composition of the decoder 1000 and the computer-readable storage medium described above, referring to FIG. 45, which illustrates a schematic diagram of a specific hardware structure of the decoder 1000 according to the embodiment of the disclosure. As illustrated in FIG. 45, the decoder 1000 may include: a first communication interface 1101, a first memory 1102, and a first processor 1103; the various components are coupled together by a first bus system 1104. It should be understood that the first bus system 1104 is configured to achieve connection and communication between these components. The first bus system 1104 includes a power bus, a control bus, and a status signal bus in addition to a data bus. However, for the sake of clarity of illustration, the various buses are designated as first bus system 1104 in FIG. 11.

The first communication interface 1101 is configured to receive and transmit signals during the process of transmitting and receiving information with other external network elements.

A first memory 1102 is configured to store a computer program executable on the first processor 1103.

A first processor 1103 is configured to execute the computer program, to perform operations of:
when it is determined that attribute prediction is enabled to be performed on nodes in the current layer, parsing a bitstream to determine first syntax identifier information;
when the first syntax identifier information indicates that adaptive selection of the inter prediction mode and/or the intra prediction mode for the current layer is enabled, parsing the bitstream to determine the target decoding mode for the current layer;
performing attribute decoding on the nodes in the current layer based on the target decoding mode to determine attribute reconstruction values of the nodes in the current layer.

It may be understood that the first memory 1102 in the embodiment of the disclosure may be a volatile memory or a non-volatile memory, or may include both volatile and non-volatile memories. The non-volatile memory may be a ROM, a Programmable ROM (PROM), an Erasable PROM (EPROM), an electrically EPROM (EEPROM), or a flash memory. The volatile memory may be a RAM, which is used as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The first memory 1102 of the system and method described in the disclosure is intended to include, but is not limited to these memories and any other suitable types of memories.

The first processor 1103 may be an integrated circuit chip with a signal processing capability. During implementation, each operation of the above methods may be completed by an integrated logical circuit in a form of hardware in the first processor 1103 or instructions in a form of software. The above first processor 1103 may be a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc. The methods, operations and logic block diagrams disclosed in the embodiments of the disclosure may be implemented or performed. The general purpose processor may be a microprocessor, or the processor may be any conventional processor, etc. Operations in the methods disclosed according to the embodiments of the disclosure may be directly embodied as being performed and completed by a hardware decoding processor, or performed and completed by a combination of hardware in the decoding processor and a software module. The software module may be located in a mature storage medium in this field such as a RAM, a flash memory, a ROM, a PROM or an EEPROM, a register, etc. The storage medium is located in the first memory 1102, and the first processor 1103 reads information in the first memory 1102, and completes the operations in the above methods in combination with the hardware thereof.

It may be understood that these embodiments described in the disclosure may be implemented in hardware, software, firmware, middleware, microcode or a combination thereof. For implementation in hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. For implementation in software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the first processor 1103 is further configured to execute the computer program to perform the method described in any one of the foregoing embodiments.

The present embodiment provides a decoder, and at decoding end, a corresponding attribute decoding mode is introduced for each layer, and when attribute decoding is performed for each layer, the decoding end can adaptively select a target decoding mode for each layer, so that the decoding end uses the parsed target decoding mode to perform attribute reconstruction on point cloud attributes, thereby improving decoding efficiency of point cloud attributes, and further improving decoding performance of point cloud.

In another embodiment of the disclosure, based on the same inventive concept as the above-described embodiments, referring to FIG. 46, which illustrates a schematic diagram of a compositional structure of an encoder according to the embodiment of the disclosure. As illustrated in FIG. 46, the encoder 2000 may include a second determining part 2001 and an encoding part 2002.

The second determining part is configured to: when it is determined that attribute prediction is enabled to be performed on nodes in the current layer, and that adaptive selection of the inter prediction mode and/or the intra prediction mode for the current layer is enabled, determine a target encoding mode for the current layer and determine first syntax identifier information; the first syntax identifier information is used to indicate whether adaptive selection of the inter prediction mode and/or the intra prediction mode for the current layer is enabled;

The encoding part is configured to: perform attribute encoding on the nodes in the current layer based on the target encoding mode, and determine attribute reconstruction values of the nodes in the current layer.

The encoding part 2002 is configured to: when it is determined that adaptive selection of the inter prediction mode and/or the intra prediction mode for the current layer is enabled, determine that a value of the first syntax identifier information is a first value; when it is determined that adaptive selection of the inter prediction mode and/or the intra prediction mode for the current layer is disabled, determine that the value of the first syntax identifier information is a second value.

In some embodiments of the disclosure, the second determining part 2001 is further configured to: when it is determined that adaptive selection of the inter prediction mode and/or the intra prediction mode for the current coefficient group is enabled, determine that the value of the first syntax identifier information is a first value, the current coefficient group including at least one layer, the current layer being one of the at least one layer; when it is determined that adaptive selection of the inter prediction mode and/or the intra prediction mode for the current coefficient group is disabled, determine that the value of the first syntax identifier information is a second value.

In some embodiments of the disclosure, the second determining part 2001 is further configured to: when it is determined that adaptive selection of the inter prediction mode and/or the intra prediction mode for the current layer is enabled, determine that the value of the first syntax identifier information is a first value; when it is determined that adaptive selection of the inter prediction mode and/or the intra prediction mode for the current layer is disabled, determine that the value of the first syntax identifier information is a second value.

In some embodiments of the disclosure, the second determining part 2001 is further configured to: determine second syntax identifier information based on the target encoding mode; add the second syntax identifier information to an attribute brick header information parameter set, perform encoding process on the attribute brick header information parameter set, and signal the obtained encoded bits into a bitstream.

In some embodiments of the disclosure, the target encoding mode includes a region-adaptive hierarchical intra transform mode, a region-adaptive hierarchical inter transform mode, and a region-adaptive hierarchical combined transform mode. The region-adaptive hierarchical intra transform mode characterizes using the intra prediction mode to perform attribute prediction transform encoding on the nodes in the current layer. The region-adaptive hierarchical inter transform mode characterizes using the inter prediction mode to perform attribute prediction transform encoding on the nodes in the current layer. The region-adaptive hierarchical combined transform mode characterizes using intra prediction mode combined with inter prediction mode to perform attribute prediction transform encoding on the nodes in the current layer.

In some embodiments of the disclosure, the region-adaptive hierarchical inter transform mode includes a first region-adaptive hierarchical inter transform mode and a second region-adaptive hierarchical inter transform mode. The region-adaptive hierarchical combined transform mode includes a first region-adaptive hierarchical combined transform mode, a second region-adaptive hierarchical combined transform mode, and a third region-adaptive hierarchical combined transform mode.

The first region-adaptive hierarchical inter transform mode characterizes performing attribute prediction transform encoding on nodes in the current layer in a manner of using geometric information of the nodes to determine collocated prediction nodes.

The second region-adaptive hierarchical inter transform mode characterizes performing attribute prediction transform encoding on the nodes in the current layer in a manner of using the cache of the reference pictures to determine collocated prediction nodes.

The first region-adaptive hierarchical combined transform mode characterizes using a combination of the region-adaptive hierarchical intra transform mode and the first region-adaptive hierarchical inter transform mode to perform attribute prediction transform encoding on the nodes in the current layer.

The second region-adaptive hierarchical combined transform mode characterizes using a combination of region-adaptive hierarchical intra transform mode and the second region-adaptive hierarchical inter transform mode to perform attribute prediction transform encoding on the nodes in the current layer.

The third region-adaptive hierarchical combined transform mode characterizes using a combination of the region-adaptive hierarchical intra transform mode, the first region-adaptive hierarchical inter transform mode and the second region-adaptive hierarchical inter transform mode to perform attribute prediction transform encoding on the nodes in the current layer.

In some embodiments of the disclosure, the second determining part 2001 is further configured to: determine a value of the second syntax identifier information based on the target decoding mode that uses the inter prediction mode and/or the intra prediction mode for the current layer.

In some embodiments of the disclosure, the second determining part 2001 is further configured to: when the target encoding mode for the current layer is a region-adaptive hierarchical intra transform mode, determine that the value of the second syntax identifier information is a third value;
when the target encoding mode for the current layer is a first region-adaptive hierarchical inter transform mode, determine that a value of the second syntax identifier information is a fourth value;
when the target encoding mode for the current layer is a second region-adaptive hierarchical inter transform mode, determine that the value of the second syntax identifier information is a fifth value;
when the target encoding mode for the current layer is a first region-adaptive hierarchical combined transform mode, determine that the value of the second syntax identifier information is a sixth value;
when the target encoding mode for the current layer is a second region-adaptive hierarchical combined transform mode, determine that the value of the second syntax identifier information is a seventh value;
when the target encoding mode for the current layer is a third region-adaptive hierarchical combined transform mode, determine that the value of the second syntax identifier information is an eighth value.

In some embodiments of the disclosure, the second determining part 2001 is further configured to: determine a value of the third syntax identifier information, and the third syntax identifier information is used to indicate the number of layers included in a current sequence where the current layer is located; obtain an index value of the current layer, and when the index value of the current layer is greater than or equal to a ninth value and less than the number of layers, perform the operation of determining a target encoding mode for the current layer; when the index value of the current layer is greater than the number of layers, not perform the operation of determining a target encoding mode for the current layer; perform encoding process on the third syntax identifier information, and signal the obtained encoded bits into the bitstream.

In some embodiments of the disclosure, the second determining part 2001 is further configured to: perform attribute encoding on the current layer based on at least one candidate encoding mode, and determine a pre-encoding result for each of the at least one candidate encoding mode; perform a cost calculation based on the pre-encoding result for each of the at least one candidate encoding mode, to determine a cost value for each of the at least one candidate encoding mode; determine the target encoding mode for the current layer from the at least one candidate encoding mode based on respective cost values of the at least one candidate encoding mode.

In some embodiments of the disclosure, the second determining part 2001 is further configured to: perform rate-distortion cost calculation based on the pre-encoding result for each of the at least one candidate encoding mode, to determine a cost value for each of the at least one candidate encoding mode.

In some embodiments of the disclosure, the second determining part 2001 is further configured to: determine a minimum cost value from the respective cost values of the at least one candidate encoding mode; determine a candidate encoding mode with the minimum cost value as the target encoding mode for the current layer.

In some embodiments of the disclosure, the at least one candidate encoding mode includes at least one of: a region-adaptive hierarchical intra transform mode, a first region-adaptive hierarchical inter transform mode, a second region-adaptive hierarchical inter transform mode, a first region-adaptive hierarchical combined transform mode, a second region-adaptive hierarchical combined transform mode, and a third region-adaptive hierarchical combined transform mode.

In some embodiments of the disclosure, the encoding part 2002 is further configured to: determine attribute prediction values of nodes in the current layer; perform a forward transform on the attribute prediction values of the nodes in the current layer based on the target encoding mode, to determine a first coefficient value and a second coefficient prediction value for each of the nodes in the current layer; determine a second coefficient value for the node of the current layer based on the second coefficient prediction value; perform inverse transform on the first coefficient value and the second coefficient value of the node in the current layer based on the target encoding mode, to determine an attribute reconstruction value of the node in the current layer.

In some embodiments of the disclosure, the encoding part 2002 is further configured to: determine adjacent nodes of each of the nodes in the current layer, herein, the adjacent nodes includes neighbouring nodes and neighbouring nodes of a parent node; determine the attribute prediction value of the node in the current layer by performing linear fitting based on the attribute reconstruction values for the adjacent nodes and the geometric distances between the node in the current layer and each of the adjacent nodes.

In some embodiments of the disclosure, the encoding part 2002 is further configured to determine a second coefficient encoded residual value for the node in the current layer; perform inverse quantization process on the second coefficient encoded residual value to obtain the second coefficient inverse-quantized residual value of the node in the current layer; determine the second coefficient value of the node in the current layer based on the second coefficient prediction value and the second coefficient inverse-quantized residual value of the node in the current layer.

In some embodiments of the disclosure, the encoding part 2002 is further configured to determine an attribute original value of the node in the current layer; perform forward transform on the attribute original value of the node in the current layer based on the target encoding mode to determine the first coefficient value and the second coefficient original value of the node in the current layer; determine a second coefficient prediction residual value of the node in the current layer based on the second coefficient original value and the second coefficient prediction value of the node in the current layer; perform a quantization process on second coefficient residual value to obtain the second coefficient quantized residual value of the node in the current layer.

In some embodiments of the disclosure, the encoding part 2002 is further configured to: perform encoding process on the second coefficient quantized residual value of the node in the current layer, and signal the obtained encoded bits into the bitstream.

In some embodiments of the disclosure, when the target encoding mode for the current layer is the region-adaptive hierarchical combined transform mode, the encoding part 2002 is further configured to: perform forward transform on each of the nodes in the current layer based on the region-adaptive hierarchical combined transform mode, and determine a first intermediate prediction value and a second intermediate prediction value of the node in the current layer; add the first intermediate prediction value and the second intermediate prediction value of the node in the current layer to obtain the second coefficient prediction value of the node in the current layer.

In some embodiments of the disclosure, the encoding part 2002 is further configured to: determine a target weight combination corresponding to the current layer in a preset weight table, the target weight combination includes a first target weight and a second target weight; perform forward transform on the node in the current layer by using the region-adaptive hierarchical intra transform mode to determine a first attribute prediction value of the node in the current layer; perform forward transform on the node in the current layer by using the region-adaptive hierarchical inter transform mode to determine a second attribute prediction value of the node in the current layer; multiply the first attribute prediction value of the node in the current layer with the first target weight to obtain the first intermediate prediction value of the node in the current layer; multiply the second attribute prediction value of the node in the current layer with the second target weight to obtain the second intermediate prediction value of the node in the current layer.

In some embodiments of the disclosure, the encoding part 2002 is further configured to perform encoding process on the weight index value corresponding to the target weight combination in the preset weight table, and signal the obtained encoded bits into the bitstream.

In some embodiments of the disclosure, the encoding part 2002 is further configured to determine attribute prediction values of nodes in the current layer; perform a forward transform on the attribute prediction values of the nodes in the current layer based on the target encoding mode, to determine a first coefficient value and a second coefficient prediction value for each of the nodes in the current layer; determine a second coefficient value for the node of the current layer based on the second coefficient prediction value; perform inverse transform on the first coefficient value and the second coefficient value of the node in the current layer based on the target encoding mode, to determine an attribute reconstruction value of the node in the current layer.

In some embodiments of the disclosure, the encoding part 2002 is further configured to: determine adjacent nodes of each of the nodes in the current layer, herein, the adjacent nodes includes neighbouring nodes and neighbouring nodes of a parent node; and determine the attribute prediction value of the node in the current layer by performing linear fitting based on the attribute reconstruction values for the adjacent nodes and the geometric distances between the node in the current layer and each of the adjacent nodes.

In some embodiments of the disclosure, the encoding part 2002 is further configured to: determine a second coefficient encoded residual value for the node in the current layer; perform inverse quantization on the second coefficient encoded residual value to obtain the second coefficient inverse-quantized residual value of the node in the current layer; determine the second coefficient value of the node in the current layer based on the second coefficient prediction value and the second coefficient inverse-quantized residual value of the node in the current layer.

In some embodiments of the disclosure, the encoding part 2002 is further configured to: determine an attribute original value of the node in the current layer; perform forward transform on the attribute original value of the node in the current layer based on the target encoding mode, determine the first coefficient value and the second coefficient original value of the node in the current layer; determine a second coefficient prediction residual value for the node in the current layer based on the second coefficient original value and the second coefficient prediction value for the node in the current layer; perform quantization process on the second coefficient residual value to obtain a second coefficient quantized residual value of the node in the current layer.

In some embodiments of the disclosure, the encoding part 2002 is further configured to perform encoding process on the second coefficient quantized residual value of the node in the current layer, and signal the obtained encoded bits into the bitstream.

In some embodiments of the disclosure, when the target encoding mode for the current layer is the region-adaptive hierarchical combined transform mode, the encoding part 2002 is further configured to: perform forward transform on the node in the current layer based on the region-adaptive hierarchical combined transform mode, to determine a first intermediate prediction value and a second intermediate prediction value of the node in the current layer; and add the first intermediate prediction value and the second intermediate prediction value of the node in the current layer to obtain the second coefficient prediction value of the node in the current layer.

In some embodiments of the disclosure, the encoding part 2002 is further configured to determine a target weight combination corresponding to the current layer in a preset weight table, the target weight combination includes a first target weight and a second target weight; perform forward transform on the node in the current layer by using the region-adaptive hierarchical intra transform mode to determine a first attribute prediction value of the node in the current layer; perform forward transform on the node in the current layer by using the region-adaptive hierarchical inter transform mode to determine a second attribute prediction value of the node in the current layer; multiply the first attribute prediction value of the node in the current layer with the first target weight to obtain the first intermediate prediction value of the node in the current layer; and multiply the second attribute prediction value of the node in the current layer with the second target weight to obtain the second intermediate prediction value of the node in the current layer.

In some embodiments of the disclosure, the encoding part 2002 is further configured to perform encoding process on the weight index value corresponding to the target weight combination in the preset weight table, and signal the obtained encoded bits into the bitstream.

In some embodiments of the disclosure, when the target encoding mode for the current layer is the region-adaptive hierarchical inter transform mode or the region-adaptive hierarchical combined transform mode, the encoding part 2002 is further configured to: when the second coefficient prediction value of the node in the current layer is a tenth value, perform forward transform on the node in the current layer based on the region-adaptive hierarchical intra transform mode to obtain an intermediate second coefficient prediction value of the node in the current layer; and take the intermediate second coefficient prediction value as the second coefficient prediction value for the node in the current layer.

In some embodiments of the disclosure, the encoding part 2002 is further configured to: determine a value of the fourth syntax identifier information and a value of the fifth syntax identifier information; the fifth syntax identifier information is used to indicate whether intra prediction is enabled to be performed on the nodes in current layer; when the fourth syntax identifier information and the fifth syntax identifier information are both the first value, determine that the value of the first syntax identifier information is the first value; when any one of the fourth syntax identifier information or the fifth syntax identifier information is a second value, determine that the value of the first syntax identifier information is a second value; perform encoding process on the first syntax identifier information, and signal the obtained encoded bits into the bitstream.

In some embodiments of the disclosure, the second determining part 2001 is further configured to: when it is determined that inter prediction is enabled to be performed on the nodes of the current layer, set a value of the fourth syntax identifier information to a first value; when it is determined that inter prediction is disabled to be performed on the nodes of the current layer, set a value of the fourth syntax identifier information to a second value; encode the fourth syntax identifier information, and signal the obtained encoded bits into the bitstream.

In some embodiments of the disclosure, the second determining part 2001 is further configured to: when it is determined that intra prediction is enabled to be performed on the nodes of the current layer, set a value of the fifth syntax identifier information to a first value; when it is determined that intra prediction is disabled to be performed on the nodes of the current layer, set a value of the fifth syntax identifier information to a second value; encode the fifth syntax identifier information, and signal the obtained encoded bits into the bitstream.

In some embodiments of the disclosure, the second determining part 2001 is further configured to: determine a value of the sixth syntax identifier information; the sixth syntax identifier information is used to indicate that the region-adaptive hierarchical inter transform mode is used for the nodes in the current layer; encode the sixth syntax identifier information, and signal the obtained encoded bits into the bitstream.

In some embodiments of the disclosure, the second determining part 2001 is further configured to: perform encoding process on the target encoding mode for the nodes in the current layer, and signal the obtained encoded bits into the bitstream.

In some embodiments of the disclosure, the second determining part 2001 is further configured to determine the number of adjacent nodes of the current layer; herein, the adjacent nodes includes the number of neighbouring nodes and the number of neighbouring nodes of the parent nodes; when the number of adjacent nodes is greater than or equal to a preset threshold, determine that attribute prediction is enabled to be performed on the nodes in the current layer.

In some embodiments of the disclosure, the second determining part 2001 is further configured to: determine neighbouring nodes of each node in the current layer based on the spatial position of each node; herein the neighbouring nodes of the node includes at least neighbouring nodes coplanar with the node and neighbouring nodes collinear with the node.

In some embodiments of the disclosure, the second determining part 2001 is further configured to: determine a parent node of each of the nodes in the current layer; determine neighbouring nodes of the parent node of each node based on the spatial position of the parent node of each node; herein, neighbouring nodes of the parent node of the node at least includes neighbouring nodes coplanar with the parent node of the node and neighbouring nodes collinear with the parent node of the node.

In some embodiments of the disclosure, the second determining part 2001 is further configured to: count the number of neighbouring nodes of all of the nodes in the current layer to determine the number of the neighbouring nodes in the current layer; count the number of neighbouring nodes of parent nodes of nodes in the current layer to determine the number of neighbouring nodes of the parent nodes in the current layer; add the number of the neighbouring nodes and the number of the neighbouring nodes of the parent nodes to obtain the number of the adjacent nodes of the current layer.

It should be understood that in the embodiments of the disclosure, the “part” may be a part of a circuit, a part of a processor, a part of a program or software, etc. Or, the “part” may be a module, or may be non-modular. Furthermore, various components in the embodiment may be integrated into a processing unit, or each unit may physically exist separately, or two or more than two units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the embodiment provides a computer-readable storage medium, which is applied to the encoder 2000, the computer-readable storage medium stores a computer program that, when executed by a second processor, implements the method according to any one of the foregoing embodiments.

Based on the composition of the encoder 2000 and the computer-readable storage medium described above, referring to FIG. 47, which illustrates a schematic diagram of a specific hardware structure of the encoder 2000 according to the embodiment of the disclosure. As illustrated in FIG. 47, the encoder 2000 may include: a second communication interface 2101, a second memory 2102, and a second processor 2103; the various components are coupled together by a second bus system 2104. It should be understood that the second bus system 2104 is configured to achieve connection and communication between these components. The second bus system 2104 includes a power bus, a control bus, and a status signal bus in addition to a data bus. However, for the sake of clarity of illustration, various buses are designated as second bus system 2104 in FIG. 21.

The second communication interface 2101 is configured to receive and transmit signals during the process of transmitting and receiving information with other external network elements.

A second memory 2102 is configured to store a computer program executable on the second processor 2103.

A second processor 2103 is configured to execute the computer program, to perform operations of:
when it is determined that attribute prediction is enabled to be performed on nodes in the current layer, determining first syntax identifier information;
when it is determined that attribute prediction is enabled to be performed on nodes in the current layer and that adaptive selection of an inter prediction mode and/or an intra prediction mode for the current layer is enabled, determining a target encoding mode for the current layer and determining first syntax identifier information; the first syntax identifier information is used to indicate whether adaptive selection of an inter prediction mode and/or an intra prediction mode for the current layer is enabled;
performing attribute encoding on the nodes in the current layer based on the target encoding mode, and determining attribute reconstruction values of the nodes in the current layer.

Optionally, as another embodiment, the second processor 2103 is further configured to execute the computer program to perform the method described in any one of the foregoing embodiments.

It should be understood that the hardware functionality of the second memory 2102 is similar to that of the first memory 1102, and the hardware functionality of the second processor 2103 is similar to that of the first processor 1103. It will not be detailed here.

The present embodiment provides an encoder, at the encoding end, a corresponding attribute encoding mode is introduced for each layer, and when attribute encoding is performed for each layer, the encoding end can adaptively select a target encoding mode for each layer, so that the encoding end uses the parsed target encoding mode to perform attribute reconstruction on point cloud attributes, thereby improving the encoding efficiency of the point cloud attributes, and further improving the encoding performance of the point cloud.

In another embodiment of the disclosure, referring to FIG. 48, which illustrates a schematic s diagram of a compositional structure of an encoding and decoding system according to the embodiment of the disclosure. As illustrated in FIG. 48, the encoding and decoding system 3000 may include a decoder 3001 and an encoder 3002.

In an embodiment of the disclosure, the decoder 3001 may be the decoder described in any one of the preceding embodiments, and the encoder 3002 may be the encoder described in any one of the preceding embodiments.

It should be noted that in the disclosure, terms “including”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above sequence numbers of the embodiments of the disclosure are only for the purpose of descriptions, and do not represent the advantages and disadvantages of the embodiments.

The methods disclosed in several method embodiments provided in the disclosure may be arbitrarily combined without conflict to obtain new method embodiments.

The features disclosed in several product embodiments provided in the disclosure may be arbitrarily combined without conflict to obtain new product embodiments.

The features disclosed in several method or device embodiments provided in the disclosure may be arbitrarily combined without conflict to obtain new method or device embodiments.

The above descriptions are only specific implementations of the disclosure, but the scope of protection of the disclosure is not limited thereto. Variation or replacement easily conceived by any technician skilled in the art within the technical scope disclosed in the disclosure, should fall within the scope of protection of the disclosure. Therefore, the scope of protection of the disclosure should be subject to the scope of protection of the claims.

### INDUSTRIAL PRACTICALITY

In the embodiment of the disclosure, at the decoding end, when it is determined that attribute prediction is enabled to be performed on nodes in the current layer, a bitstream is parsed to determine the first syntax identifier information; when the first syntax identifier information indicates that adaptive selection of an inter prediction mode and/or an intra prediction mode is enabled for the current layer, the bitstream is parsed to determine the target decoding mode for the current layer; and attribute decoding is performed on the nodes in the current layer based on the target decoding mode to determine the attribute reconstruction values of the nodes in the current layer. At the encoding end, when it is determined that attribute prediction is enabled to be performed on nodes in the current layer and that adaptive selection of an inter prediction mode and/or an intra prediction mode for the current layer is enabled, the target encoding mode for the current layer is determined, and the first syntax identifier information is determined, the first syntax identifier information is used to indicate whether adaptive selection of an inter prediction mode and/or an intra prediction mode for the current layer is enabled; attribute encoding is performed on the nodes in the current layer based on the target encoding mode to determine the attribute reconstruction values of the nodes in the current layer. In this way, by introducing a corresponding attribute encoding mode for each layer, when performing attribute encoding on each layer, the encoding end can adaptively select the target encoding mode for each slice and transmit the target encoding mode to the decoder, so that the decoding end uses the parsed target decoding mode to perform attribute reconstruction on the point cloud attributes, thereby improving the encoding and decoding efficiency of point cloud attributes and further enhancing the encoding and decoding performance of point clouds.

1. A decoding method, applied to a decoder, comprising:
when it is determined that attribute prediction is enabled to be performed on nodes in a current layer, parsing a bitstream to determine first syntax identifier information;
when the first syntax identifier information indicates that adaptive selection of an inter prediction mode and/or an intra prediction mode for the current layer is enabled, parsing the bitstream to determine a target decoding mode for the current layer; and
performing attribute decoding on the nodes in the current layer based on the target decoding mode, to determine attribute reconstruction values of the nodes in the current layer.

2. The method of claim 1, wherein parsing the bitstream to determine the target decoding mode for the current layer comprises:
decoding the bitstream to determine an attribute brick header information parameter set;
determining second syntax identifier information from the attribute brick header information parameter set; and
determining the target decoding mode for the current layer based on the second syntax identifier information.

3. The method of claim 2, wherein determining the target decoding mode for the current layer based on the second syntax identifier information comprises:
determining the target decoding mode that uses the inter prediction mode and/or the intra prediction mode for the current layer based on a value of the second syntax identifier information.

4. The method of claim 1, wherein performing attribute decoding on the nodes in the current layer based on the target decoding mode, to determine the attribute reconstruction values of the nodes in the current layer, comprises:
determining an attribute prediction value for each of the nodes in the current layer;
performing forward transform on the attribute prediction value of the node in the current layer based on the target decoding mode, to determine a first coefficient value and a second coefficient prediction value of the node in the current layer;
determining a second coefficient value for the node of the current layer based on the second coefficient prediction value; and
performing inverse transform on the first coefficient value and the second coefficient value of the node in the current layer based on the target decoding mode, to determine the attribute reconstruction value of the node in the current layer.

5. The method of claim 4, wherein determining the attribute prediction value for each of the nodes in the current layer, comprises:
determining adjacent nodes of the node in the current layer; wherein the adjacent nodes comprises neighbouring nodes and neighbouring nodes of a parent node; and
determining the attribute prediction value of the node in the current layer by performing linear fitting based on attribute reconstruction values for the adjacent nodes and geometric distances between the node in the current layer and each of the adjacent nodes.

6. The method of claim 4, wherein determining the second coefficient value for the node of the current layer based on the second coefficient prediction value, comprises:
decoding the bitstream to determine a second coefficient decoded residual value for the node in the current layer;
performing an inverse quantization process on the second coefficient decoded residual value to obtain a second coefficient inverse-quantized residual value of the node in the current layer; and
determining the second coefficient value of the node in the current layer based on the second coefficient prediction value and the second coefficient inverse-quantized residual value of the node in the current layer.

7. The method of claim 1, further comprising:
determining a number of adjacent nodes of the current layer; wherein the adjacent nodes comprises a number of neighbouring nodes and a number of neighbouring nodes of the parent nodes; and
when the number of adjacent nodes is greater than or equal to a preset threshold, determining that attribute prediction is enabled to be performed on the nodes in the current layer.

8. The method of claim 7, further comprising:
determining neighbouring nodes of each of the nodes in the current layer based on the spatial position of each of the nodes; and
wherein the neighbouring node of the node comprises at least neighbouring nodes coplanar with the node and neighbouring nodes collinear with the node.

9. The method of claim 7, further comprising:
determining a parent node of each of the nodes in the current layer; and
determining neighbouring nodes of the parent node of the node based on a spatial location of the parent node of the node; wherein the neighbouring nodes of the parent node of the node at least comprise neighbouring nodes coplanar with the parent node of the node and neighbouring nodes collinear with the parent node of the node.

10. The method of claim 7, wherein determining the number of the adjacent nodes of the current layer comprises:
counting the number of neighbouring nodes of the nodes in the current layer to determine the number of the neighbouring nodes in the current layer;
counting the number of neighbouring nodes of parent nodes of the nodes in the current layer to determine the number of neighbouring nodes of the parent nodes in the current layer;
adding the number of the neighbouring nodes and the number of the neighbouring nodes of the parent nodes to obtain the number of adjacent nodes of the current layer.

11. An encoding method, applied to an encoder, comprising:
when it is determined that attribute prediction is enabled to be performed on nodes in a current layer, and that adaptive selection of an inter prediction mode and/or an intra prediction mode for the current layer is enabled, determining a target encoding mode for the current layer and determining first syntax identifier information; wherein the first syntax identifier information is used to indicate whether adaptive selection of the inter prediction mode and/or the intra prediction mode for the current layer is enabled; and
performing attribute encoding on the nodes in the current layer based on the target encoding mode, and determining attribute reconstruction values of the nodes in the current layer.

12. The method of claim 11, further comprising:
determining second syntax identifier information based on the target encoding mode; and
adding the second syntax identifier information to an attribute brick header information parameter set, performing encoding process on the attribute brick header information parameter set, and signalling the obtained encoded bits into a bitstream.

13. The method of claim 12, wherein determining the second syntax identifier information based on the target encoding mode comprises:
determining a value of the second syntax identifier information based on the target decoding mode that uses the inter prediction mode and/or the intra prediction mode for the current layer.

14. The method of claim 11, wherein performing attribute encoding on the nodes in the current layer based on the target encoding mode, and determining the attribute reconstruction values of the nodes in the current layer, comprises:
determining an attribute prediction value for each of the nodes in the current layer;
performing forward transform on the attribute prediction value of the node in the current layer based on the target encoding mode, to determine a first coefficient value and a second coefficient prediction value of the node in the current layer;
determining a second coefficient value for the node of the current layer based on the second coefficient prediction value; and
perform inverse transform on the first coefficient value and the second coefficient value of the node in the current layer based on the target encoding mode, to determine the attribute reconstruction value of the node in the current layer.

15. The method of claim 14, wherein the determining an attribute prediction value for a node in the current layer comprises:
determining adjacent nodes of each of the nodes in the current layer; wherein the adjacent nodes includes neighbouring nodes and neighbouring nodes of a parent node; and
determine the attribute prediction value of the node in the current layer by performing linear fitting based on attribute reconstruction values for the adjacent nodes and geometric distances between the node in the current layer and each of the adjacent nodes.

16. The method of claim 14, wherein determining the second coefficient value for the node ofthe current layer based on the second coefficient prediction value, comprises:
determining a second coefficient encoded residual value for the node in the current layer;
performing an inverse quantization process on the second coefficient encoded residual value to obtain a second coefficient inverse-quantized residual value of the node in the current layer; and
determining the second coefficient value of the node in the current layer based on the second coefficient prediction value and the second coefficient inverse-quantized residual value of the node in the current layer.

17. The method of claim 11, further comprising:
determining a number of adjacent nodes of the current layer; wherein the adjacent nodes comprises a number of neighbouring nodes and a number of neighbouring nodes of the parent nodes; and
when the number of adjacent nodes is greater than or equal to a preset threshold, determining that attribute prediction is enabled to be performed on the nodes in the current layer.

18. The method of claim 17, further comprising:
determining neighbouring nodes of each of the nodes in the current layer based on the spatial position of each of the nodes; and
wherein the neighbouring node of the node comprises at least neighbouring nodes coplanar with the node and neighbouring nodes collinear with the node.

19. The method of claim 17, further comprising:
determining a parent node of each of the nodes in the current layer; and
determining neighbouring nodes of the parent node of the node based on a spatial location of the parent node of the node; wherein the neighbouring nodes of the parent node of the node at least comprise neighbouring nodes coplanar with the parent node of the node and neighbouring nodes collinear with the parent node of the node.

20. A non-transitory computer-readable storage medium having a computer program and a bitstream stored thereon, wherein the computer program that, when executed by a processor, enables the processor to perform the steps of an encoding method to generate the bitstream, wherein the encoding method comprises:
when it is determined that attribute prediction is enabled to be performed on nodes in a current layer, and that adaptive selection of an inter prediction mode and/or an intra prediction mode for the current layer is enabled, determining a target encoding mode for the current layer and determining first syntax identifier information; wherein the first syntax identifier information is used to indicate whether adaptive selection of the inter prediction mode and/or the intra prediction mode for the current layer is enabled; and
performing attribute encoding on the nodes in the current layer based on the target encoding mode, and determining attribute reconstruction values of the nodes in the current layer.
